(19) United States
(12) Patent Application Publication
(10) Pub. No.: US 2016/0086429 A1
(43) Pub. Date: Mar. 24, 2016

(54) GAMING MACHINE AND GAME CONTROL METHOD

(71) Applicants: Universal Entertainment Corporation, Tokyo (JP); Aruze Gaming America, Inc., Las Vegas, NV (US)

(72) Inventors: Yukinori INAMURA, Tokyo (JP); Kenji Enokido, Tokyo (JP); Hiromoto Yamauchi, Tokyo (JP); Hiroshi Takahashi, Tokyo (JP)

(21) Appl. No.: 14/855,467

(22) Filed: Sep. 16, 2015

(30) Foreign Application Priority Data
Sep. 18, 2014 (JP) 2014-190462

(51) Int. Cl. G07F 17/32

(52) U.S. Cl. CPC G07F 17/3213

(57) ABSTRACT

There are provided highly entertaining games. A gaming machine includes: a lower image display panel configured to variably display a plurality of symbol arrays with a plurality of symbols including normal symbols and special symbols each of which regarded as any one of the normal symbols, and then display a game result by rearranging the symbols in a symbol display region containing a matrix of display blocks, and a game controller configured to run the game, and award, to a player, a payout according to the game result. Before the variable displaying is started, the game controller determines a plurality of symbols to be rearranged on the lower image display panel, and when the special symbol included in the symbols determined satisfy a predetermined condition, executes a process of determining whether to perform the predetermined indication effect.

### CROSS REFERENCE TO RELATED APPLICATION

The present application claims priority from Japanese Patent Application No. 2014-190462, which was filed on Sep. 18, 2014, the disclosure of which is herein incorporated by reference in its entirety.

### BACKGROUND OF THE INVENTION

### 1. Field of the Invention

The present invention relates to a gaming machine which variably displays symbols and then rearranges the symbols, and a method of controlling the game control method.

An example of a known slot machine is disclosed, for example, by U.S. Laid-Open Patent Application No. 2011/0250947. In such a slot machine, a plurality of symbols in a symbol display area at the front side of its cabinet are scrolled when a player inserts a coin, a bill, or the like into an insertion slot of the slot machine and operates a spin button. The symbols are then automatically stopped. Various prizes such as a bonus are established based on how the symbols are stopped.

In gaming machines such as the known slot machine above, when a trigger condition is established in a normal game, shifting from the normal game to a bonus game is achieved. As such, the gaming machines allow players to play highly entertaining games. In other words, providing highly entertaining games has been an important point in the gaming machines.

An object of the present invention is to provide a highly-entertaining gaming machine, and a game control method.

### SUMMARY OF THE INVENTION

An aspect of the present invention is a gaming machine including: a symbol display device configured to display a result of a game by rearranging symbols in a symbol display area including a matrix of cells, after variably displaying a plurality of symbol arrays each of which is an array of symbols including normal symbols and one or more special symbols each of which is capable of replacing any one of the normal symbols, a controller configured to run the game, and award, to a player, a payout according to the game result, wherein the controller determines symbols to be rearranged on the symbol display device before the variable displaying of symbols starts, and executes a process of determining whether to perform a predetermined effect during the variable display, when the one or more special symbols included in the symbols determined satisfied a predetermined condition.

With the above structure, it is possible to inform that the special symbol satisfies the predetermined condition, by means of the predetermined effect, before the symbols are rearranged. Each special symbol is regarded as any one of the normal symbols. Therefore, presenting such a predetermined effect will let the player know that the payout by the normal symbols will improve, prior to the rearrangement of the symbols, which consequently causes the player to have a high expectation. This way, there is provided a gaming machine that realizes a high entertainment characteristic for players.

Further, the gaming machine of the above aspect of the present invention further includes a bet input device capable of receiving a bet whose amount is designated by a player, wherein the game includes a normal game configured to run on condition that a bet is placed and award a payout to the player according to the game result, and wherein the controller executes a process of determining whether to perform the predetermined effect during the variable display in the normal game, when a predetermined number or more of special symbols are to be rearranged in the symbol display device, and when the payout equals to or surpasses the product of bet amount multiplied by a predetermined number.

The above structure causes players to expect a probability for a high payout by the normal symbols in the normal game. This way, there is provided a gaming machine that realizes a high entertainment characteristic for players.

Further, the gaming machine of the above aspect of the present invention may be adapted so that the game includes a free game which could be triggered in the normal game, and configured to award a payout to the player according to the game result; and the controller executes a process of determining whether to perform the predetermined effect during the variable display in the free game, when a predetermined number or more of special symbols are to be rearranged in the symbol display device, and when the payout equals to or surpasses the product of bet amount in the normal game having triggered the free game multiplied by a predetermined number.

The above structure causes players to expect a probability for a high payout by the normal symbols in the free game. This way, there is provided a gaming machine that realizes a high entertainment characteristic for players.

The present invention provides highly entertaining games.

### BRIEF DESCRIPTION OF THE DRAWINGS

FIG. 1 is an explanatory diagram of an operation state of a gaming machine.

FIG. 2 is an explanatory diagram showing payout table of a game.

FIG. 3 is an explanatory diagram of paylines.

FIG. 4 is an explanatory diagram showing a function flow of the gaming machine.

FIG. 5 is an explanatory diagram showing a function flow of the gaming machine.

FIG. 6 is a block diagram of a gaming system.

FIG. 7 is a perspective view of a slot machine in the gaming machine.

FIG. 8 is an explanatory diagram of the button configuration of the control panel.

FIG. 9 is an electrical block diagram of the gaming machine.

FIG. 10A is an explanatory diagram showing symbol arrays for the normal game.

FIG. 10B is an explanatory diagram showing symbol arrays for the normal game.

FIG. 11A is an explanatory diagram showing symbol arrays for the free game.

FIG. 11B is an explanatory diagram showing symbol arrays for the free game.

FIG. 12A is an explanatory diagram showing symbol arrays for the free game.

FIG. 12B is an explanatory diagram showing symbol arrays for the free game.

FIG. 13A is an explanatory diagram showing symbol arrays for the free game.

FIG. 13B is an explanatory diagram showing symbol arrays for the free game.

FIG. 14A is an explanatory diagram showing symbol arrays for the free game.

FIG. 14B is an explanatory diagram showing symbol arrays for the free game.

FIG. 15A is an explanatory diagram showing symbol arrays for the free game.

FIG. 15B is an explanatory diagram showing symbol arrays for the free game.

FIG. 16 is an explanatory diagram of a display screen on an upper image display panel.

FIG. 17 is an explanatory diagram of a display screen on the upper image display panel and the lower image display panel.

FIG. 18 is an explanatory diagram of a display screen on the upper image display panel and the lower image display panel.

FIG. 19 is an explanatory diagram of a display screen on the upper image display panel and the lower image display panel.

FIG. 20 is an explanatory diagram of a display screen on the upper image display panel and the lower image display panel.

FIG. 21 is an explanatory diagram of a display screen on the upper image display panel and the lower image display panel.

FIG. 22 is an explanatory diagram of a display screen on the upper image display panel and the lower image display panel.

FIG. 23 is an explanatory diagram of a display screen on the upper image display panel and the lower image display panel.

FIG. 24 is an explanatory diagram of a mystery symbol conversion random determination table.

FIG. 25 is an explanatory diagram of a mystery symbol conversion random determination table random determination table.

FIG. 26 is an explanatory diagram of a display screen on a lower image display panel.

FIG. 27 is an explanatory diagram of a display screen on a lower image display panel.

FIG. 28 is an explanatory diagram of a display screen on a lower image display panel.

FIG. 29 is an explanatory diagram of a display screen on a lower image display panel.

FIG. 30 is an explanatory diagram of a display screen on a lower image display panel.

FIG. 31 is an explanatory diagram of a display screen on a lower image display panel.

FIG. 32 is an explanatory diagram of a display screen on a lower image display panel.

FIG. 33 is an explanatory diagram of a display screen on a lower image display panel.

FIG. 34 is an explanatory diagram of a display screen on a lower image display panel.

FIG. 35 is an explanatory diagram of a display screen on a lower image display panel.

FIG. 36 is an explanatory diagram of a display screen on an upper image display panel.

FIG. 37 is an explanatory diagram of a display screen on a lower image display panel.

FIG. 38 is an explanatory diagram of a display screen on a lower image display panel.

FIG. 39 is an explanatory diagram of a display screen on a lower image display panel.

FIG. 40 is an explanatory diagram of a display screen on a lower image display panel.

FIG. 41 is an explanatory diagram of a display screen on a lower image display panel.

FIG. 42 is an explanatory diagram of a display screen on a lower image display panel.

FIG. 43 is an explanatory diagram of a display screen on a lower image display panel.

FIG. 44 is an explanatory diagram of a display screen on a lower image display panel.

FIG. 45 is a flowchart of a normal game running process.

FIG. 46 is a flowchart of a feature execution process.

FIG. 47 is a flowchart of a scroll display control process.

FIG. 48 is an explanatory diagram of a spin table.

FIG. 49 is an explanatory diagram of an LED data table.

FIG. 50 is an explanatory diagram showing a layout of display screens on the lower image display panel.

FIG. 51 is an explanatory diagram showing operation status of various meters.

FIG. 52 is an explanatory diagram showing operation status of various meters.

FIG. 53 is an explanatory diagram showing operation status of various meters.

FIG. 54 is an explanatory diagram showing operation status of various meters.

FIG. 55 is an explanatory diagram showing operation status of various meters.

FIG. 56 is an explanatory diagram showing operation status of various meters.

FIG. 57 is an explanatory diagram showing operation status of various meters.

FIG. 58 is an explanatory diagram showing operation status of various meters.

FIG. 59 is an explanatory diagram showing operation status of various meters.

FIG. 60 is an explanatory diagram showing operation status of various meters.

FIG. 61 is an explanatory diagram showing a menu window.

FIG. 62 is an explanatory diagram showing a help screen.

FIG. 63A is an explanatory diagram showing operation on a control panel in the help screen.

FIG. 63B is an explanatory diagram showing operation on a control panel in the help screen.

FIG. 63C is an explanatory diagram showing operation on a control panel in the help screen.

FIG. 64 is an explanatory diagram of a display screen on the lower image display panel.

FIG. 65 is an explanatory diagram of a display screen on the lower image display panel.

FIG. 66 is an explanatory diagram of a display screen on the lower image display panel.

FIG. 67 is an explanatory diagram of a display screen on the lower image display panel.

FIG. 68 is an explanatory diagram of a display screen on the lower image display panel.

FIG. 69 is an explanatory diagram of a display screen on the lower image display panel.

FIG. 70 is an explanatory diagram showing an audit screen.

FIG. 71 is an explanatory diagram of a display screen on the lower image display panel.

FIG. 72 is an explanatory diagram of a display screen on the lower image display panel.

FIG. 73 is an explanatory diagram of a display screen on the lower image display panel.

FIG. 74 is an explanatory diagram of a display screen on the lower image display panel.

FIG. 75 is an explanatory diagram of a display screen on the lower image display panel.

FIG. 76 is an explanatory diagram showing a button prereading process.

FIG. 77 is an explanatory diagram showing a button prereading process.

FIG. 78 is an explanatory diagram of a display screen on the lower image display panel.

FIG. 79 is an explanatory diagram of a display screen on the upper image display panel and the lower image display panel.

FIG. 80 is an explanatory diagram of a display screen on the lower image display panel.

FIG. 81 is an explanatory diagram of a display screen on the lower image display panel.

FIG. 82 is an explanatory diagram of a display screen on the lower image display panel.

FIG. 83 is an explanatory diagram of a display screen on the lower image display panel.

FIG. 84 is an explanatory diagram of a display screen on the lower image display panel.

FIG. 85 is an explanatory diagram of a display screen on the upper image display panel and the lower image display panel.

FIG. 86 is an explanatory diagram of a win effect screen.

FIG. 87 is an explanatory diagram of a win effect screen.

FIG. 88 is an explanatory diagram of a win effect screen.

FIG. 89 is an explanatory diagram of a win effect screen.

FIG. 90 is an explanatory diagram of a win effect screen.

FIG. 91 is an explanatory diagram of a win effect screen.

FIG. 92 is an explanatory diagram of a win effect screen.

FIG. 93 is an explanatory diagram of a win effect screen.

FIG. 94 is an explanatory diagram of a win effect screen.

FIG. 95 is an explanatory diagram of a win effect screen.

FIG. 96 is an explanatory diagram of a win effect screen.

FIG. 97 is an explanatory diagram of a win increment operation.

FIG. 98 is an explanatory diagram of a win increment operation.

FIG. 99 is an explanatory diagram of an example control panel.

FIG. 100 is an explanatory diagram of an example control panel.

FIG. 101 is an explanatory diagram of an example control panel.

FIG. 102 is an explanatory diagram of an example control panel.

FIG. 103 is an explanatory diagram of an example control panel.

FIG. 104 is an explanatory diagram of an example control panel.

FIG. 105 is an explanatory diagram of an example control panel.

FIG. 106 is an explanatory diagram of an example control panel.

FIG. 107 is an explanatory diagram of an example control panel.

FIG. 108 is an explanatory diagram of an example gamble game.

FIG. 109 is an explanatory diagram of an example gamble game.

FIG. 110 is an explanatory diagram of an example gamble game.

FIG. 111 is an explanatory diagram of an example gamble game.

FIG. 112 is an explanatory diagram of an example gamble game.

FIG. 113 is an explanatory diagram of an example gamble game.

FIG. 114 is an explanatory diagram of an example gamble game.

FIG. 115 is an explanatory diagram of an example gamble game.

FIG. 116 is an explanatory diagram of an example gamble game.

FIG. 117 is an explanatory diagram of an example gamble game.

FIG. 118 is an explanatory diagram of an example gamble game.

FIG. 119 is an explanatory diagram showing an audit screen.

FIG. 120 is an explanatory diagram showing an audit screen.

FIG. 121 is an explanatory diagram showing an audit screen.

FIG. 122 is an explanatory diagram showing an audit screen.

FIG. 123 is an explanatory diagram of a ticket out screen.

FIG. 124 is an explanatory diagram of a ticket out screen.

### DESCRIPTION OF THE PREFERRED EMBODIMENTS

The following will describe a gaming machine of the present invention with reference to figures.

(Outline of Gaming Machine)

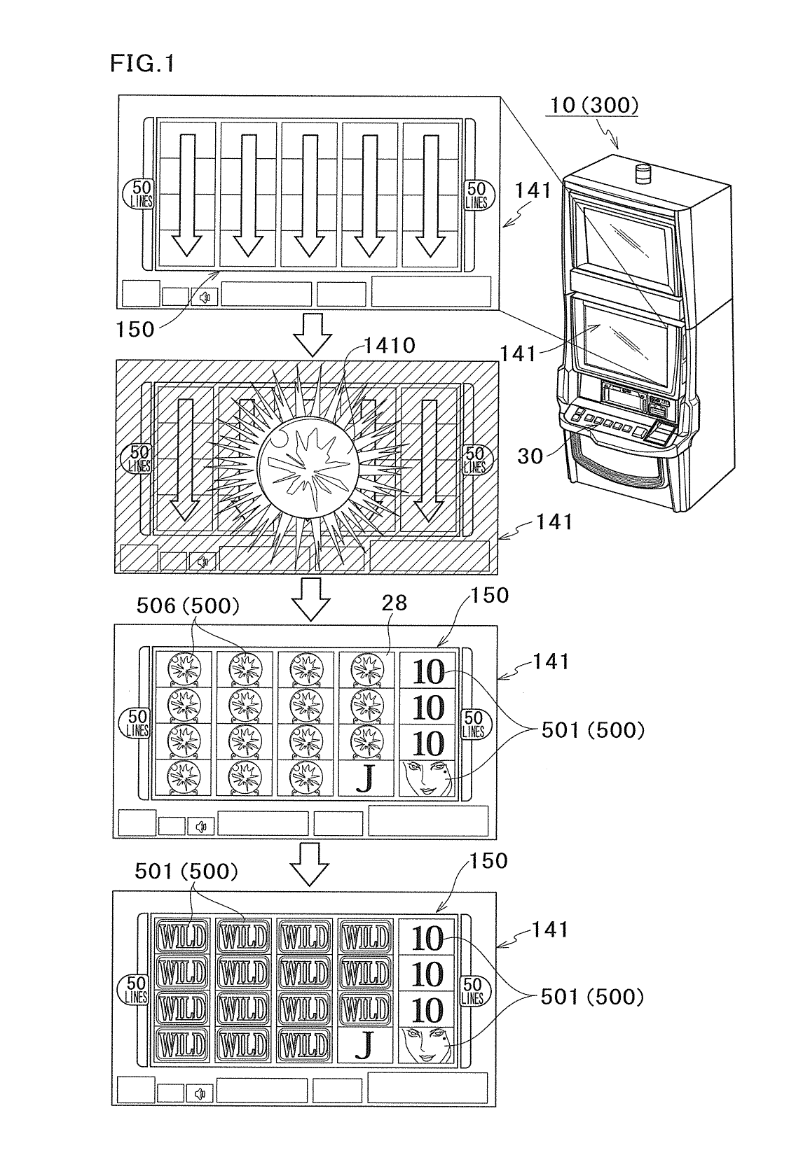

A gaming machine 300 (slot machine 10) is configured to suggest information related to game result in the form of indication effect, during the game before the game result is presented. As shown in FIG. 1, the gaming machine 300 includes a lower image display panel 141 serving as a symbol display device. On the lower image display panel 141, symbols 500 are rearranged thus displaying the game result, in the symbol display area 150 including a matrix of cells (display blocks 28), after a plurality of symbol arrays having a plurality of symbols 500 including normal symbols 501 and one or more special symbols 506 each of which is capable of replacing any one of the normal symbols 501 are variably displayed. The gaming machine 300 runs a game (normal game, free game) which provides such an effect, and awards a payout to the player according to the game result. Before the variable displaying is started, the gaming machine 300 determines a plurality of symbols 500 to be rearranged on the lower image display panel 141, and when the special symbol 506 included in the symbols determined satisfy a predetermined condition, executes a process of determining whether to perform the predetermined effect (displaying of a crystal ball appearing indication effect image 1410). In the following the special symbol 506 may be also referred to as mystery symbol or crystal ball symbol.

Here, the following describes the special symbol 501 capable of replacing any one of the normal symbols 501. In slot games in general, the game result is determined according to the arrangement of the symbols 500 rearranged in the symbol display area 150. To determine the game result, the gaming machine 300 specifies the arrangement of the symbols 500 at a predetermined timing. In this process, the gaming machine 300 regards the special symbol 506 as any one of the normal symbols 501. That is, to replace any one of the normal symbols 501 means that, in the process of determining the game result, the gaming machine 300 uses the special symbol 506 in substitution for that any one of the normal symbols 501. It should be noted that, in the present embodiment, an effect is performed such that the special symbol 506, when rearranged, is converted to any one of the normal symbols 50. With the conversion of the special symbol 506 to any one of the normal symbols 501, the game result is shown to the player. That is, it is possible to inform that the special symbol 506 satisfies the predetermined condition, by means of the predetermined effect (indication effect), before the symbols 500 are rearranged.

Further, as shown in FIG. 1, the gaming machine 300 of the present embodiment further includes a control panel 30 serving as a bet input device capable of receiving a bet whose bet amount is designated by a player. The gaming machine 300 runs, as the game, a normal game which requires placing of a bet through the control panel 30, and awards a payout according to the game result of the normal game. Then, the gaming machine determines whether to perform the predetermined effect (displaying of an indication effect image 1410) during the variable display in the normal game, when a predetermined number or more of special symbols 506 are to be rearranged in the lower image display panel 141, and when the payout equals to or surpasses the product of bet amount multiplied by a predetermined number.

It should be noted that the predetermined effect is performed during the variable displaying. Therefore, the determination of whether or not the predetermined number or more of special symbols 506 are rearranged and the determination of whether or not the payout is at least a product of a bet amount multiplied by a predetermined number are performed during a period ranging from a point before the start of variable display and at least including a period of variable displaying. As described, the expression “special symbols 506 each of which is capable of replacing any one of the normal symbols 501” means that the special symbol 506 is substituted for any one of the normal symbols 501, in at least the process of determining the payout based on the game result.

(Overview of Indication Effect)

As shown in FIG. 1, when a bet is place via the control panel 30, variable displaying of symbol arrays is started in the symbol display area 150 of the lower image display panel 141. At this time, the gaming machine 300 determines, in advance, the symbols 500 to be rearranged in the symbol display area 150. Further, the gaming machine 300 determines whether or not the symbols 500 to be rearranged in the symbol display area 150 include a predetermined number or more of the special symbols 506. Further, the gaming machine 300 determines the or each special symbol 506 to be rearranged is substituted for which one of the normal symbols 501 to be rearranged, and determines whether or not the payout to be awarded according to the game result is at least a product of the bet amount multiplied by a predetermined number. Then, when these conditions are satisfactory, the gaming machine 300 displays the indication effect image 1410 during the variable display. Then, the gaming machine 300 rearranges symbols 500 in the symbol display area 150 and performs an effect display of converting the special symbol 506 rearranged into the normal symbol 501.

It should be noted that there are following additional conditions in the present embodiment. Namely, the gaming machine 300 performs the indication effect only when the special symbol 506 to be rearranged is handled as a wild symbol 505 or a design symbol 503. That is, the gaming machine 300 does not perform the indication effect when the special symbol 506 to be rearranged is handled as a royal symbol 502. As in the above case, whether to perform the indication effect may be determined based on which one of the normal symbol 501 the special symbol 506 is substituted for.

It should be noted that the indication effect could be triggered in the normal game, and is also performed in the free game that awards a payout to the player according to the game result. The free game is a game that does not require placement of a bet via the control panel 30. The indication effect in the free game is performed as described below. That is, the gaming machine 300 determines whether to perform the indication effect during the variable display in the free game, when a predetermined number or more of special symbols 506 are to be rearranged in the lower image display panel 141, and when the payout equals to or surpasses the product of bet amount in the normal game having triggered the free game multiplied by a predetermined number.

### DEFINITION

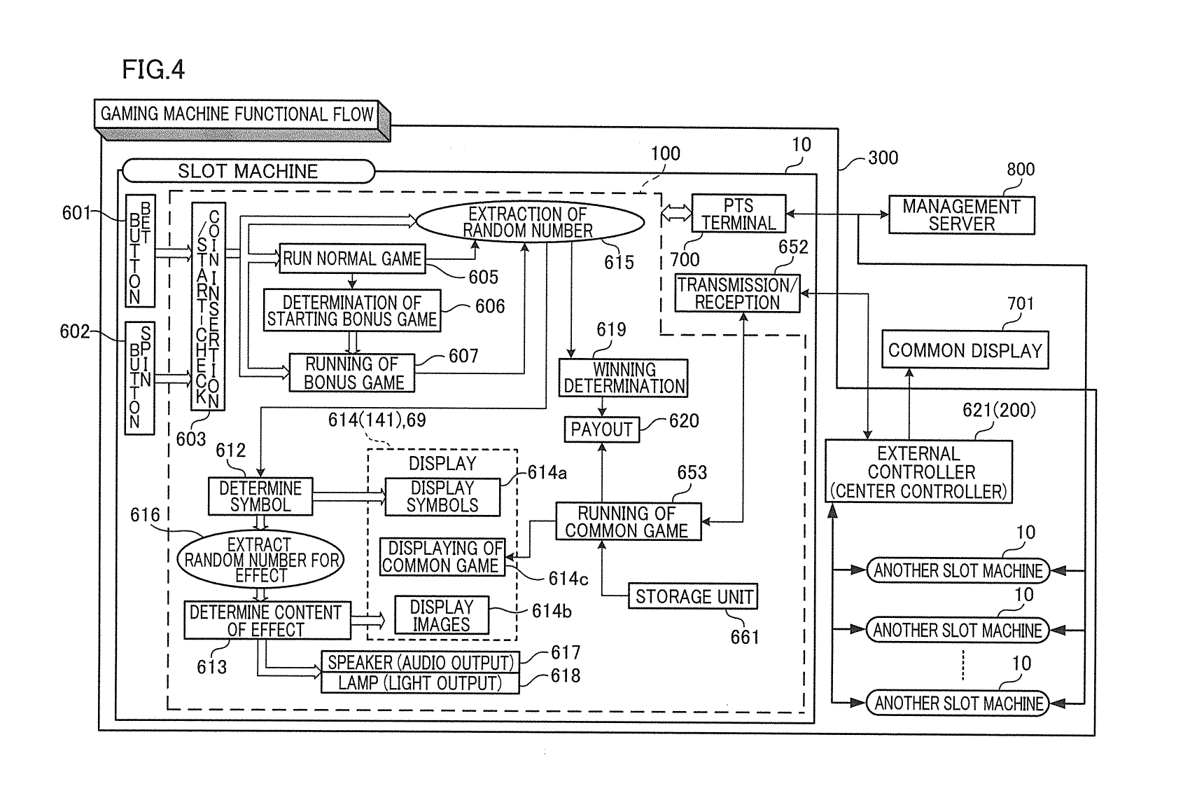

In the present embodiment, the gaming machine 300 is structured so as to enable participation of multiple players, and a plurality of slot machines 10 serving as the gaming terminals are connected to a center controller 200 (FIG. 4, FIG. 5) in such a manner as to enable data communications. The gaming machine 300 is able to run a base game such as a slot game at each slot machine 10 and run a common game at a common display device 701 or the like while synchronizing the slot machines 10. The slot machines 10 and the center controller 200 are connected wireless, by wires, or by both of them. However, the present invention is not limited to this, and the gaming machine 300 may be arranged such that one or more slot machine 10 has the function of the center controller 200 and the slot machines 10 are connected to be able to communicate with one another. Alternatively, the gaming machine may be a single slot machine. A unit of bet amount may be a currency of a country or area such as dollar, yen, euro, or the like, or may be a game point used exclusively in a hall having the gaming machine 300 or in the industry.

The rearrangement of the symbols in the slot game is conducted on the lower image display panel 141. The slot game includes: a process of executing a normal game of rearranging symbols on the lower image display panel 141 when a gaming value is bet and awarding a normal payout in accordance with the rearranged symbols; a process of, when the symbols are rearranged in a predetermined condition in the normal game, i.e., when a trigger condition is established, shifting to a bonus game in which a re-trigger condition which is less stringent than the trigger condition may be established; and a process of, when the retrigger condition is established in the bonus game, increasing a benefit awarded to the player in the bonus game.

To be more specific, in the slot game, a feature game is executed as a bonus game. The “feature game” is a game in which one or more free games are run. Therefore, the slot game includes a process of, when the trigger condition is established, shifting to the feature game (bonus game) in which the re-trigger condition which is less stringent than the trigger condition may be established; a process of executing the free game at least once in the feature game; and a process of, when the retrigger condition is established in the feature game, increasing the payout rate of the free game in the feature game.

While the present embodiment deals with the slot game in which the normal game and the feature game (bonus game) are executed, however, the embodiment is not limited to this. In the slot game, a bonus game different from the feature game may be executed in place of or in addition to the feature game. For example, the slot game may include a process of executing a bonus game where symbols are rearranged in a condition in which the payout rate is higher than the payout rate in the normal game and a bonus payout is awarded in accordance with the rearranged symbols. Furthermore, the slot game may include a process of executing a rescue process when a rescue start condition is established.

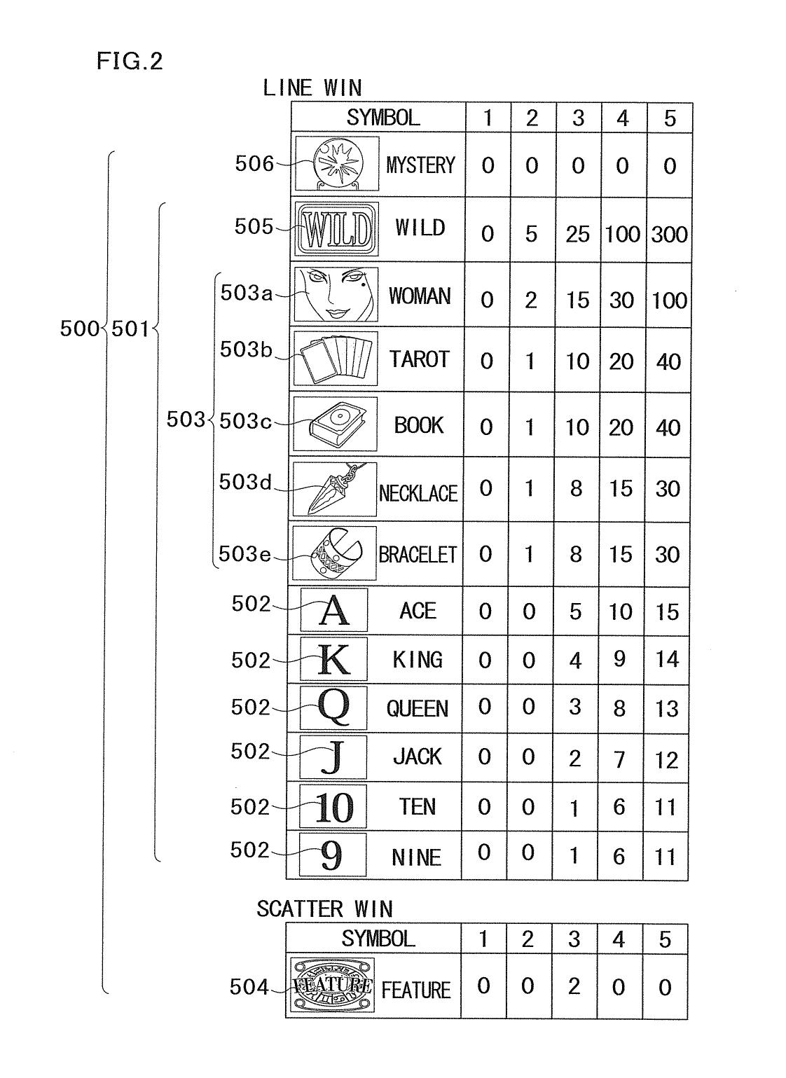

As shown in FIG. 2, a plurality of symbols 500 are constituted by a special symbol 506, normal symbols 501, and a trigger symbol 504. In other words, “symbol” 500 is a superordinate concept to the special symbols 506, normal symbols 501, and the trigger symbol 504. The normal symbols 501 include the wild symbol 505, the design symbol 503, and the royal symbol 502. That is, the special symbol 506 is substituted for any one of the wild symbol 505, the design symbol 503, and the royal symbol 502. The wild symbol 505 is a symbol substitutable for any type of symbols. That is, while the special symbol 506 is regarded as any one of the normal symbols 501 which are determined in advance, the wild symbol 505 is regarded as any type of royal symbols 502 or the design symbols 503, according to the other symbols 500 rearranged. The trigger symbol 504 is a symbol which triggers at least a bonus game. For example, the trigger symbol 504 functions as a trigger to shift the normal game to various types of the bonus game. In the present embodiment, the trigger condition and the retrigger condition are established based on the trigger symbol 504. In the present embodiment, the trigger symbol 504 functions as a scatter symbol. That is to say, the trigger condition and the retrigger condition are established based solely on the number of the rearranged trigger symbols 504, irrespective of the payline. Furthermore, the trigger symbol 504 may function as a trigger of increase in the number of times to run the bonus game. For example, the trigger symbol 504 of the present embodiment causes the establishment of the retrigger condition which triggers the increase in the number of times of execution of the free game in the feature game which is the bonus game.

More specifically, the design symbols 503 include: a “WOMAN” symbol 503a, a “TAROT” symbol 503b, a “BOOK” symbol 503c, a “NECKLACE” symbol 503d, and a “BRACELET” symbol 503e. Further, the royal symbols 502 include: an “ACE” symbol, a “KING” symbol, a “QUEEN” symbol, a “JACK” symbol, a “TEN” symbol, and a “NINE” symbol.

The gaming value is electrically valuable information such as electronic money and the like. It is to be noted that the gaming value in the disclosure is not limited to these, and for example a game medium such as a medal, a token, a coin, a ticket or the like can be adopted. The ticket is not particularly limited, and for example, a ticket having data of credit amount and the like in the form of bar code. Alternatively, the gaming value may be a game point not including valuable information.

The “bonus game” is described as the feature game; however, the present invention is not limited to this, and the bonus game may be any type of game as long as it provides more advantageous gaming condition than the normal game. Other types of the bonus game may be additionally employed as long as the gaming state is advantageous for the player, i.e., the gaming state is more advantageous than that of the normal game. For example, the bonus game may be a game that provides a player with a chance of winning more gaming values than the normal game or a game that provides a player with a higher chance of winning gaming values than the normal game. Alternatively, the bonus game may be a game that consumes fewer amounts of gaming values than the normal game. In the bonus game, these games may be provided alone or in combination.

The free game is a game which is executable with a smaller amount of gaming values bet than in the normal game. Note that “bet of fewer amounts of gaming values” encompasses a bet of 0 gaming value. The “free game” therefore may be a game runnable without a bet of a gaming value, which free game awards an amount of gaming values based on symbols rearranged. In other words, the “free game” may be a game which is started without consumption of a gaming value. To the contrary, the “normal game” is a game runnable on condition that a gaming value is bet, which normal game awards an amount of gaming value based on the symbols rearranged. In other words, the “normal game” is a game which starts with consumption of a gaming value.

The term “rearrangement” indicates that the symbols are rearranged after the arrangement of the symbols is dismissed. Arrangement means a state where the symbols can be visibly confirmed by a player. More specifically, “rearrangement” is a state in which, after the symbols on the reels are variably displayed as the reels rotate, the variable display of the symbols stops as the rotation of the reels stops, and the symbols stop in the display window.

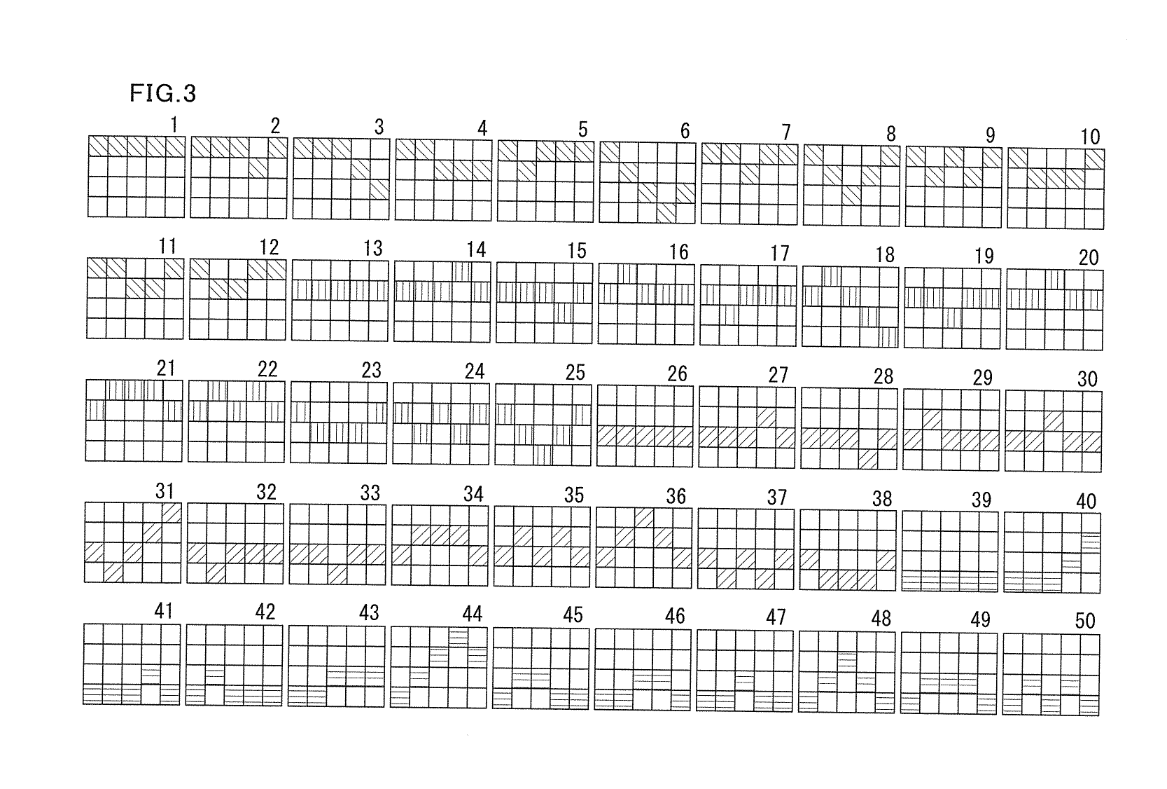

The phrase “payout based on the rearranged symbols” means a payout corresponding to a rearranged winning combination in the normal game and the bonus game (free game). Furthermore, the term “winning combination” indicates that a winning is established. As shown in FIG. 3, there are 50 different paylines in the present embodiment. Rearrangement of a plurality of identical symbols 500 on a payline forms a winning combination, which generates a payout for the player. The cells structuring the 50 boxes in FIG. 3 are each a display block 28 of the symbol display area 150. Each payline is formed by a total of 5 display blocks 28, i.e., one display block 28 selected out of each column in the symbol display area 150. That is, formation of a winning combination is determined for each payline, and a payout occurs for every winning combination formed. It should be noted that the paylines are not limited to those, and for example, any pattern formed by one display block 28 out of each column is possible. Further, in the present embodiment, the scatter mode is adopted only for the trigger symbol 504 in determining the prize; however, the scatter mode may be adopted for all symbols 500 in determining the prize.

(Functional Flow of Gaming Machine 300: Slot Machine)

The gaming machine 300 arranged as above includes, as shown in FIG. 4, slot machines 10 and an external controller 621 (center controller 200) connected to the slot machines 10 to be able to communicate therewith. The external controller 621 is able to communicate with the slot machines 10 provided in a hall.

Each slot machine 10 includes a BET button 601 (control panel 30), a spin button 602, and a display 614 (such as a lower image display panel 141 shown in FIG. 1), and further includes a game controller 100 configured to control these units. The BET button 601 and the spin button 602 are kinds of input devices. The slot machine 10 further includes a transceiver unit 652 that makes it possible to perform data communication with the external controller 621.

The BET button 601 above has a function of receiving a bet amount input by the player. The spin button 602 has a function of receiving an instruction to start a game such as a normal game in response to an operation by the player, i.e., a start operation. The display 614 has a function of displaying still image information such as various symbols, numbers, and characters, and moving image information such as effect videos. Furthermore, the display 614 has a touch panel 69 as an input device, and has a function of receiving various instructions input by a pressing operation by the player. The display 614 has a symbol display region 614a, an image display region 614b, and a common game display region 614c. The symbol display region 614a displays a reel screen including the symbols shown in FIG. 1. The image display region 614b displays various types of effect image information (including the common indication effect and the individual indication effect) executed during a game, by means of moving images and still images. The common game display region 614c displays a common game.

Although in the present embodiment the symbol display region 614a, the image display region 614b, and the lower image display panel 141 are provided on the same screen, the disclosure is not limited to this arrangement. The common game display region 614c may be formed together with the symbol display region 614a and the image display region 614b, or may appear as a substitute only when a common game is run.

The game controller 100 includes: a bet/start-check unit 603; a normal game running unit 605; a bonus game start determining unit 606; a bonus game running unit 607; a random number sampling unit 615; a symbol determining unit 612; an effect-use random number sampling unit 616; an effect determining unit 613; a speaker unit 617; a lamp unit 618; a winning determining unit 619; and a payout unit 620.

The normal game running unit 605 has a function of running a normal game on condition that the bet button unit 601 has been operated. The bonus game start determining unit 606 determines whether to run a bonus game, based on a combination of the symbols rearranged in the normal game. That is to say, the bonus game start determining unit 606 has a function of determining that a bonus game is obtained when a trigger symbol 504 or the like is rearranged in a predetermined condition, and shifting the process to the bonus game running unit 607 so that a bonus game is run from the next unit game.

It is noted that “unit game” is a series of operations from the start of the receiving of a bet to a state in which an award can be established. For example, a unit game in the normal game includes a single bet time for receiving a bet, a single game time of rearranging stopped symbols 501, and a single payout time of a payout process of awarding a payout. A unit game in the normal game is termed unit normal game.

The bonus game running unit 607 has a function of running a bonus game in which a free game is repeated only by an operation of the spin button 602.

The symbol determining unit 612 has functions of: determining symbols to be rearranged with reference to a random number value from the random number sampling unit 615; rearranging the determined symbols on the symbol display region 614a of the display 614; outputting rearrangement information of the symbols to the winning determining unit 619; and outputting an effect specifying signal to the effect-use random number sampling unit 616 based on the state of the rearrangement of the symbols.

The effect-use random number sampling unit 616 has a function of sampling an effect random number when receiving an effect instruction signal from the symbol determining unit 612 and a function of outputting the effect random number to the effect determining unit 613. The effect determining unit 613 has a function of determining the effect content by using the effect random number, an effect of outputting the image information of the determined effect content to the image display region 614b of the display 614, and a function of outputting audio/light information of the determined effect content to the speaker unit 617 and the lamp unit 618.

The winning determining unit 619 has a function of determining the presence of winning when obtaining rearrangement information of the symbols, which is a display state of rearrangement on the display 614, a function of calculating a payout amount based on the winning combination when it is determined that winning is achieved, and a function of outputting a payout signal to the payout unit 620 based on the payout amount. The payout unit 620 has a function of paying out a gaming value to the player, in the form of electronic money and the like. Furthermore, the payout unit 620 has a function of adding credit data corresponding to the credit to be paid out to credit data stored in an IC card inserted into the later-described PTS terminal 700.

In addition to the above, the game controller 100 includes a storage unit 661 that stores various types of bet amount data. The storage unit 661 stores data in a rewritable manner, e.g., a hard disk device and a memory.

In addition to the above, the game controller 100 has a common game running unit 653. The common game running unit 653 has functions of: outputting bet amount information based on a bet amount bet on a normal game to the external controller 621 in each unit base game; executing a common game in response to a game start command from the external controller 621; and receiving a bet input through the BET button 601 for a bet amount corresponding to bet amount data for a common game, which is stored in the storage unit 661 and is bettable on a common game.

Further, the game controller 100 is connected to the PTS terminal 700. The PTS terminal 700 is a unit in which an LCD, a microphone, a human body detection camera, etc. are integrated, and has, for example, a function of executing an effect for a game by mutual communications with the game controller 100. In particular, the PTS terminal 700 has a card slot to which an IC card can be inserted. With this, the player is able to insert an IC card into the card slot and use the credits stored in the IC card in the slot machine 10. The mechanical structure of the PTS terminal 700 will be described later.

In addition to the above, when receiving credit data from the PTS terminal 700, the game controller 100 updates the credit display on the display 614. Furthermore, the game controller 100 outputs settled credit data to the PTS terminal 700 when the credits on a game are settled.

Furthermore, the PTS terminal 700 of each of the slot machines 10 constituting the gaming machine 300 is connected to a management server 800 to be able to communicate each other, and centrally manages the download of images, IC cards and credits.

(Function Flow of Gaming Machine 300: External Controller)

The slot machine 10 arranged as above is, as shown in FIG. 5, connected to the external controller 621. The external controller 621 has a function of remotely operating and monitoring the operation state of each slot machine 10 and processes such as changes in game setting values. Furthermore, the external controller 621 has a function of determining a common game start condition for each gaming terminal which is the slot machine 10, and executing a common game at a plurality of slot machines 10 when a determination result at any gaming terminal satisfies the common game start condition.

More specifically, the external controller 621 includes a common game start unit 6213, a gaming terminal selection unit 6215, and a transceiver unit 6217. The common game start unit 6213 has functions of: determining whether the common game start condition is established based on the accumulated bet amount information sent from the slot machine 10 in each unit base game; outputting a game start command to a plurality of slot machines 10; and displaying on the common display device 701 states until the common game start condition is established.

The determination as to whether the common game start condition is established is based on the accumulated bet amount information or based on all accumulated values that increase as the unit base game is repeated. For example, the number of times of running the base game and the game time of the base game may be used as the accumulated values.

The gaming terminal selection unit 6215 has a function of selecting a specific slot machine 10 from the slot machines 10 and outputting a common game start command signal to that specific slot machine 10. The common game start command signal provides the specific slot machine 10 with the right to start the common game. The transceiver unit 6217 has a function of exchanging data with the slot machines 10.

(Operations of Gaming Machine 300)

The operations of the gaming machine 300 having the functional blocks above will be described. While in the present embodiment the “gaming terminal” shown in the flowcharts indicates a slot machine 10 executing a slot game, the disclosure is not limited to this arrangement.

(Operations of Slot Machine 10)

A slot machine 10 which is a gaming terminal executes terminal-side processes. More specifically, to begin with, a base game process (e.g., normal game) is executed. That is, a series of operations below are executed.

(Coin-Insertion/Start-Check)

First, the slot machine 10 checks whether or not a BET button 601 has been pressed by a player, and subsequently checks whether or not a spin button 602 has been pressed by the player.

(Symbol Determination)

Next, when a spin button 602 has been pressed by the player, the slot machine 10 extracts a random number for symbol determination, and determines symbols to be displayed for the player at the time of stopping the scroll of the symbol array, for respective video reels displayed on a display unit 614.

(Symbol Display)

Then the slot machine 10 starts the scroll of the symbol array of each video reel, and stops the scroll so that the determined symbols are displayed for the player.

(Winning Determination)

Subsequently, as the scroll of the symbol array of each video reel is stopped, the slot machine 10 determines whether the combination of the symbols displayed for the player is a combination related to win.

(Payout)

When the combination of the symbols displayed for the player is a combination related to win, the slot machine 10 offers, to the player, benefit according to the combination.

For example, when a combination of symbols related to a payout has been displayed, the slot machine 10 awards an amount of payout corresponding to the combination of symbols to the player.

Subsequently, whether to win a bonus combination is determined. When winning the bonus combination, a bonus game process is executed. On the other hand, when not winning the bonus combination, the normal game is run again. During a period in which the base game including such a normal game and bonus game is being run, execution state information indicating the start and end of the unit game such as the normal game and the bet amount on the unit game is transmitted to the external controller 621. With this, the external controller 621 centrally manages the execution state information of each slot machine 10.

(Operation of External Controller 621)

When the slot machines 10 operate as above, the external controller 621 executes the following center-side processes in synchronization with the slot machines 10.

To begin with, the external controller 621 receives the execution state information from each slot machine 10 and obtains the execution state of the base game. Thereafter, based on the number of the repetition of the base game, the accumulated bet amount, or the like, whether the common game start condition is established at any slot machine 10 is determined. When the common game start condition is not established, the acquisition of the execution state of the base game at each slot machine 10 is continued.

In the meanwhile, when the common game start condition is established, the game start command is simultaneously output to the slot machines 10 that satisfy the game running condition. Thereafter, a specific slot machine 10 is selected from the slot machines 10 satisfying the game running condition, and a common game start right instruction is output to the specific slot machine 10.

Thereafter, the external controller 621 waits for the common game start command to be supplied from the specific slot machine 10. Upon receiving the common game start command, the result of the common game is determined as a game result. The game result is, for example, win, lose, or draw. When the game result is not draw, at least a part of a draw game result is skipped among a series of temporarily-stored game results, and the remaining game results are serially output to the slot machines 10, as game result information.

Thereafter, based on the winning or losing game result, whether to win in the common game is determined. When lost, the execution state of the base game at each slot machine 10 is newly obtained. On the other hand, when won, a payout amount is calculated based on the bet amount bet on the common game at each slot machine 10, and the payout amount is sent to each slot machine 10 as payout information.

(Overall Structure of Game System)

A game system 350 including the gaming machine 300 having the functions above will be described.

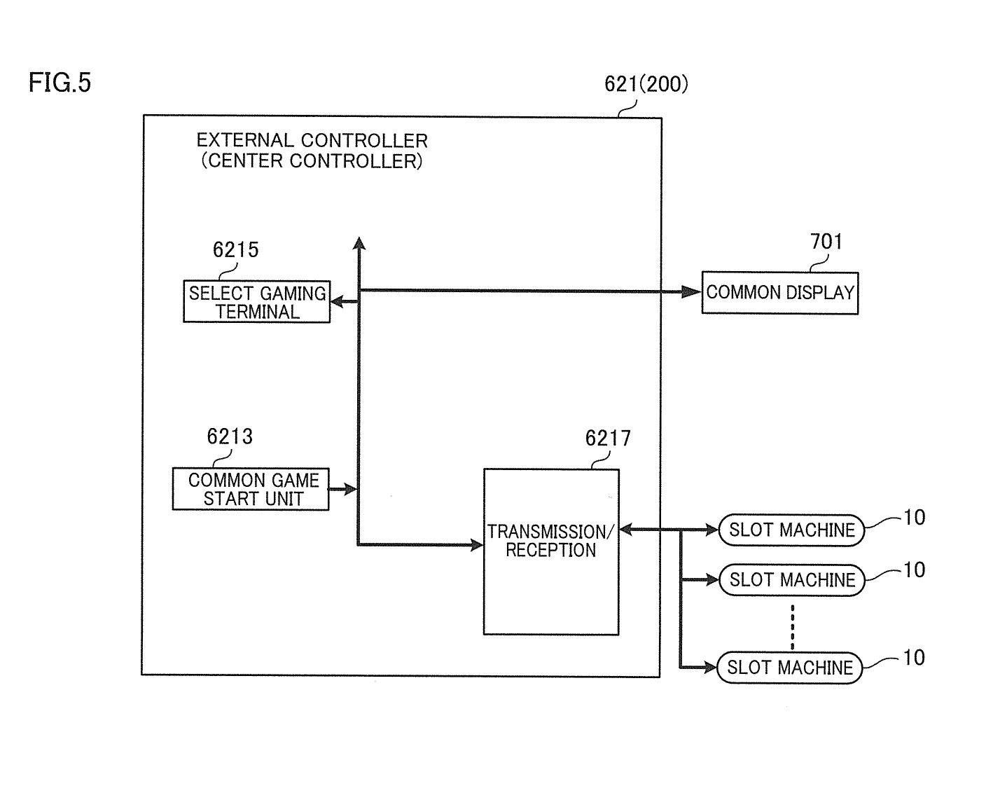

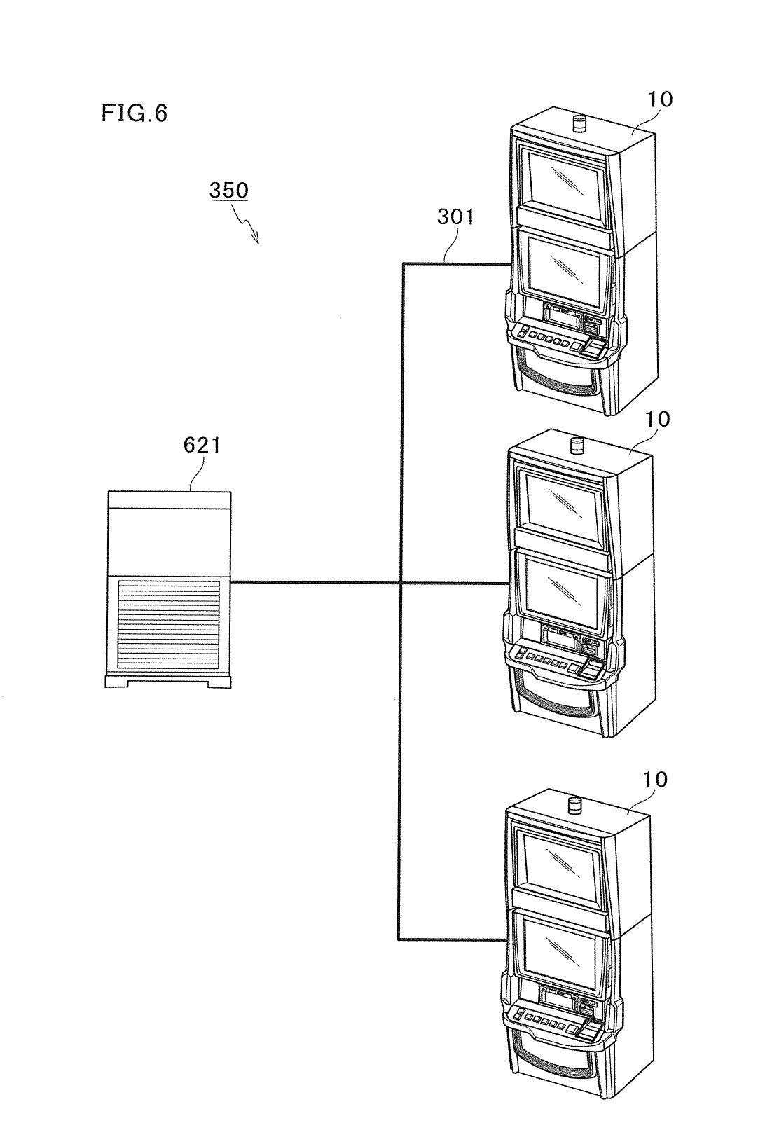

As shown in FIG. 6, the game system 350 includes the slot machines 10 and the external controller 621 connected to the slot machines 10 over a communication line 301.

The external controller 621 is configured to control the slot machines 10. In the present embodiment, the external controller 621 is a so-called hall server provided in a gaming facility where a plurality of slot machines 10 are provided. Each of the slot machines 10 has a unique identification number, and the external controller 621 identifies which one of the slot machines 10 transmitted data, by referring to the identification number. Further, when transmitting data from the external controller 621 to any of the slot machines 10, the identification number is used for designating the transmission destination.

The game system 350 may be constructed in a single gaming facility such as a casino where various games are playable or may be constructed for a plurality of gaming facilities. Further, when the game system 350 is constructed in a single gaming facility, the gaming system may be constructed in each floor or section of the gaming facility. The communication line 301 may be a wired or wireless line, and can adopt a dedicated line, an exchange line or the like.

(Mechanical Structure of Slot Machine)

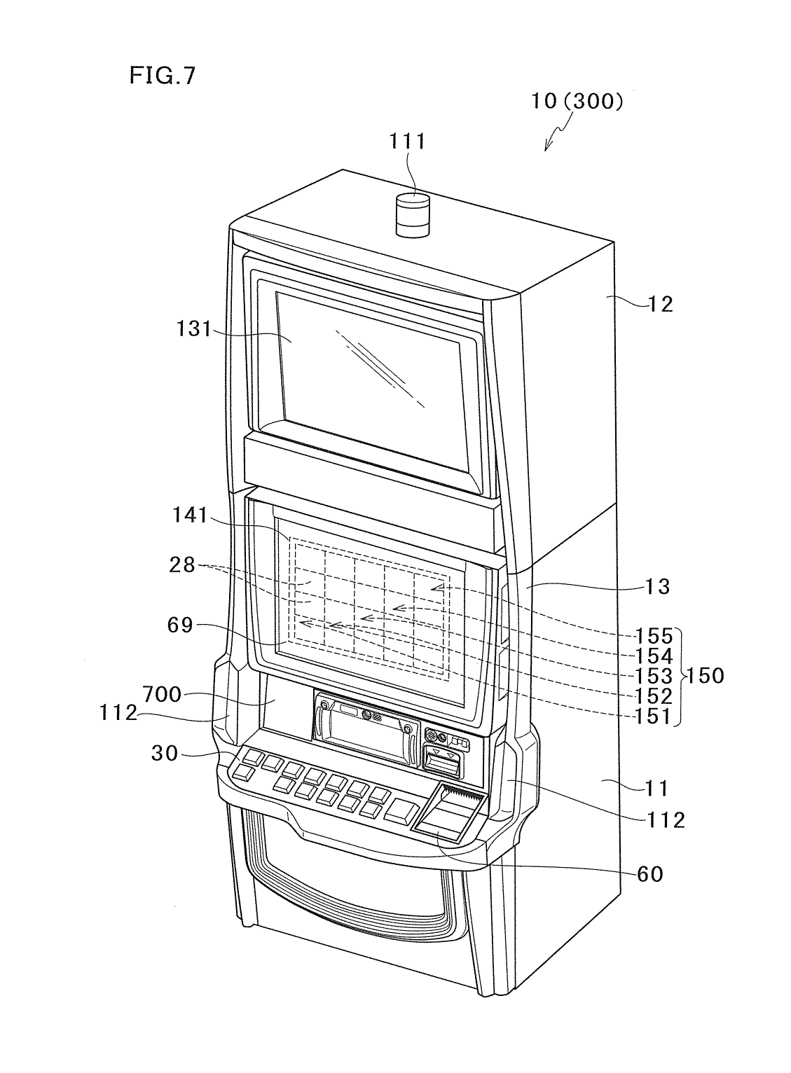

Referring to FIG. 7, the overall structure of the slot machine 10 will be described.

Electrically valuable information such as electronic money is used as a gaming value in the slot machine 10. It is to be noted that the gaming value is not limited to these, and for example a coin, a medal, a token, a ticket with a bar code and the like can be adopted.

The slot machine 10 includes a cabinet 11, a top box 12 installed on the upper side of the cabinet 11, and a main door 13 provided at the front surface of the cabinet 11. To the main door 13 is provided a speaker 112.

On the main door 13, a symbol display device termed lower image display panel 141 is provided. The symbol display device is formed by a transparent liquid crystal panel. The screen displayed on the lower image display panel 141 has a symbol display region 150 at the central portion. The symbol display region 150 is constituted by 20 display blocks 28 forming a matrix of 5 columns and 4 rows. The 4 display blocks 28 of each column form pseudo reels 151 to 155. On each of the pseudo reels 151 to 155, the 4 display blocks 28 move downward with changes in speed, so that the symbols on the display blocks 28 are vertically rotated (variably displayed) and then stopped, in other words, the symbols are rearranged. The details of the display screen on the lower image display panel 141 will be given later.

While the present embodiment the slot machines 10 are so-called video slot machines, some mechanical reels in the slot machines 10 of the present invention may be replaced by the pseudo reels 151 to 155.

On the front surface of the symbol display device is provided a touch panel 69. The touch panel 69 allows a player to input various instructions by touching the display screen of the lower image display panel 141. The input signal is transmitted from the touch panel 69 to the main CPU 71.

An upper image display panel 131 is provided at the front face of the top box 12. The upper image display panel 131 includes a liquid crystal panel, and forms the display. The upper image display panel 131 displays images related to effects and images showing introduction of the game contents and explanation of the game rules. Further, the top box 12 is provided with a lamp 111. The slot machine 10 produces effects by displaying images, outputting sounds, and outputting the light.

Below the lower image display panel 141 are provided a control panel 30 having various buttons, PTS device 700, and a bill entry 22.

The bill entry 60 validate bills and receives genuine bills into the cabinet 11. The bill entry 60 is electrically connected to the PTS device 700, and when a legitimate bill is received, transmits to the PTS device 700 an input signal based on the value of the bill. The input signal represents information of credit data and the like related to the bill received.

The PTS device 700 is a unit in which an LCD (liquid crystal display), a human body detection camera, a microphone, and the like are integrated. The human body detection camera makes it possible to detect the presence of a player by the camera function. The microphone is used for the player's participation in a game by voice and the authentication of a player by voice recognition. Further, the PTS device 700 has a card slot to which an IC card can be inserted. With this, the player is able to insert an IC card into the card slot and use the credits stored in the IC card in the slot machine 10.

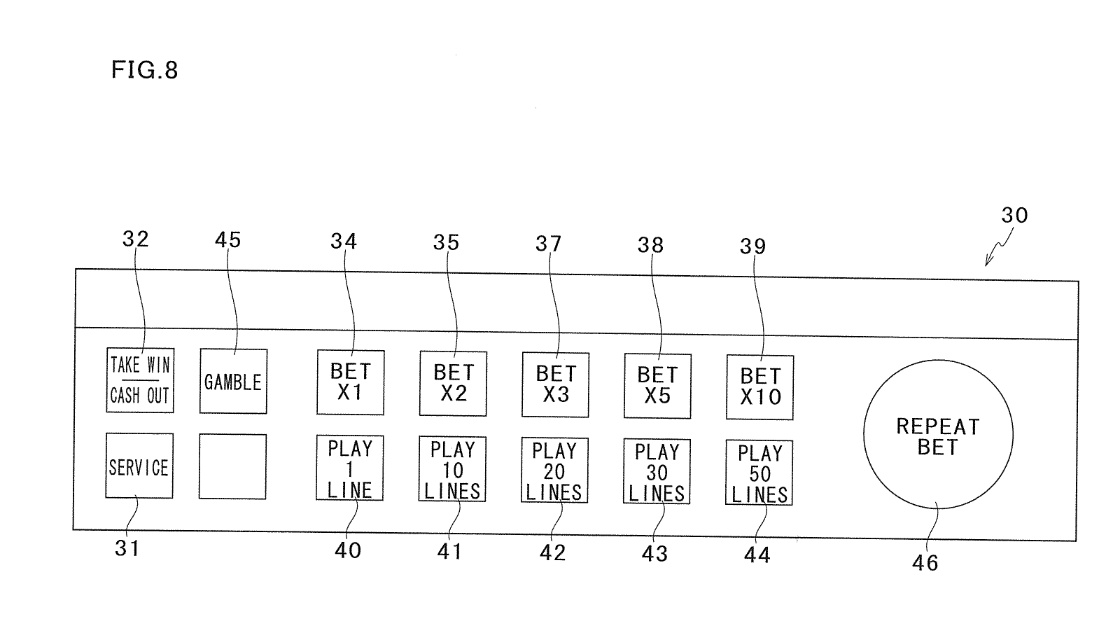

As shown in FIG. 8, on the control panel 30, there are a plurality of columns arranged in two stages, i.e., the upper and lower stages. On the right end portion is arranged a repeat bet button 46. Specifically, in the upper stage of the control panel 30, there are arranged a cash-out button 32, a gamble button 45, a 1-bet button 34, a 2-bet button 35, a 3-bet button 37, a 5-bet button 38, and a 10-bet button 39 from the left side. Further, in the lower stage of the control panel 30, there are arranged a service button 31, a play 1 line button 40, a play 10 line button 41, a play 20 line button 42, a play 30 line button 43, a play 50 line button 44 from the left side. It is noted that the control panel 30 may have a different design of buttons in accordance with the type of the game.

The service button 31 is an operation button to be used when temporarily leaving the seat, or when requesting a staff person of the gaming facility for an exchange. The cash-out button 32 is a so-called settlement button by which credit data concerning credits obtained in games is added to the credit data stored in an IC card inserted into the PTS terminal 700.

Each time the 1-bet button 34 is pressed, a credit of 1 out of the player-owned credit is bet on each active payline L. The 2-bet button 35 is used to start a game with a bet of 2 credit on each active payline L. The 3-bet button 37 is used to start a game with a bet of 3 credit on each active payline L. The 5-bet button 38 is used to start a game with a bet of 5 credit on each active payline L. The 10-bet button 39 is used to start a game with a bet of 10 credit on each active payline L. As described, the amount of bet on 1 active payline L is determined by pressing the 1-bet button 34, the 2-bet button 35, the 3-bet button 37, the 5-bet button 38, and the 10-bet button 39.

The play 1 line button 40 is pressed for activating 1 paylines L. As the result, the number of active paylines L becomes 1. The play 10 line button 41 is pressed for activating 10 paylines L. In this case, the number of active payline is 10. The play 20 line button 42 is pressed for activating 20 paylines L. As a result, the number of active paylines L becomes 20. The play 30 line button 43 is pressed for activating 30 paylines L. As a result, the number of active paylines L becomes 30. The play 50-line button 44 is pressed for activating 50 paylines L. As a result, the number of active paylines L becomes 50.

For example, where there are 50 paylines of “1” to “50”, as shown in FIG. 3, pressing the play 1 line button 40 will activate only the payline “1”. Further, pressing the play 10 line button 41 will activate the paylines “1” to “10”. Pressing the play 20 line button 42 will activate the paylines “1” to “20”. Pressing the play 30 line button 43 will activate the paylines “1” to “30”. Pressing the play 50 line button 44 will activate the paylines “1” to “50”. The present invention is not limited to this, and all the 50 lines may be activated always irrespective of the bet amount.

As described, by pressing any of the bet buttons 34, 35, and 37 to 39 and further pressing the play line buttons 40 to 44, the amount of bet placed by the player is determined. That is, the normal game is started and the bet amount per line×the number of active paylines is subtracted from the credit. It should be noted that, when the bet amount and the number of active lines are determined by the bet buttons 34, 35, and 37 to 39, and the play lines 40 to 44, the variable display (spin) in the symbol display area 150 is automatically started. That is, the bet buttons 34, 35, and 37 to 39 and the play lines 40 to 44 function as the bet button 601 and also function as the spin button 602. Note that the maximum value of the bet amount selectable by these buttons is 500.

The bet amount for each line determined by the bet buttons 34, 35, and 37 to 39 is not limited to the above. For example, it is possible to adopt a configuration such that the bet amounts selectable by the bet buttons 34, 35, and 37 to 39 may be 1, 2, 3, 4, and 5 (maximum bet amount: 250); 1, 2, 5, 10, and 15 (maximum bet amount: 750); or 1, 2, 5, 10, and 20 (maximum bet amount: 1000).

The gamble button 45 is an operation button used for, for example, shifting to the gamble game after the end of the bonus game or the like. The gamble game is a game played with the consumption of an obtained credit.

The repeat bet button 46 is used for starting the game with the previously placed bet amount. That is, the repeat bet buttons 46 functions as the bet button 601 and also function as the spin button 602. This repeat bet button 46 also functions as a button for starting a bonus game and for adding a payout awarded in a bonus game to the credits.

(Electrical Structure of Slot Machine)

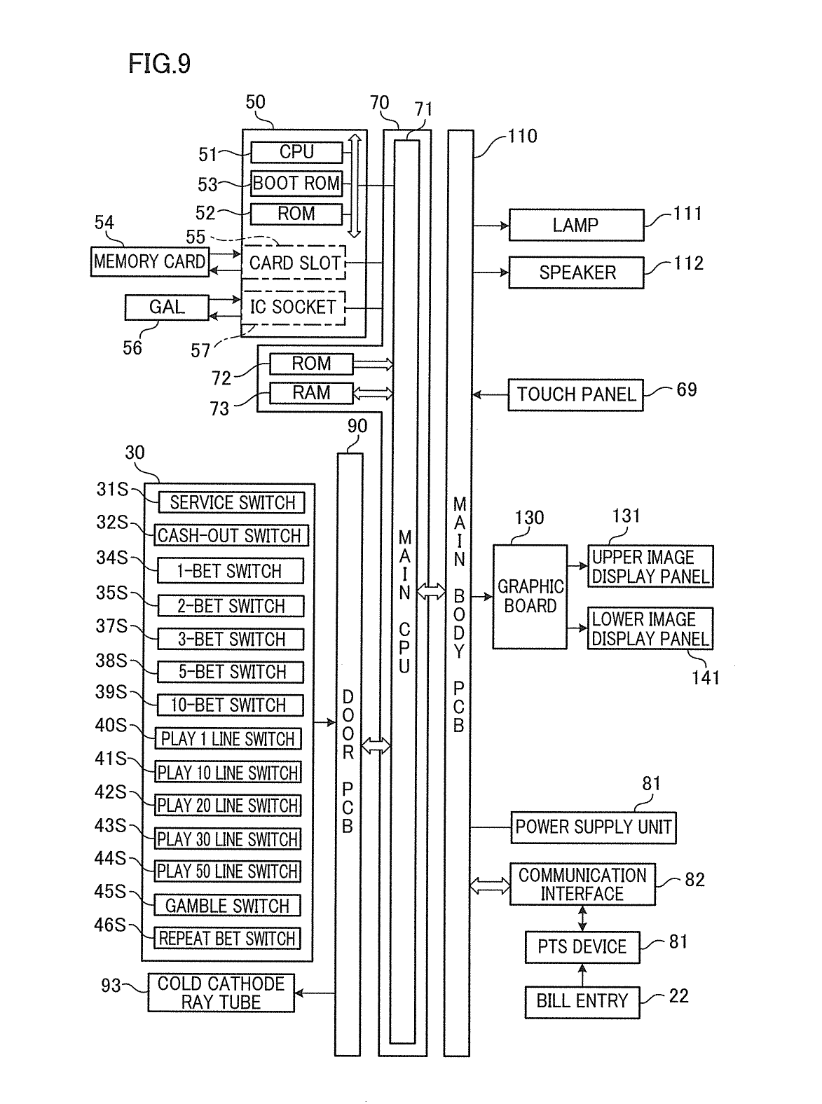

Now, referring to FIG. 9, the configuration of a circuit in the slot machine 10 will be described.

A gaming board 50 is provided with: a CPU 51, a ROM 52, and a boot ROM 53, which are mutually connected by an internal bus; a card slot 55 corresponding to a memory card 54; and an IC socket 57 corresponding to a GAL (Generic Array Logic) 56.

The memory card 54 includes a nonvolatile memory, and stores a game program. The game program includes a program related to game progression and an effect program for producing effects by images and sounds.

Further, the card slot 55 is configured so that the memory card 54 can be inserted thereinto and removed therefrom, and is connected to a motherboard 70 by an IDE bus. The type and contents of the game to be played on the slot machine 10 can be changed by drawing out the memory card 54 from the card slot 53S, writing another game program into the memory card 54, and inserting the memory card 54 into the card slot 53S.

The GAL 56 is a type of PLD (Programmable Logic Device) having a fixed OR array structure. The GAL 56 is provided with a plurality of input ports and output ports, and predetermined input into the input port causes output of the corresponding data from the output port.

Further, the IC socket 57 is configured so that the GAL 56 can be inserted thereinto and removed therefrom, and is connected to the motherboard 70 by a PCI bus. The contents of the game to be played on the slot machine 10 can be changed by replacing the memory card 54 with another memory card 54 having another program written therein or by rewriting the program written into the memory card 54 as another program.

The CPU 51, the ROM 52 and the boot ROM 53 mutually connected by the internal bus are connected to the motherboard 70 by a PCI bus. The PCI bus enables a signal transmission between the motherboard 70 and the gaming board 50, and power supply from the motherboard 70 to the gaming board 50.

The ROM 52 stores an authentication program. The boot ROM 53 stores a preliminary authentication program, a program (boot code) to be used by the CPU 51 for activating the pre-authentication program, and the like. The authentication program is a program (falsification check program) for authenticating the game program. The preliminary authentication program is a program for authenticating the aforementioned authentication program. The authentication program and the preliminary authentication program are written along a procedure (authentication procedure) for proving that the program to be the subject has not been falsified.

The motherboard 70 is constituted by a commercial general-purpose mother board (printed circuit board on which basic components for personal computers are mounted) and is provided with a main CPU 71, a ROM (Read Only Memory) 72, a RAM (Random Access Memory) 73, and a communication interface 82. This motherboard 70 is equivalent to the game controller 100 of the present embodiment.

The ROM 72 includes a memory device such as a flash memory, and stores a program such as BIOS (Basic Input/Output System) to be executed by the main CPU 71, and permanent data. When the BIOS is executed by the main CPU 71, processing for initializing predetermined peripheral devices is conducted. Further, through the gaming board 50, a process of loading the game program stored in the memory card 54 is started. In the present invention, the ROM 72 may be or may not be rewritable.

The RAM 73 stores data used for the operation of the main CPU 71 (later-described various tables and the like) and programs such as the symbol determination program. For example, when the process of loading the aforementioned game program or authentication program is executed, the RAM 73 can store the program. The RAM 73 is provided with working areas used for operations when these programs are executed. Examples of the areas include: an area that stores counter which manages the number of games, the bet amount, the amount of payout, the credit amount and the like; and an area that stores symbols (code numbers) randomly determined.

The communication interface 82 is for communicating with the PTS device 700 or a not-shown external controller. The PTS device 700, upon reception of an input signal from the bill entry 22, transmits credit data contained in the input signal to the main CPU 71 via the communication interface 82. Further, when an IC card is inserted into the card insertion slot, the PTS device 700 transmits credit data stored in the IC card to the main CPU 71 via the communication interface 82. The PTS device 700 also writes credit data into the IC card inserted into the card insertion slot, based on a control signal received from the main CPU 71 via the communication interface 82.

Further, the motherboard 70 is connected with a later-described door PCB (Printed Circuit Board) 90 and a main body PCB 110 by respective USBs. The motherboard 70 is also connected with a power supply unit 81. When the power is supplied from the power supply unit 81 to the motherboard 70, the main CPU 71 of the motherboard 70 is activated, and then the power is supplied to the gaming board 50 through the PCI bus so as to activate the CPU 51.

The door PCB 90 and the main body PCB 110 are connected with input devices such as a switch and a sensor, and peripheral devices the operations of which are controlled by the main CPU 71. The door PCB 90 is connected with a control panel 30, and a cold cathode tube 93.

The control panel 30 is provided with a service switch 31S, a cash-out switch 32S, a 1 bet switch 34S, a 2 bet switch 35S, a 3 bet switch 37S, a 5 bet switch 38S, a 10 bet switch 39S, a play 1 line switch 40S, a play 10 line switch 41S, a play 20 line switch 42S, a play 30 line switch 43S, a play 50 line switch 44S, a gamble switch 45S, and a repeat bet switch 46S which correspond to the above-described buttons, respectively. Each of the switches outputs a signal to the main CPU 71 upon detection of the pressing of the button corresponding thereto by the player.

The cold cathode tube 93 functions as a backlight installed on the rear face sides of the upper image display panel 131 and the lower image display panel 141, and lights up based on a control signal output from the main CPU 71.

The main body PCB 110 is connected with the upper image display panel 131, a lamp 111, the speakers 112, and the touch panel 69, the bill entry 22, and a graphic board 130. The speakers 112 output BGM sound or the like in accordance with a control signal output from the main CPU 71.

The touch panel 69 detects a place on the lower image display panel 141 touched by the player's finger or the like, and outputs to the main CPU 71 a signal corresponding to the detected place.

The bill entry 22 authenticates the bills and receives genuine bills into the cabinet 11. An amount of credit corresponding to the bills received by the cabinet 11 is added to the player-owned credit.

The graphic board 130 controls display of images conducted by the upper image display panel 131 and lower image display panel 141, based on a control signal output from the main CPU 71. The graphic board 130 is provided with the VDP (Video Display Processor) generating image data, the video RAM temporarily storing the image data generated by the VDP, and the like. It is to be noted that the image data used in generation of image data by the VDP is included in the game program that has been read from the memory card 54 and stored into the RAM 73.

The graphic board 130 is provided with the VDP (Video Display Processor) generating image data based on a control signal outputted from the main CPU 71, the video RAM temporarily storing the image data generated by the VDP, and the like. It is to be noted that the image data used in generation of image data by the VDP is included in the game program that has been read from the memory card 54 and stored into the RAM 73.

(Symbols, Combinations, or the Like)

The symbols, which are displayed on pseudo reels 151 to 155 of the slot machine 10, form a symbol array. Each symbol constituting the symbol array has one of the code numbers. Each symbol array is a combination of the symbols such as the wild symbol 505, the special symbol 506, the design symbol 503, the royal symbols 502, and the trigger symbol 504. Different symbol arrays are used for the pseudo reels 151 to 155, respectively, and constitutes a combination of symbol arrays.

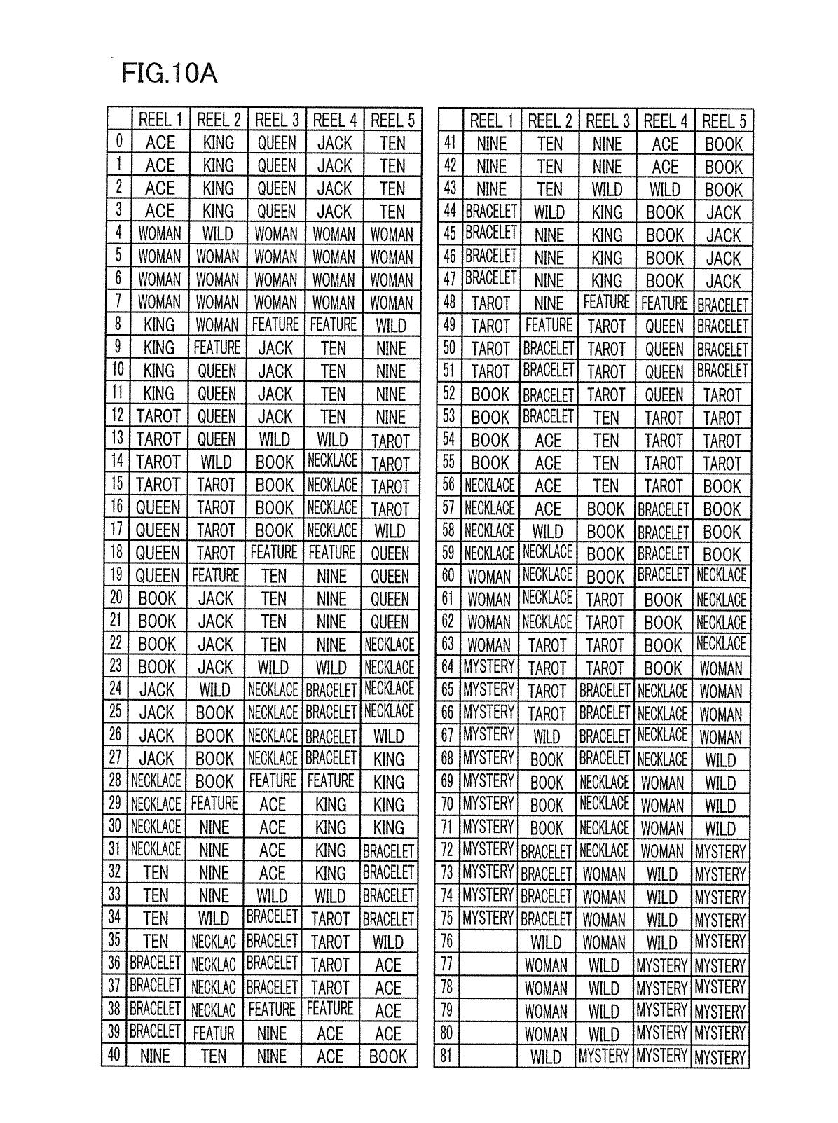

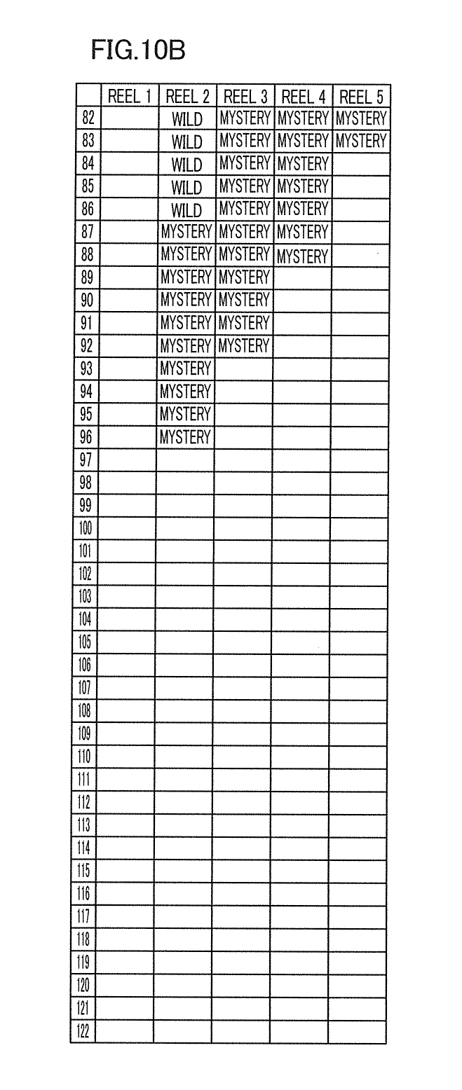

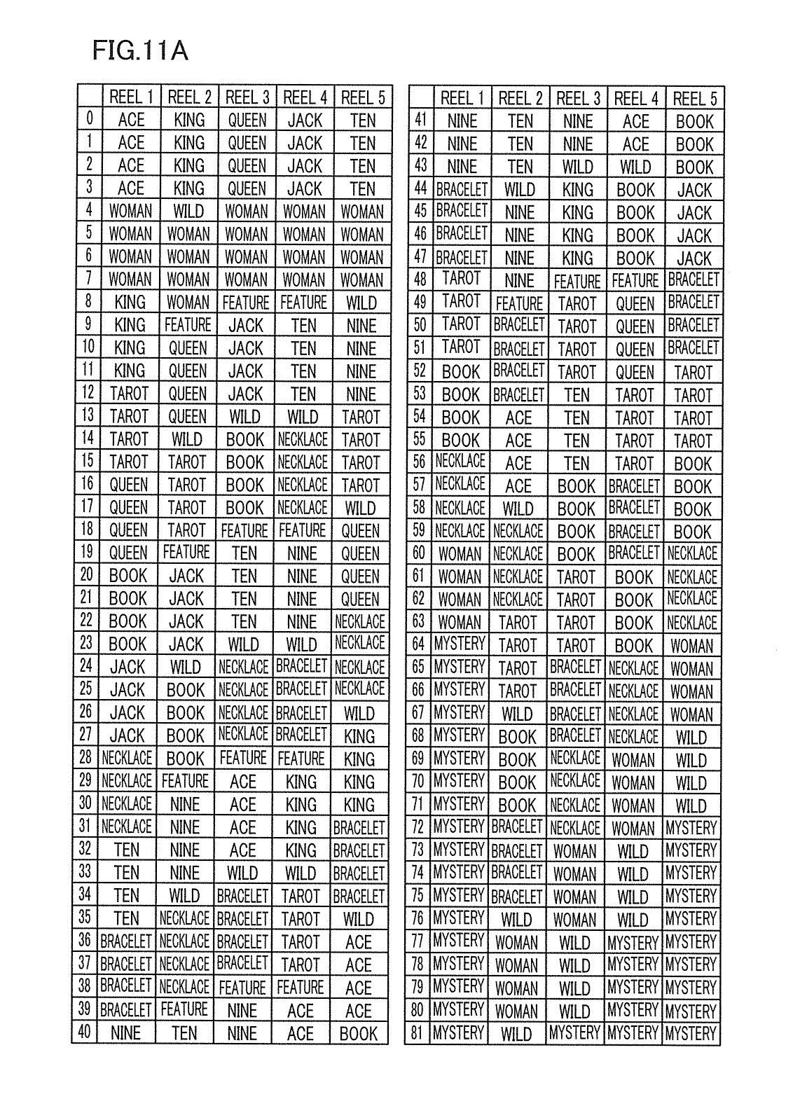

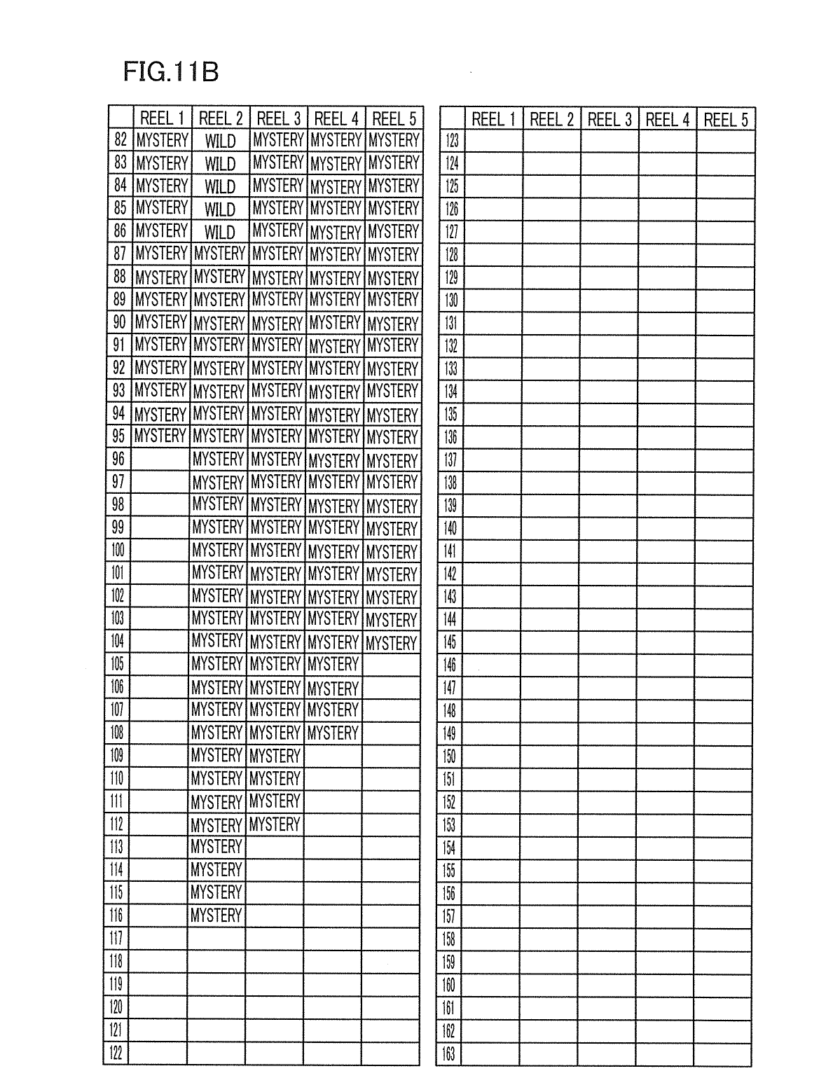

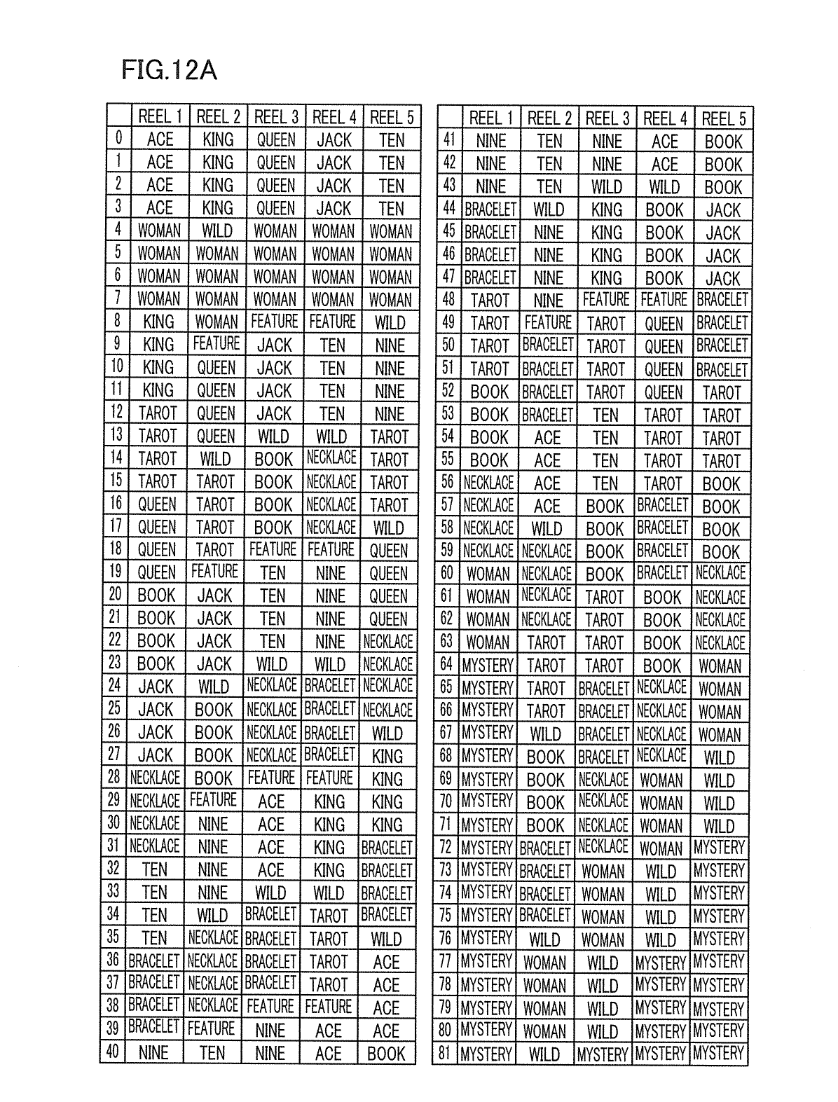

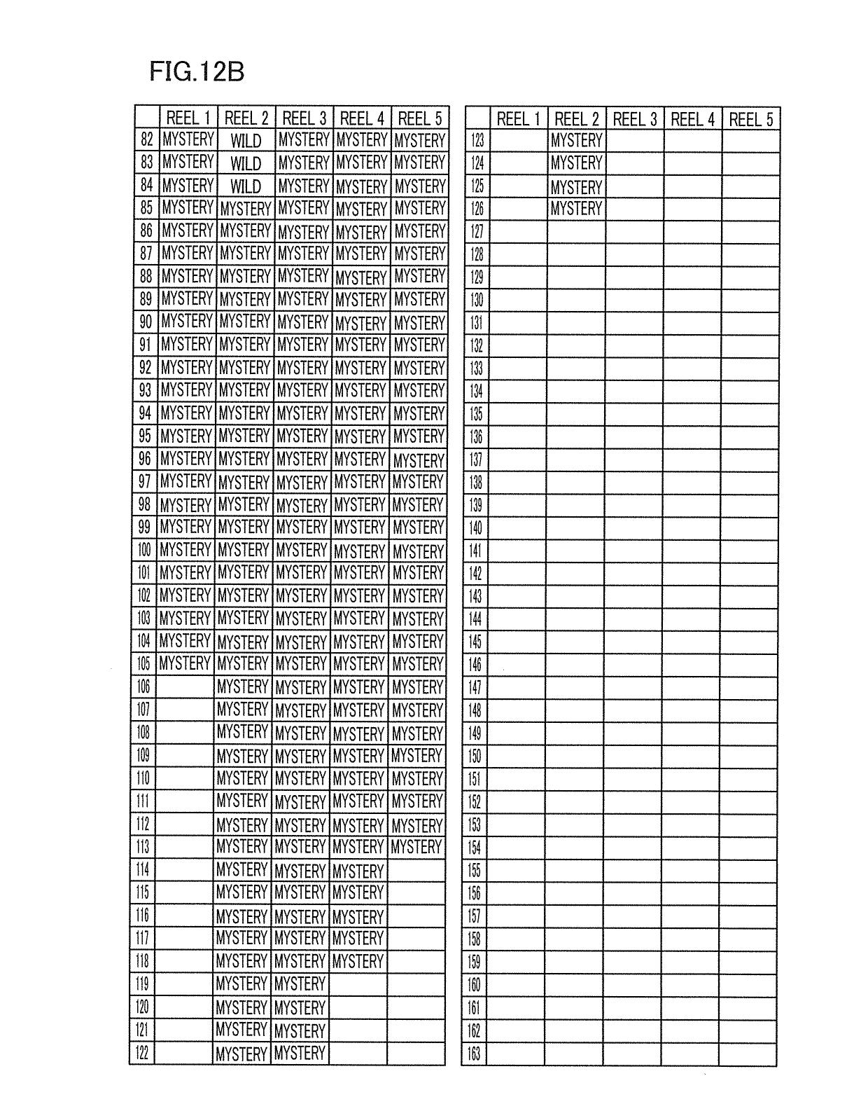

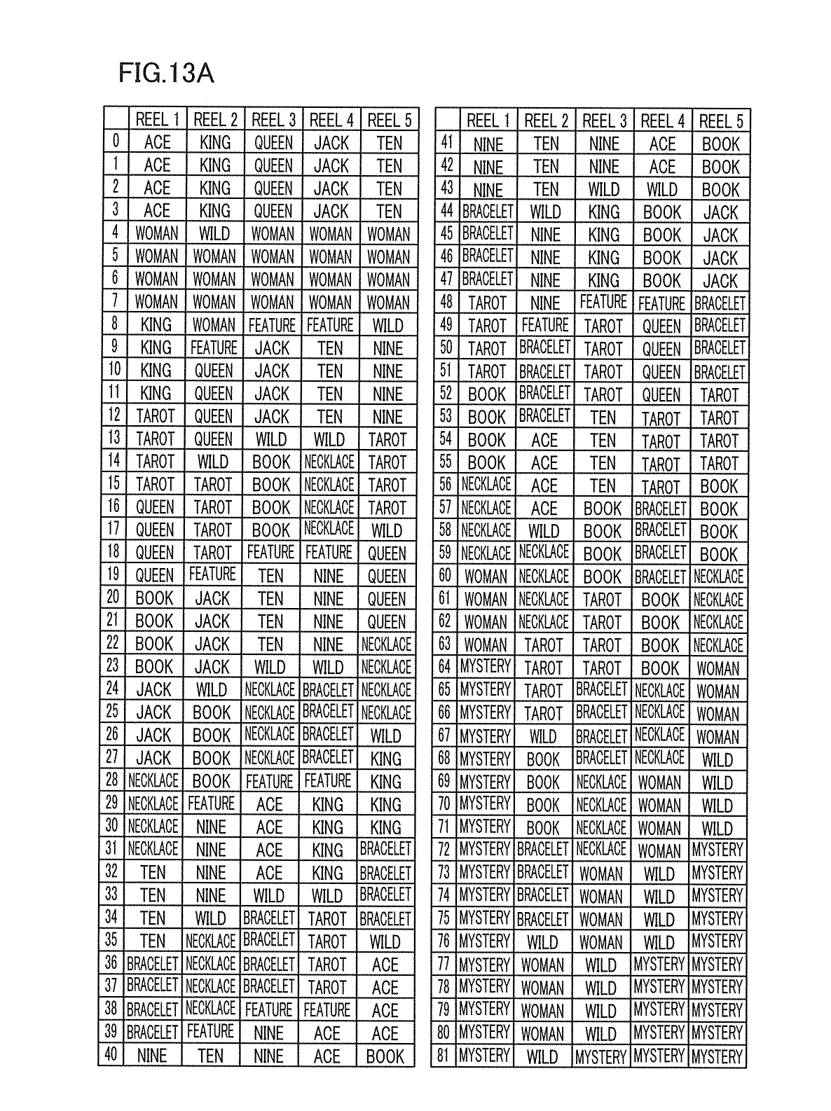

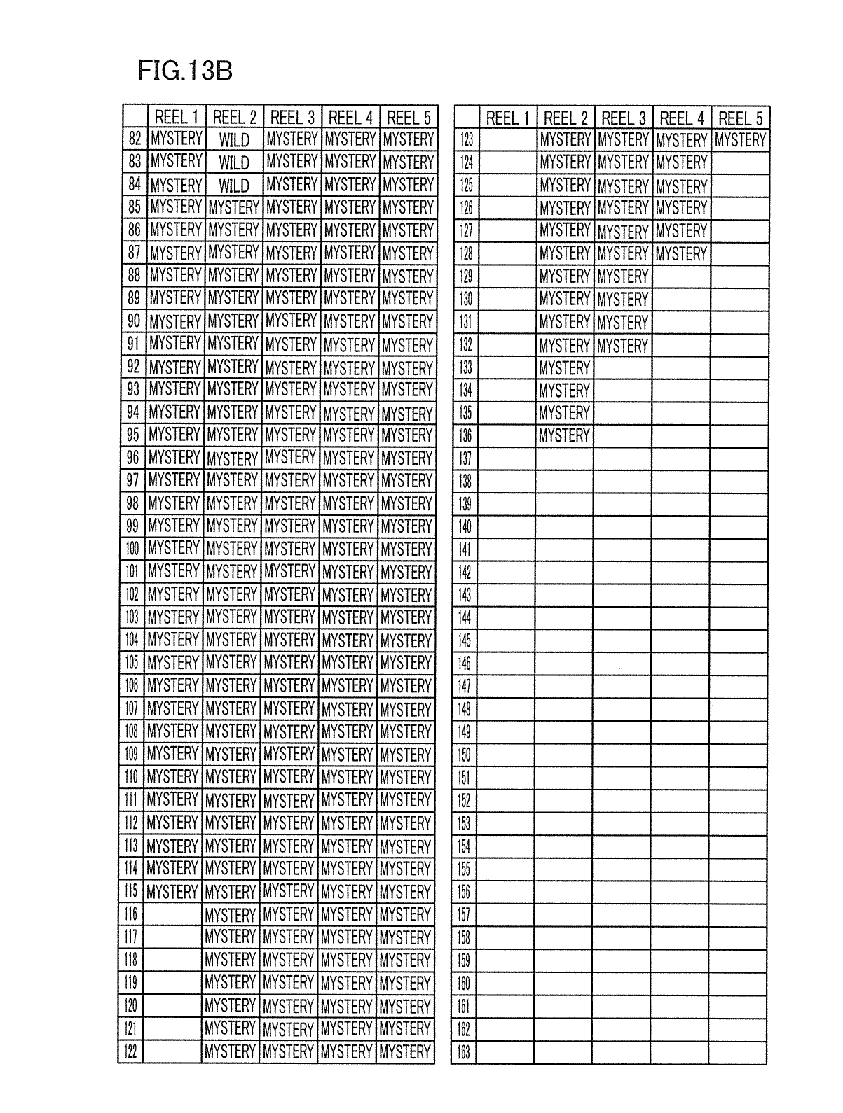

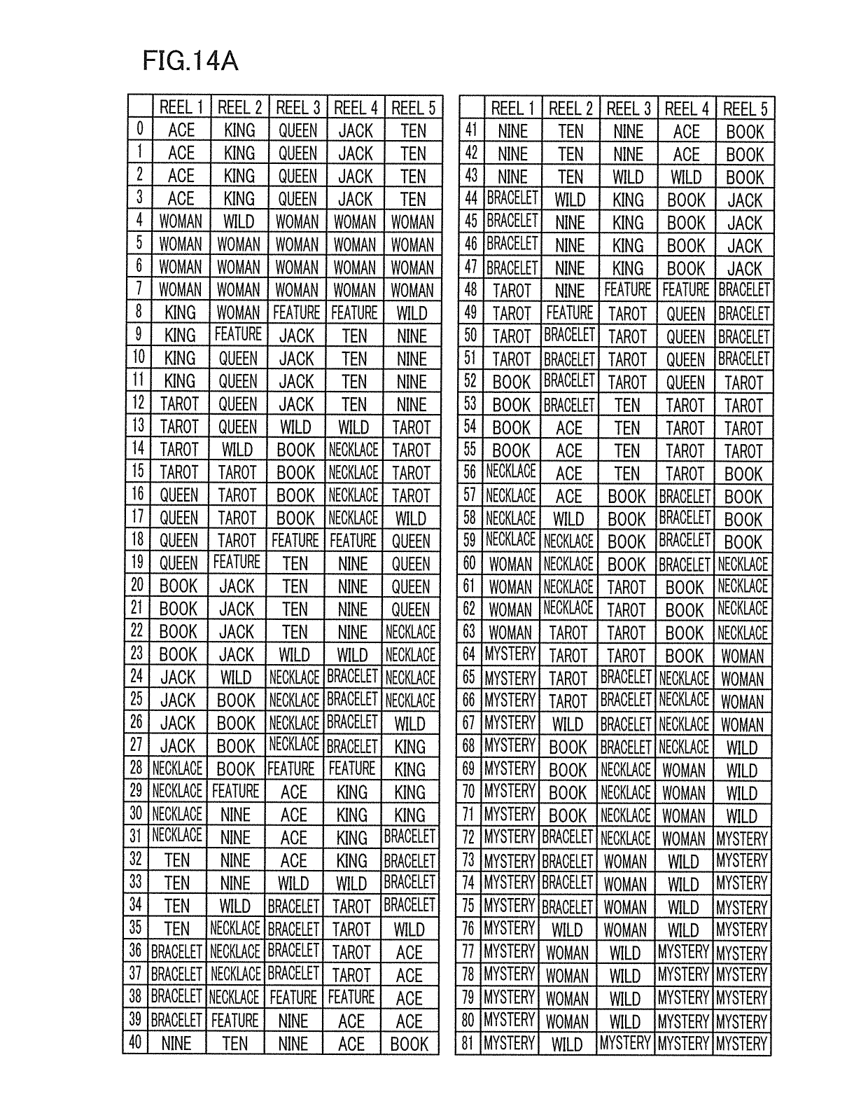

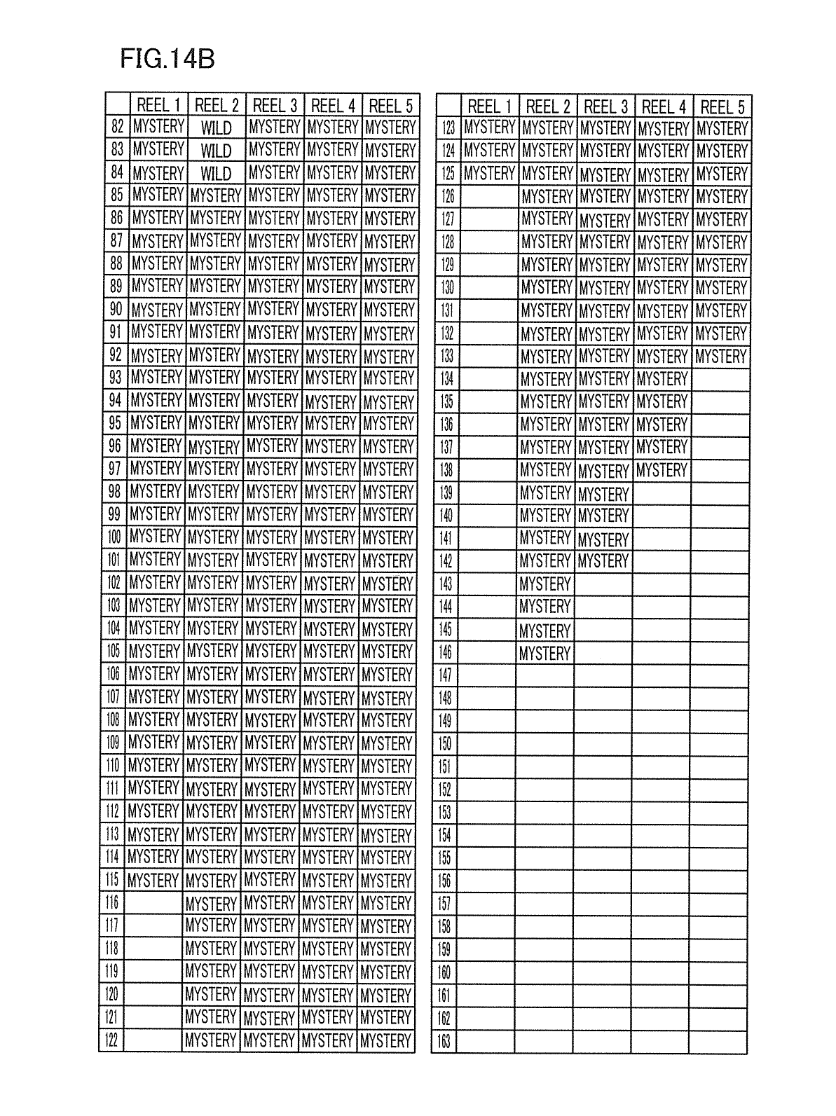

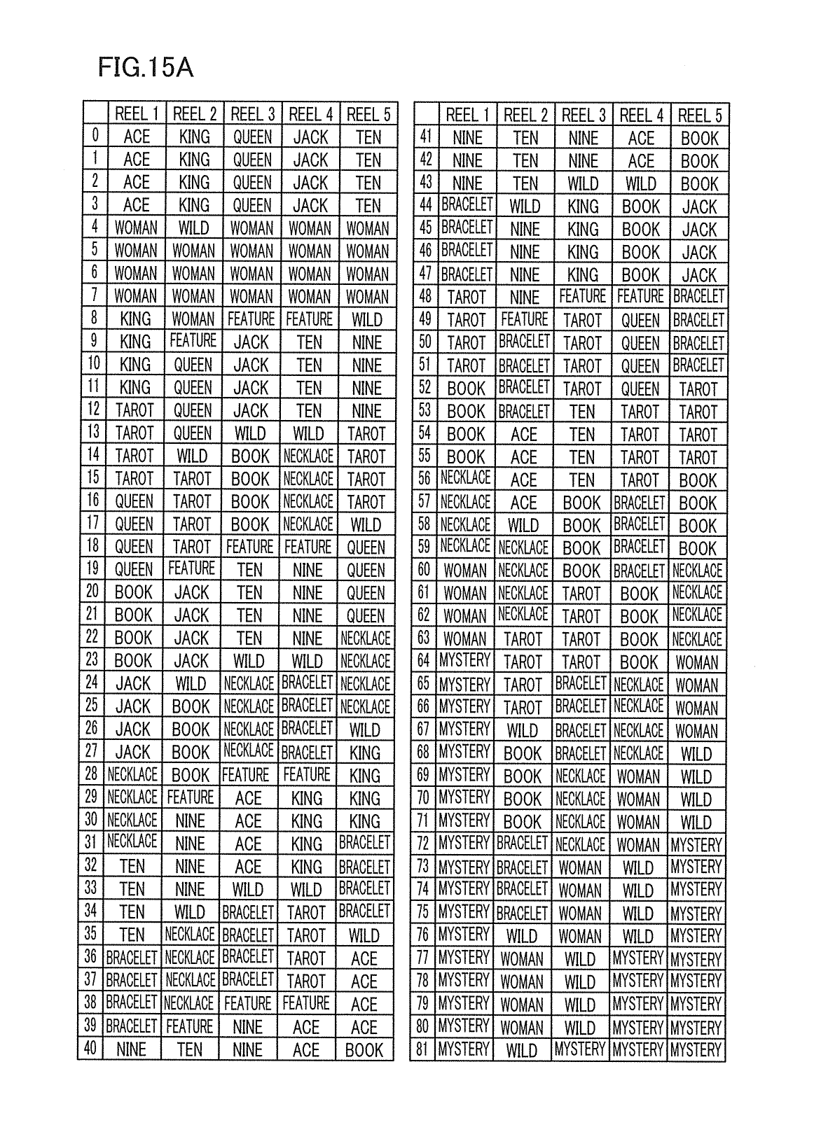

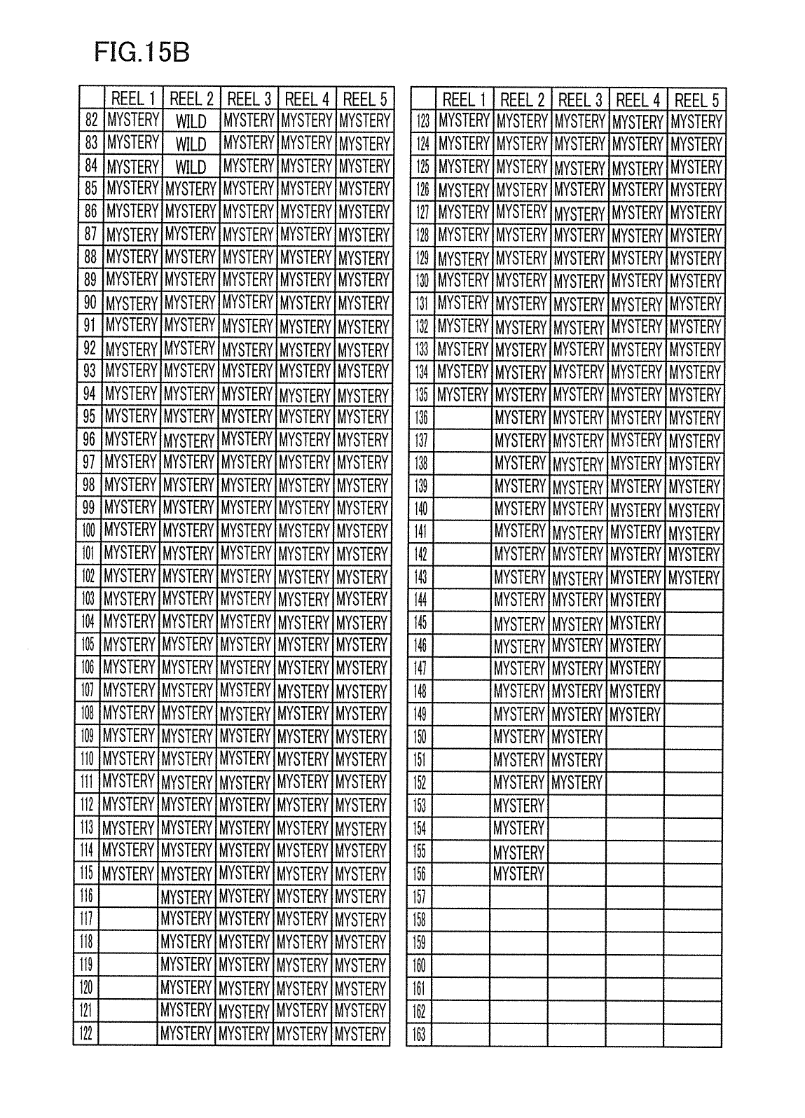

In the present embodiment, a plurality of symbol arrays are used depending on the game conditions and the like. Specifically, in the normal game, symbol arrays shown in FIG. 10A and FIG. 10B are used. Further, a pick game is run at the start of the feature game so as to determine the symbol arrays for the free game. Based on the result of the pick game, one of five types of symbol arrays is randomly determined. These five types of symbol arrays are: the symbol arrays shown in FIG. 11A and FIG. 11B, those shown in FIG. 12A and FIG. 12B, those shown in FIG. 13A and FIG. 13B, those shown in FIG. 14A and FIG. 14B, and those shown in FIG. 15A and FIG. 15B. The pick game is detailed later.

Four successive symbols in a symbol array are displayed (arranged) in the upper stage, the upper middle stage, the lower middle stage, and the lower stage of the display area of the pseudo reels 151 to 155 thereby forming a symbol matrix of 5 columns and 4 rows, in the symbol display region 150. The symbols forming the symbol matrix start to scroll at least when a game starts in response to an operation of the control panel 30. After a predetermined time elapses from the start of the scroll, the scroll of the symbols stops (rearrangement).

In addition to the above, for the symbols, various winning combinations are set in advance. A winning combination indicates that a prize is established. A winning combination is a combination in which symbols having stopped on a payline L is advantageous for the player. The advantageous state indicates states such as a state that payout corresponding to the winning combination is paid out, a state that the amount of credit is added to the credit, and a state that a bonus game starts.

As shown in FIG. 2, the winning combination in the present embodiment is a combination in which a predetermined number or more of symbols 500 of at least one type are rearranged on an activated payline L. Since the trigger symbol 504 is set as a scatter symbol, a winning combination is established when a predetermined number (3) or more of such scatter symbols are rearranged, no matter whether a payline L is activated or not.

In the present embodiment, the symbols 500 to be rearranged in the symbol display area 150 in the normal game or the feature game (free game) are randomly determined. The symbol arrays used for the pseudo reels 151 to 155 shown in FIG. 10A and FIG. 10B are weighted evenly. Therefore, the probabilities of symbols 500 rearranged in each symbol array are all the same. It should be noted that the symbols are evenly weighted or unevenly weighted. When the weights are uneven, it is possible to adjust the probabilities of wining for the respective types of the symbols by changing the ranges of the random numbers.

(Indication Effect)

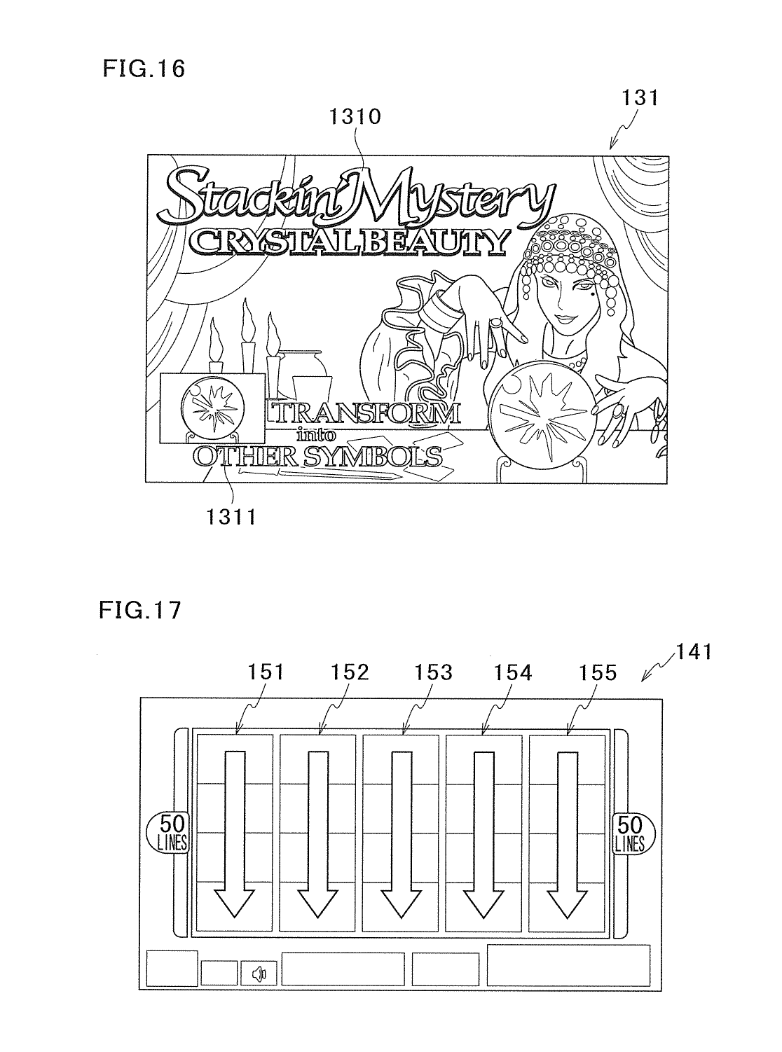

The following describes the indication effect which is performed during the variable displaying, when the special symbol 506 included in the symbols 500 to be rearranged in the symbol display area 150 satisfies a predetermined condition. In the following described is the indication effect taking place in the normal game; however, the indication effect in the free game is also performed in the similar manner. It should be noted that, as shown in FIG. 16, a title logo 1310 and a catch phrase 1311 are displayed in the upper image display panel 131, in the free game or the normal game.

(Indication Effect: Crystal Ball Appearing Indication Effect)

A crystal ball appearing indication effect takes place when the symbols 500 to be rearranged in the symbol display area 150 include 10 or more special symbols 506, and the payout resulting after the special symbols 506 are each substituted for any one of the normal symbols 501 is equal to or more than the bet amount multiplied by 20. It should be noted that the crystal ball appearing indication effect in the present embodiment occurs at a probability of 25% in the game satisfying the above condition. In other words, even if the above condition is satisfied, the crystal ball appearing indication effect may not take place at the probability of 75%. However, the present embodiment is not limited to this. For example, the indication effect may be provided at different probabilities, or may occur always when the above condition is satisfied.

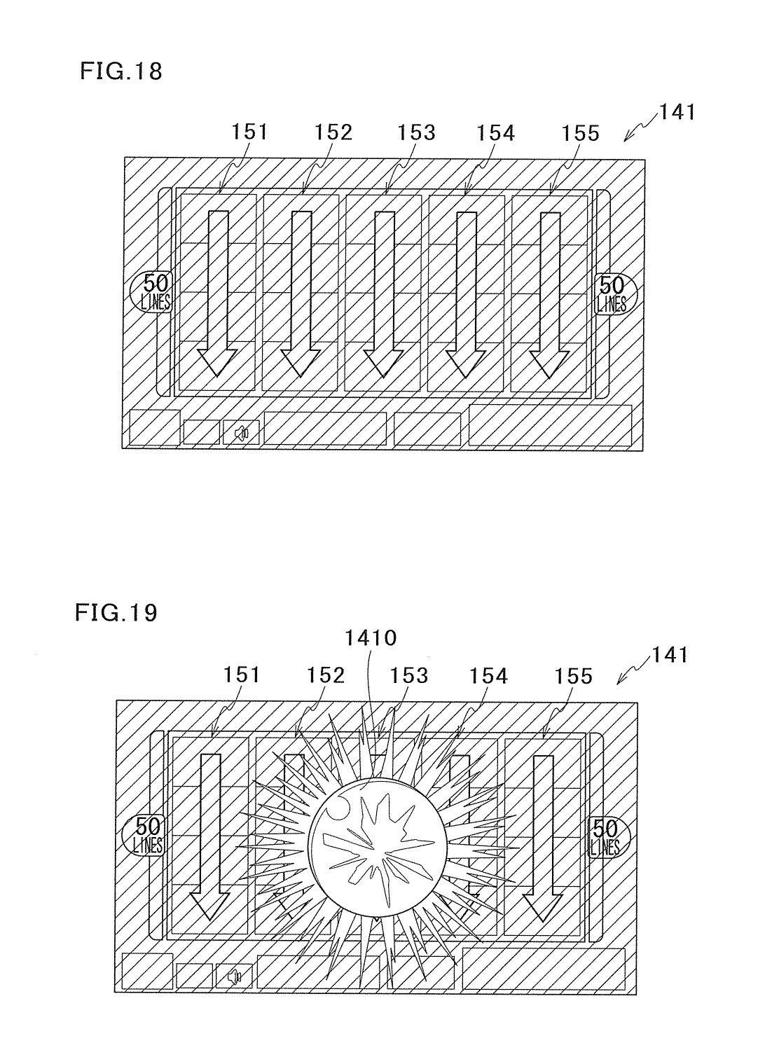

When the normal game starts, the symbol arrays of the pseudo reels 151 to 155 are variably displayed on the lower image display panel 141, as shown in FIG. 17. If the indication effect is performed, the variable display of the symbol arrays will last longer than the case without the indication effect. Further, when the indication effect is to be performed, skipping of the variable display of the symbol arrays is disabled. Then, as shown in FIG. 18, the lower image display panel 141 is entirely darkened, and grayed out. In other words, the entire screen of the lower image display panel 141 in which the symbol arrays in the symbol display area 150 are variably displayed is darkened. Then, as shown in FIG. 19, a crystal ball appearing indication effect image 1410 in the shape of a crystal ball is brightly displayed at the center of the darkened screen.

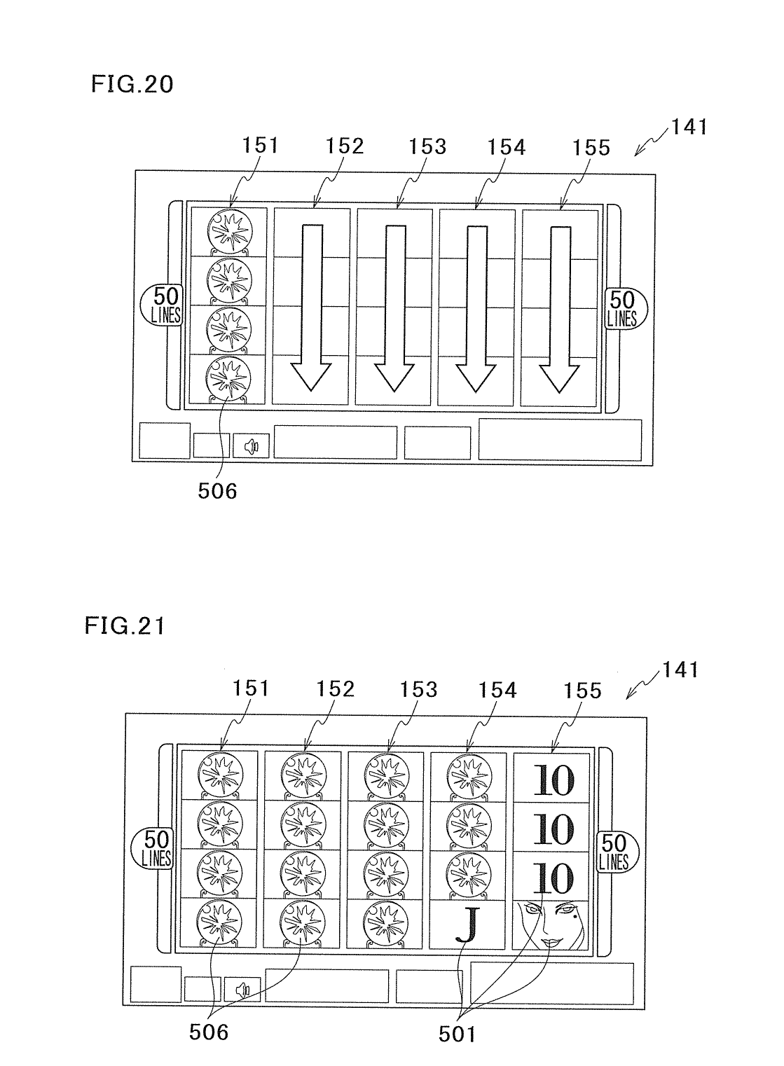

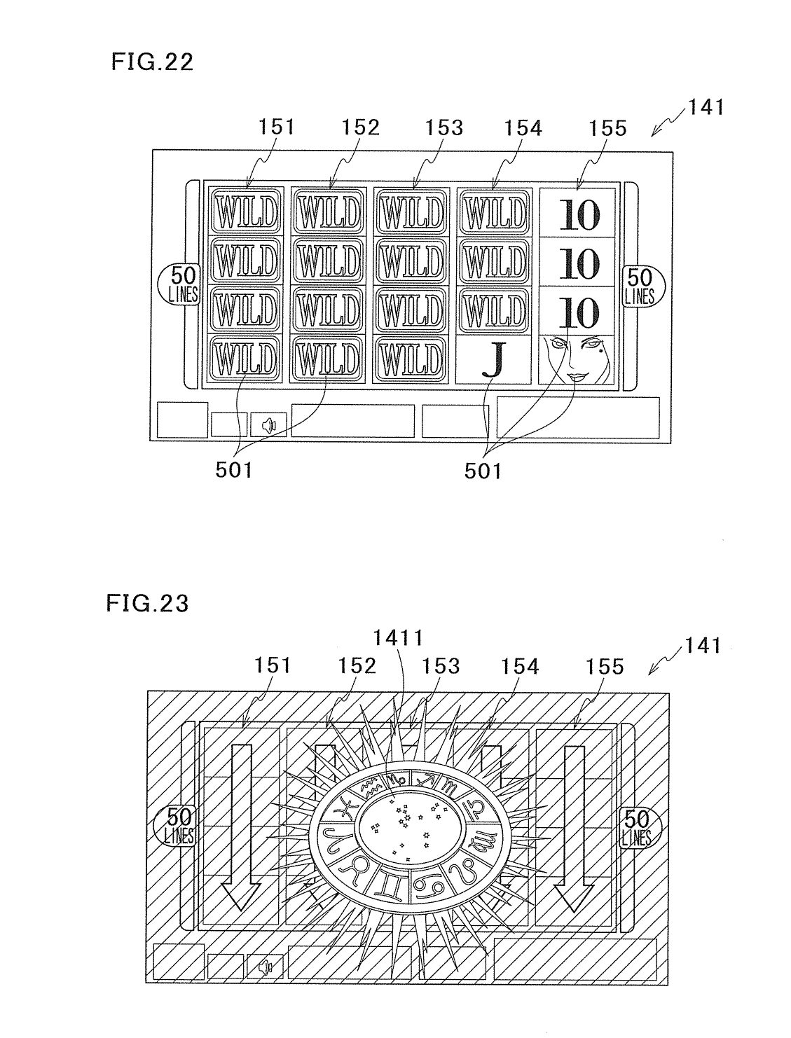

Then, the crystal ball appearing indication effect image 1410 disappears from the lower image display panel 141, and the brightness of the lower image display panel 141 is restored. Then, as shown in FIG. 20, the variable displaying of the first reel (pseudo reel 151) starts to stop. In FIG. 20, the special symbol 506 is stopped throughout the pseudo reel 151. Then, variable display of all the reels (pseudo reels 151 to 155) stops as shown in FIG. 21. Then, as shown in FIG. 22, there is performed an effect that the displayed image of each of the special symbols 506 is changed to the displayed image of any one of the normal symbols 501. Then, when there is a payout, an effect of awarding the payout is performed. After this effect (or after the effect is skipped), the displayed image of the normal symbol 501 whose displayed image is changed as described above is changed back to the displayed image of the special symbol 506, as shown in FIG. 21. Then, the unit game is ended. If the next game is to be played by placing a bet and the like, the variable display of the symbol arrays on the pseudo reels 151 to 155 is started as shown in FIG. 17.

(Indication Effect: Feature Indication Effect)

A feature indication effect occurs when symbols 500 to be rearranged in the symbol display area 150 include 3 trigger symbols 504. That is, the feature indication effect occurs when running of a feature game is determined. In the present embodiment, the feature indication effect occurs at a probability of 25% in games satisfying the above conditions. In other words, even if the above condition is satisfied, the feature indication effect may not take place at the probability of 75%. However, the present embodiment is not limited to this. For example, the indication effect may be provided at different probabilities, or may be provided always when the above condition is satisfied.

An effect similar to the crystal ball appearing indication effect is performed for the feature indication effect; however, the indication effect image is different. Specifically, as shown in FIG. 23, a feature indication effect image 1411 displayed is similar to the image of the trigger symbol 504 and has a disc with horoscope symbols.

(Change Effect of Special Symbols)

The following describes examples of how the displayed images of the special symbols 506 shown in FIG. 21 and FIG. 22 change to those of the normal symbols 501. The conversion of the special symbols 506 to the normal symbols 501 are always executed in the normal game and the free game, even when there is no crystal ball appearing indication effect.

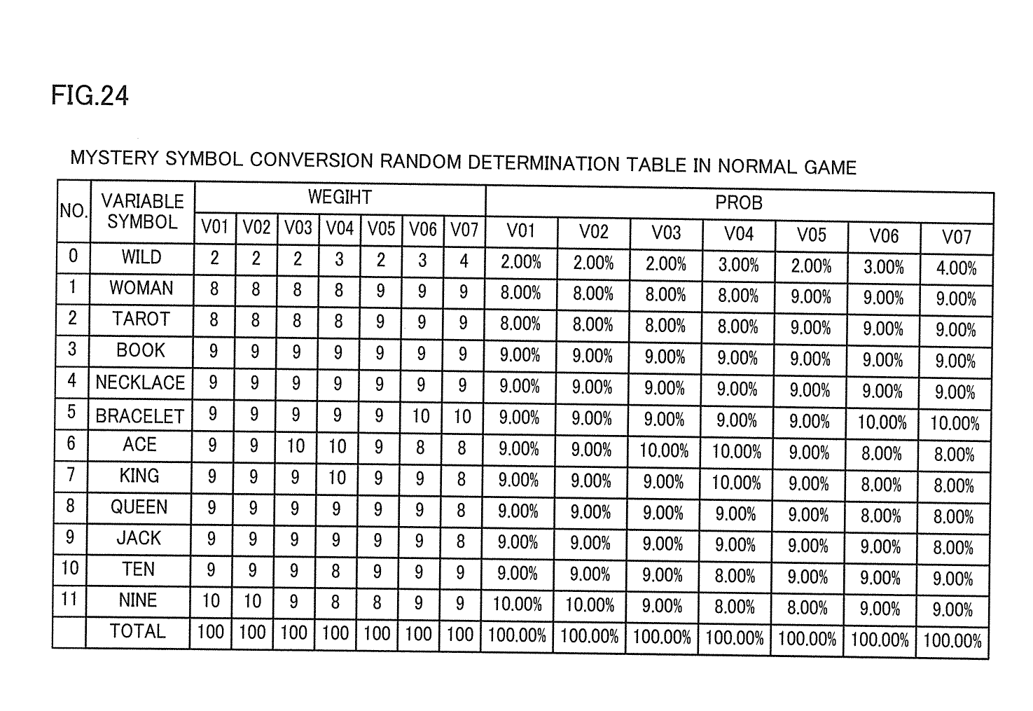

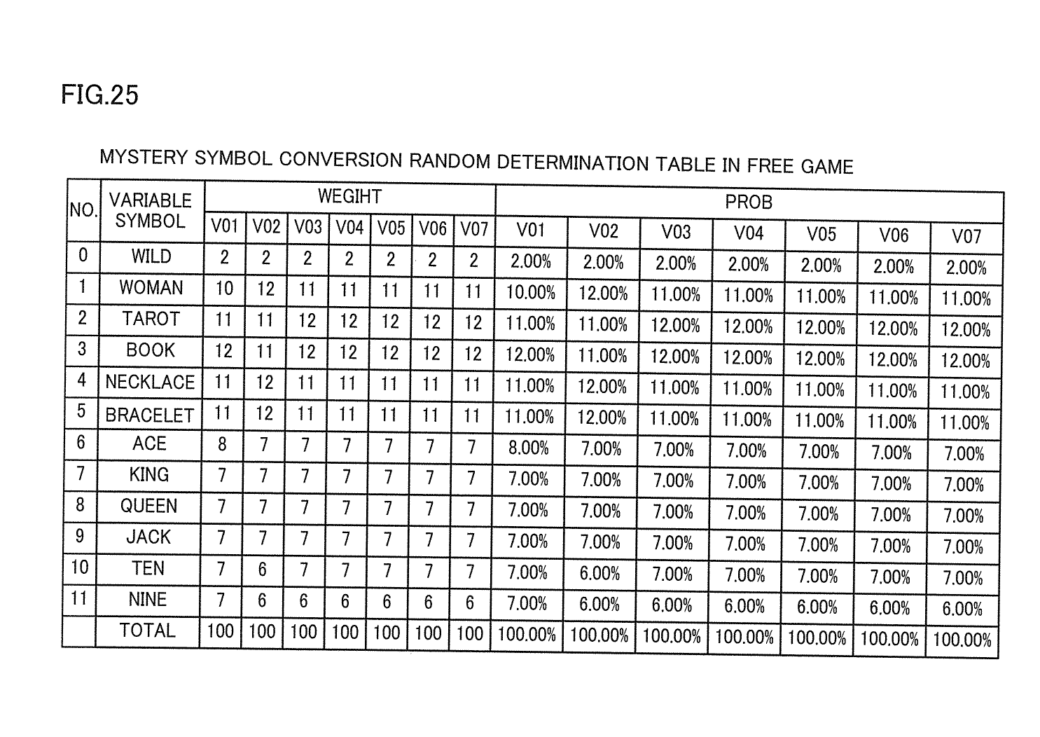

Which one of the normal symbols 501 each of the special symbols 506 is substituted for is randomly determined before the symbols 500 are rearranged. In the present embodiment, such a random determination is carried out with different probabilities in the normal game and the free game, and which one of the normal symbols 501 each of the special symbols 506 is substituted for is determined. Specifically, FIG. 24 and FIG. 25 show a random determination table (mystery symbol conversion random determination table) used in the normal game and the free game.

(Mystery Symbol Change Random Determination Table)

In the tables shown in FIG. 24 and FIG. 25, there are fields of the weights (Weight) and the probabilities (Prob) for each type of normal symbols 501. The fields of V01 to V07 are setting values of the gaming machine 300. With this setting, the probabilities of prize occurrences and the like in the gaming machine 300 are variably configured. As should be seen in FIG. 24 and FIG. 25, the conversion from the special symbol 506 to the design symbol 503 is more likely to occur in the free game than the normal game. Further, the conversion from the special symbol 506 to the royal symbol 502 is less likely to occur in the free game than the normal game. That is, the probability of conversion to a design symbol 503 associated with a higher payout than that of the royal symbol 502 is set high in the free game. Therefore, it should be understood that the free game is more advantageous than the normal game.

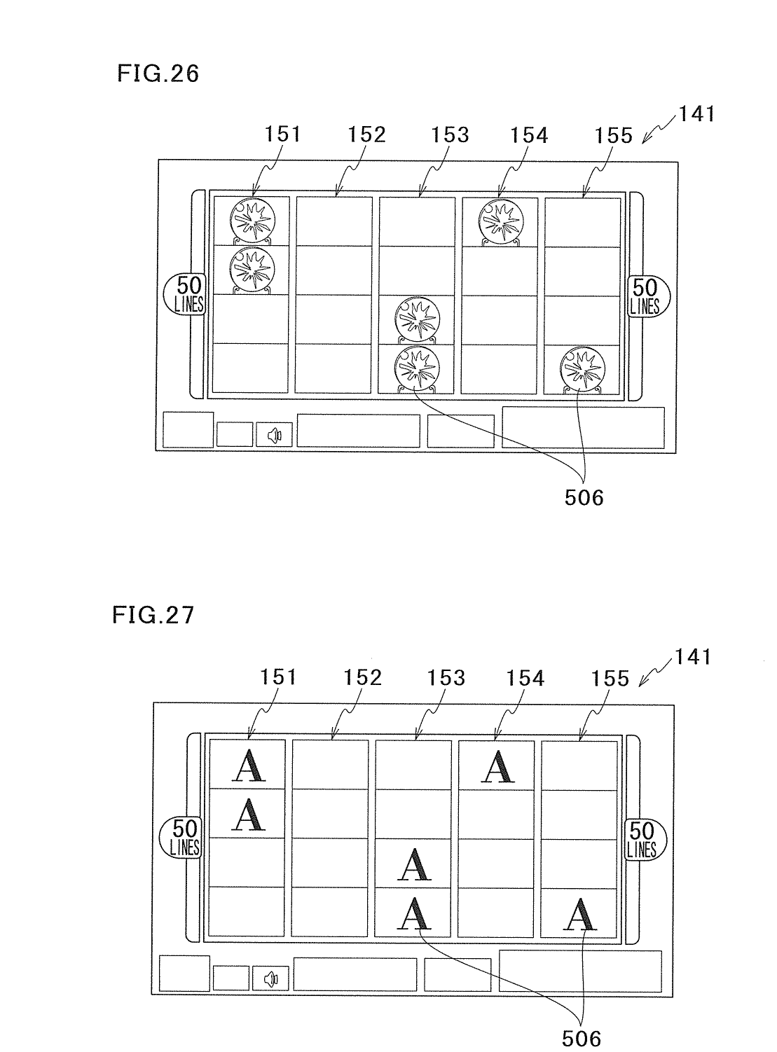

The following describes an example where the special symbols 506 are rearranged as shown in FIG. 26. It should be noted that the figure omits illustration of the other symbols rearranged. After variable displaying of the pseudo reels 151 to 155 starts, the pseudo reel 151 is first stopped, followed by the pseudo reel 152, the pseudo reel 153, the pseudo reel 154, and the pseudo reel 155, successively. For example, in cases where the pseudo reels 151, 152, and 153 are stopped while the pseudo reels 154 and 155 are still variably displayed, the special symbols 506 stopped in the pseudo reels 151, 152, and 153 are not yet converted to the normal symbols 501, and animation is displayed for the special symbols 506. Then, as shown in FIG. 26, the symbols 500 are rearranged in all the pseudo reels 151 to 155, as shown in FIG. 26. Then, an effect is provided such that the special symbols 506 in the symbols 500 rearranged are converted to the normal symbols 501, as shown in FIG. 27. In FIG. 27, the special symbols 506 are converted to the royal symbol 502 of “ACE”. It should be noted that, in the present embodiment, an effect is performed such that the special symbol 506, when rearranged, is converted to any one of the normal symbols 501. However, the present invention is not limited to this.

Then, after the effect of the special symbol 506 being converted to the normal symbol 501, an effect of a prize occurrence is performed. After that, the normal symbols 501 after the change is instantaneously switched to the special symbols 506 so that the screen will look as shown in FIG. 26, and then the subsequent game is proceeded.

It should be noted that when it is determined that the special symbols 506 will be converted to the normal symbols 506 other than the wild symbols 505, there are following three patterns of effect for the conversion of the special symbols 506 to the normal symbols 501. Namely, when a payout associated with a winning combination including the converted normal symbols 501 is less than ×8 of the bet amount, the special symbols 506 are instantaneously converted to the normal symbols 501. Further, when a payout associated with a winning combination including the converted normal symbols 501 is ×8 or more but less than ×15 of the bet amount, the special symbols 506 are converted to the normal symbols 501 in 1 second. When a payout associated with a winning combination including the converted normal symbols 501 is ×15 or more of the bet amount, the special symbols 506 are converted to the normal symbols 501 in 2 seconds. As described, the effect of the conversion may be differentiated according to the amount of the payout generated by the normal symbols 501 converted from the special symbols 506. It should be noted that the bet amount in the free game is the bet amount placed in the normal game having triggered that free game.

(Expanded Frame Animation Effect)

As in FIG. 21, when identical symbols 500 are rearranged in all the display blocks 28 of any of three adjacent pseudo reels out of the pseudo reels 151 to 155, an expanded frame animation effect is performed. It should be noted that the wild symbol 505 and the other symbols 500 are not regarded as identical. In cases of the special symbols 506, the expanded frame animation effect is performed after the special symbols 506 are converted to the normal symbols 501.

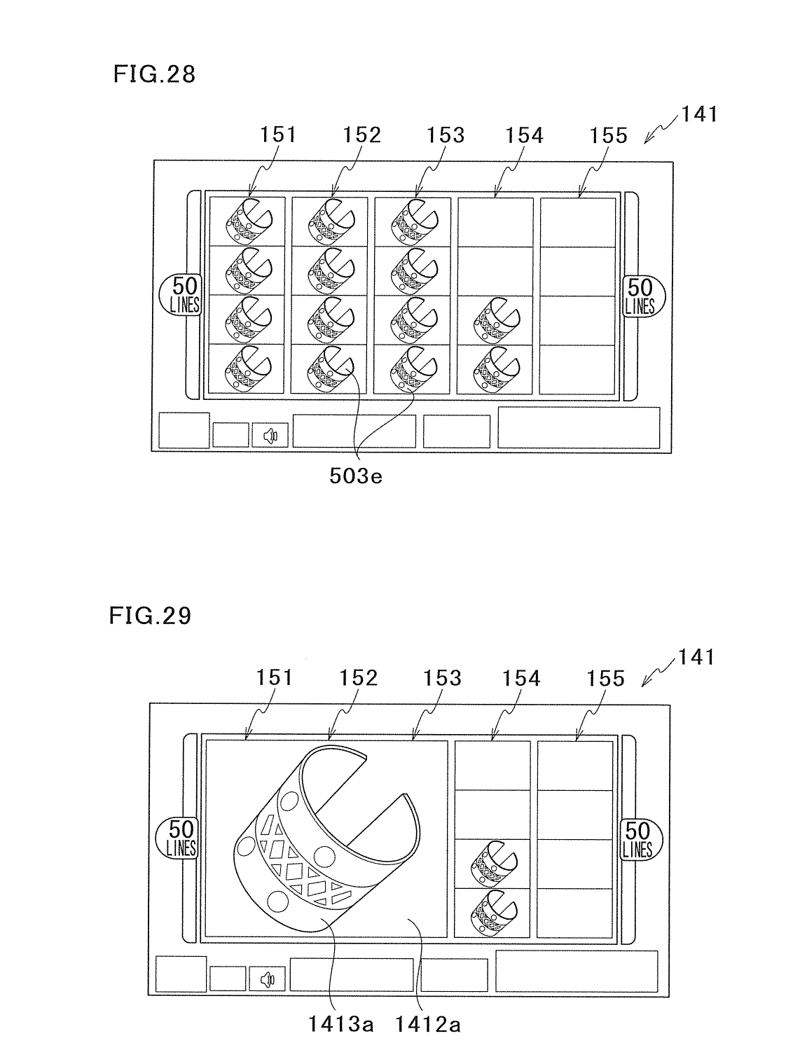

The following describes an example shown in FIG. 28, in which the BRACELET symbol 503e is rearranged in all of the pseudo reels 151 to 153, and in the lower middle stage and the lower stage of the pseudo reel 154. In this case, the display blocks 28 of all the adjacent pseudo reels 151 to 153 are jointed to form a 3-reel expanded animation display region 1412a, as shown in FIG. 29. Then, in the central portion of the region, a 3-reel expanded animation effect image 1413a is displayed. The image is an enlarged symbol 500 having been displayed in the display blocks 28 forming the 3-reel expanded animation display region 1412a. It should be noted that displaying of the BRACELET symbols 503e rearranged in the lower middle stage and the lower stage of the pseudo reel 154 is maintained as it is. The expanded frame animation effect image 1413a is a movie. Upon completion of playing the movie, the display will return to that in the FIG. 28, and an effect of prize occurrence is performed.

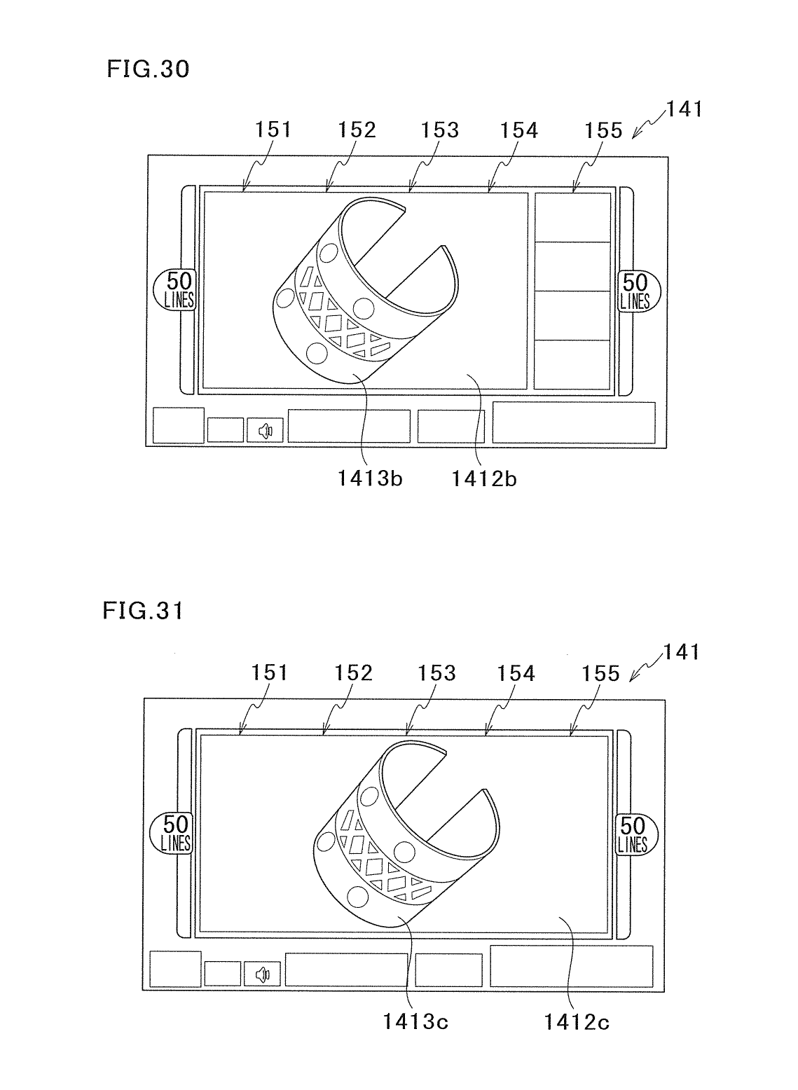

As in FIG. 30, when identical symbols 500 are rearranged in all the display blocks 28 of any of four adjacent pseudo reels out of the pseudo reels 151 to 155, the four adjacent reels form a 4-reel expanded frame animation display region 1412b, and a movie of a 4-reel expanded frame animation effect image 1413b is displayed therein. Further, as in FIG. 31, when identical symbols 500 are rearranged in all the pseudo reels 151 to 155, the pseudo reels 151 to 155 form a 5-reel expanded frame animation display region 1412c, and a movie of a 5-reel expanded frame animation effect image 1413c is displayed therein.

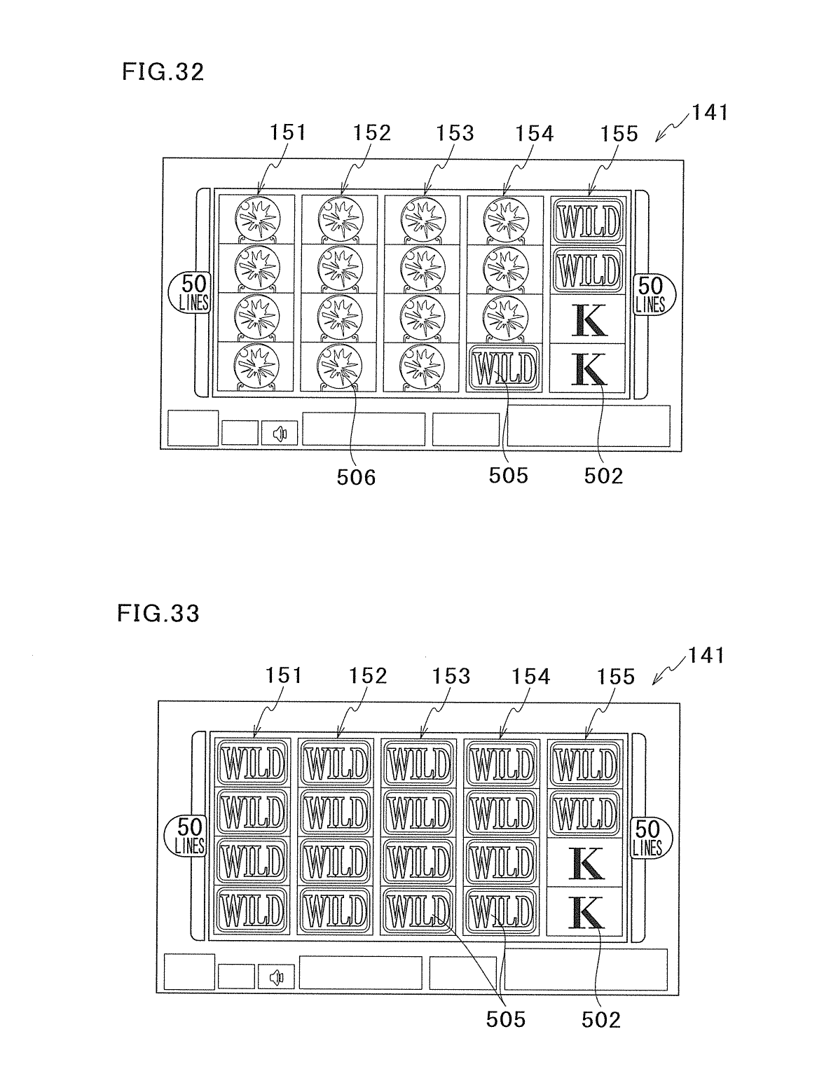

The following describes an example shown in FIG. 32, in which the special symbol 506 is rearranged throughout the pseudo reels 151 to 153, and in the upper stage, the upper middle stage, and the lower middle stage of the pseudo reel 154. In this case, there is first performed the effect of converting the special symbols 506 to the normal symbols 501, as shown in FIG. 33. In the example shown in FIG. 33, the special symbols 506 are converted to the wild symbols 505.

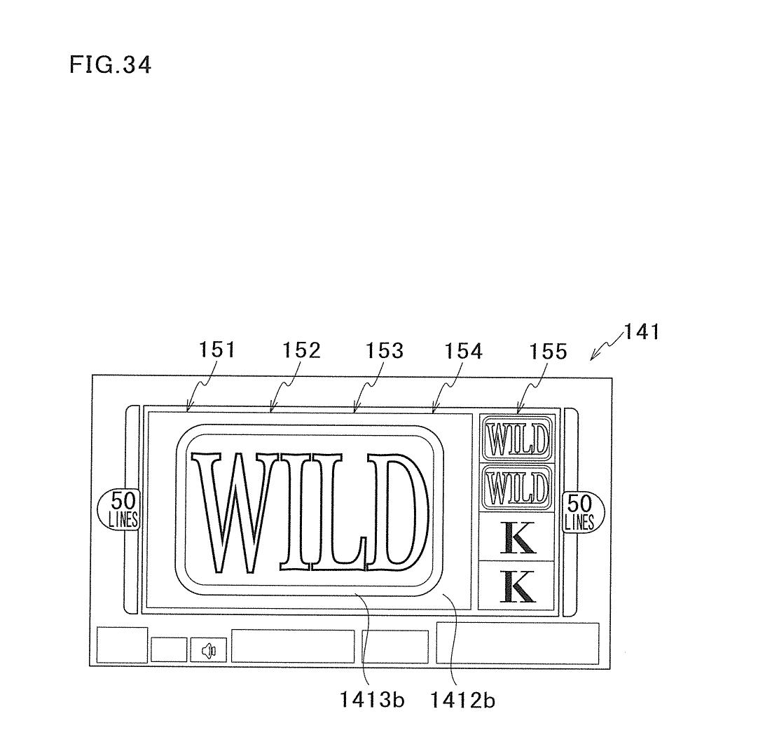

At this time, for the normal symbols 501 already rearranged and the normal symbols 501 converted from the special symbols 506, there is determined whether or not identical normal symbols 501 are rearranged in all the display blocks 28 of each pseudo reel. For example, in FIG. 33, the wild symbols 505 are rearranged in all the display blocks 28 of the pseudo reels 151 to 154, the wild symbols being the wild symbols 505 already rearranged and the wild symbols 505 converted from the special symbols 506. In this case the pseudo reels 151 to 154 form the 4-reel expanded frame animation display region 1412b, and the 4-reel expanded frame animation effect image 1413b is displayed therein, as shown in FIG. 34.

Then, the screen with the special symbols 506 being converted to the normal symbols 501 is displayed as shown in FIG. 33, and the effect of prize occurrence is performed. After that, the converted normal symbols 501 are converted back to the special symbols 506, as shown in FIG. 32.

(Feature Game)

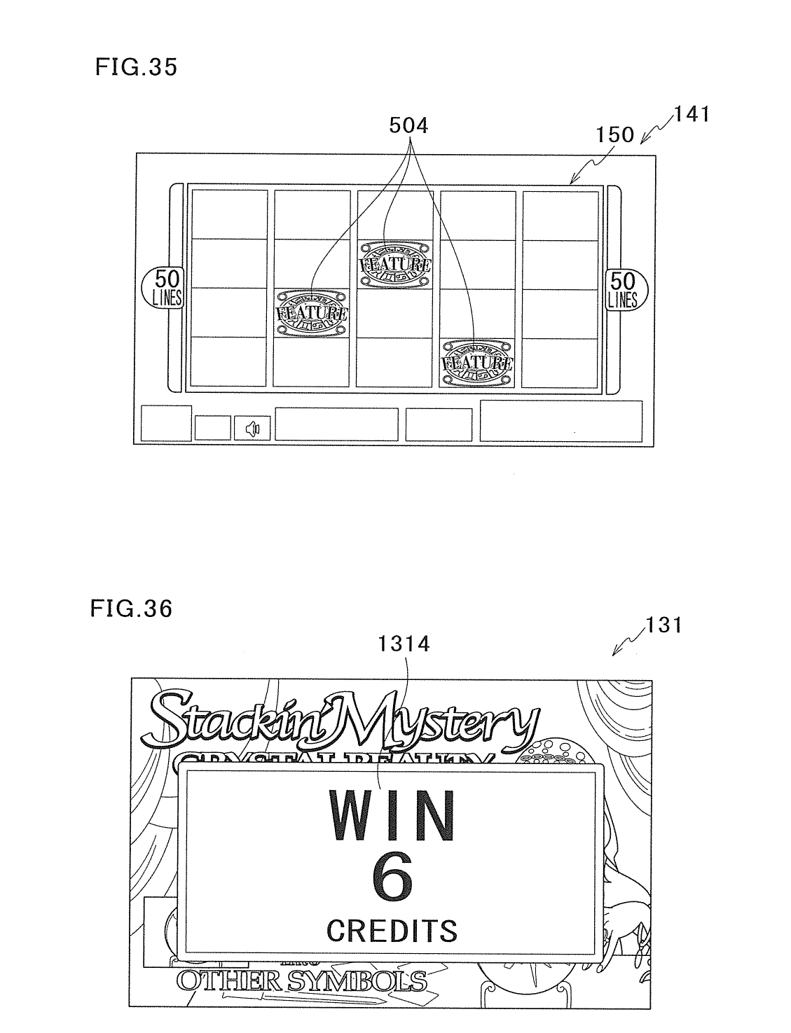

In the present embodiment, a trigger condition is satisfied and a transition to the feature game occurs when three trigger symbols 504 are rearranged in the symbol display area 150, as shown in FIG. 35, in the normal game. When the three trigger symbols 504 are rearranged, a payout is awarded as the scatter is established by the trigger symbols 504, and a win effect image 1314 is displayed on the upper image display panel 131, as shown in FIG. 36.

(Feature Game)

Then, the upper image display panel 131 as well as the lower image display panel 141 are darkened, and a pick game is started on the lower image display panel 141. At this time, an effect may be performed on the upper image display panel 131 to indicate that the feature game is taking place.

(Feature Game: Pick Game)

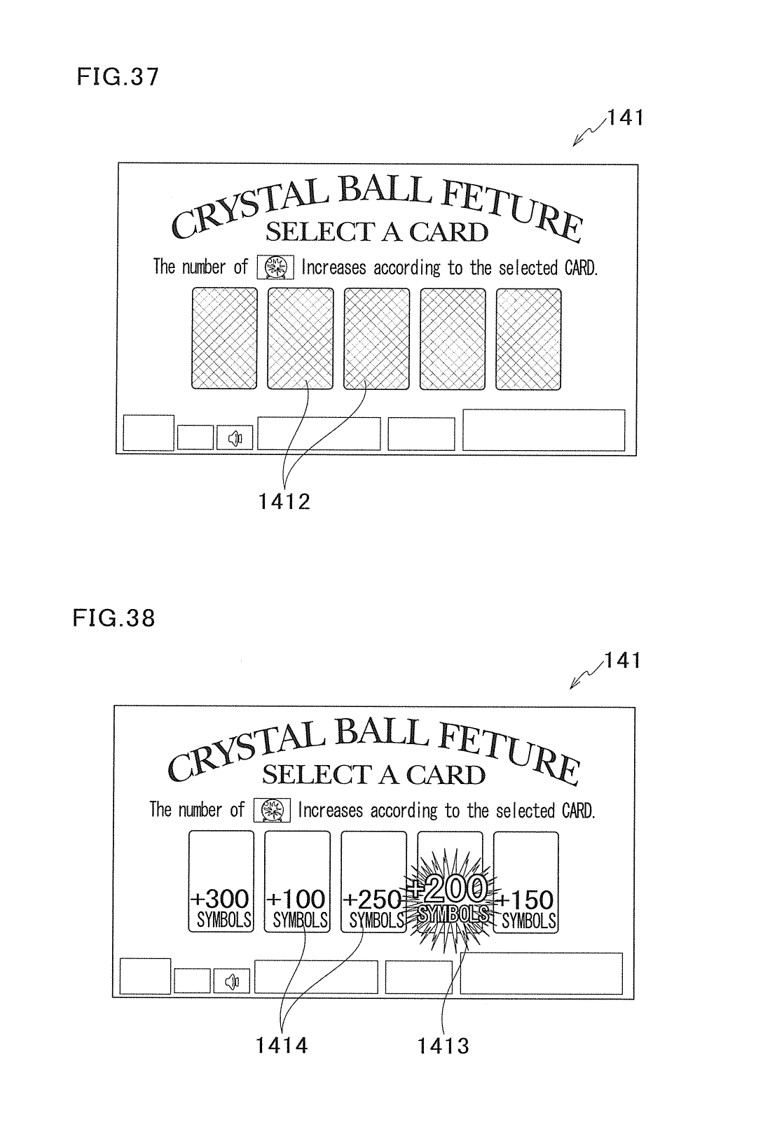

In a pick game screen, an alignment of 5 selectable images 1412 are displayed on the lower image display panel 141, as shown in FIG. 37. Further, in the pick game screen, the name of the pick game and text “SELECT A CARD” and “The number of [Crystal ball symbol] Increases according to the selected CARD.” is displayed. The selectable images 1412 are selectable by the touch panel 69 and the control panel 30. When a selectable image 1412 is selected by the player, an effect of the selected selectable image 1412 changing to a selected target image 1413 is provided, as shown in FIG. 38. Further, an effect of the four non-selected selectable images 1412 changing to the non-selected target images 1414 is provided. The selected target image 1413 and the non-selected target images 1414 all indicate the total number of special symbols 506 added in the free game. That is, the number of special symbols 506 indicated by the selected target image 1413 are added to the symbol arrays of the free game. There are five numbers for the number of additional special symbols 506 in the present embodiment, i.e., 100, 150, 200, 250, and 300.

It should be noted that in the present embodiment the number of additional special symbols 506 is randomly determined. Further, the symbol arrays for the free game are prepared in advance, and those corresponding to the number of additional special symbols 506 randomly determined are used. Specifically, when 100 special symbols 506 are to be added, the symbol arrays shown in FIG. 11A and FIG. 11B are used in the free game. Further, when 150 special symbols 506 are to be added, the symbol arrays shown in FIG. 12A and FIG. 12B are used in the free game. When 200 special symbols 506 are to be added, the symbol arrays shown in FIG. 13A and FIG. 13B are used in the free game. When 250 special symbols 506 are to be added, the symbol arrays shown in FIG. 14A and FIG. 14B are used in the free game. When 300 special symbols 506 are to be added, the symbol arrays shown in FIG. 15A and FIG. 15B are used in the free game.

(Feature Game: Free Game)

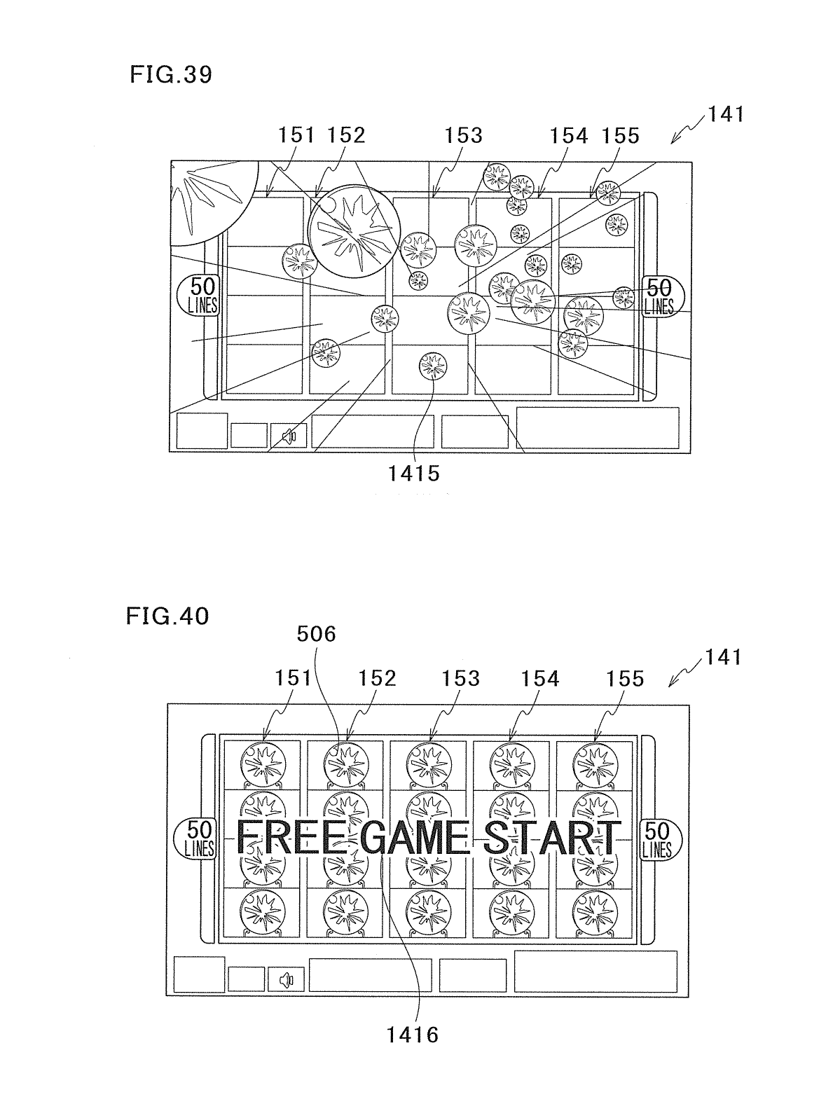

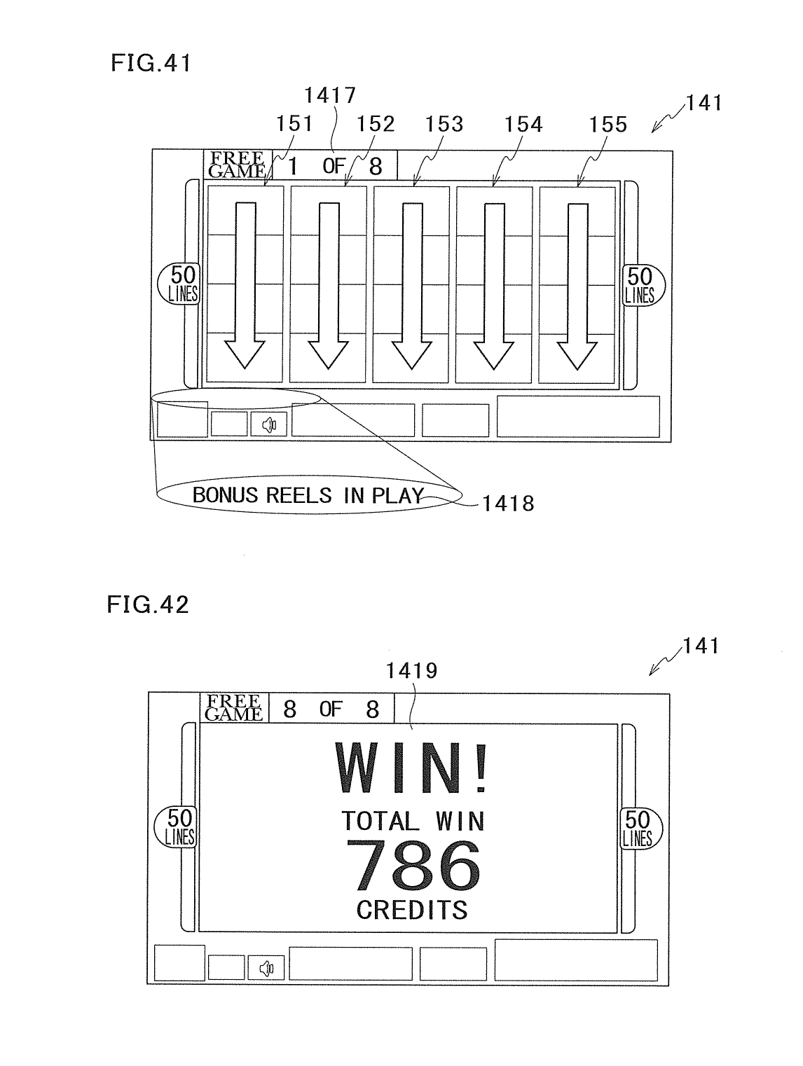

As described, the free game is started after the symbol arrays to be used in the free game are determined in the pick game. First, after the pick game screen is darkened, a crystal symbol addition effect image 1415 is displayed which looks as if crystal symbols (special symbols 506) are added to the pseudo reels 151 to 155, as shown in FIG. 39. Then, the special symbols 506 are rearranged in all the pseudo reels 151 to 155 as shown in FIG. 40. That is, parts of the selected symbol arrays where the special symbols 506 are arranged in a row are displayed in the symbol display area 150. For example, when the symbol arrays shown in FIG. 11A and FIG. 11B are selected, the 4 lower most symbols are selected to create the status in which the special symbols 506 are rearranged in all the display blocks 28 of the symbol display area 150. Specifically, the special symbols 506 of “92” to “95” are displayed in the pseudo reel 151, the special symbols 506 of “113” to “116” are displayed in the pseudo reel 152, the special symbols 506 of “109” to “112” are displayed in the pseudo reel 153, the special symbols 506 of “105” to “108” are displayed in the pseudo reel 154, and the special symbols 506 of “101” to “104” are displayed in the pseudo reel 155. Then, a free game start message 1416 is displayed to indicate that the free game will start. Then, the variable display of the free game is started as shown in FIG. 41.

In the free game, a free game counter 1417 and a bonus message 1418 are displayed as shown in FIG. 41. In the free game counter 1417, the total free game repetition count and the number of the current free game (the number of already consumed free games+1) are displayed in the form of “the number of the current game of the total free game repetition count”. The number of the current game is 0 before the free game starts, and is incremented to 1 when the variable displaying in the free game starts. The total free game repetition count is initially 8. The bonus message 1418 reads “BONUS REELS IN PLAY”, and indicates that the free game is taking place.

When a winning combination is formed in the free game, thus generating a payout, a win effect 1419 indicating the payout amount is displayed on the lower image display panel 141, as shown in FIG. 42. When the free game is run a number of times corresponding to the total repetition count, the display returns to the state in which the feature game is triggered as shown in FIG. 35.

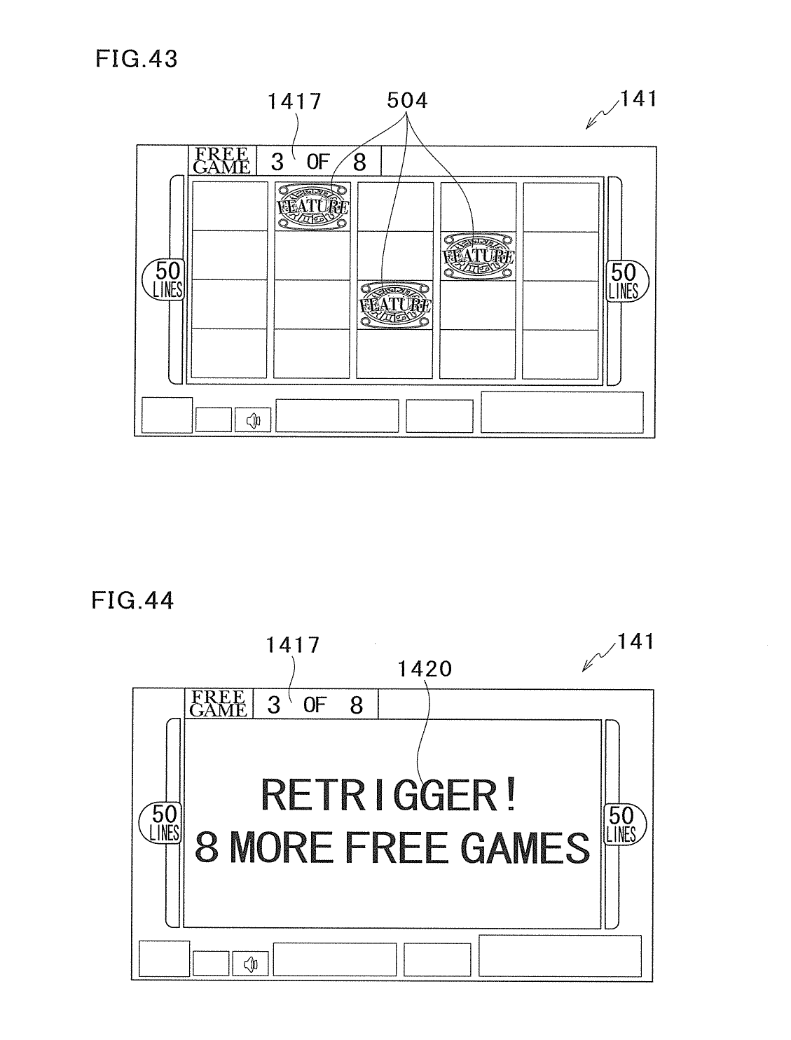

When three trigger symbols 504 are rearranged in the symbol display area 150 during the free game as shown in FIG. 43, a retrigger is established. When the retrigger is established, a retrigger message 1420 as shown in FIG. 44 is displayed to indicate that the free game will be repeated 8 more times. Then, “8” is added to the total free game repetition count indicated on the free game counter 1417. Illustration of this is however omitted.

(Operations of Slot Machine 10: Normal Game Running Process)

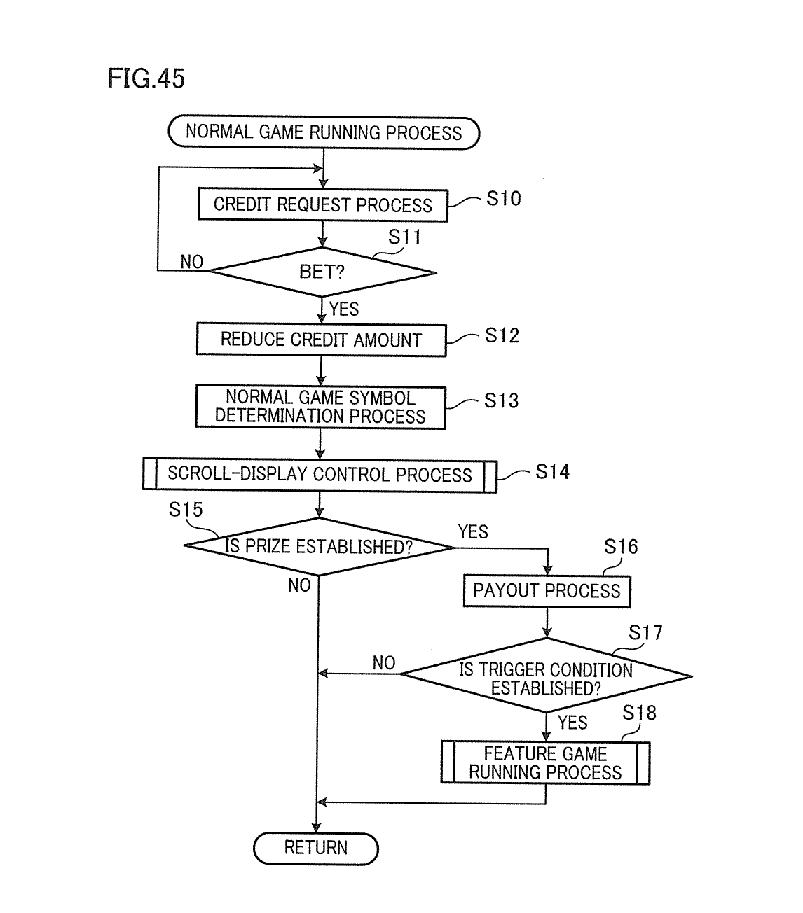

The operation of the slot machine 10 arranged as above will be described. The normal game running process shown in FIG. 45 is executed by the main CPU 71 of the slot machine 10. It should be noted that the slot machine 10 is booted in advance, and there has been carried out a process of reading out the authenticated game program from a memory card 54 via the gaming board 50 and write into the RAM 73.

To begin with, the main CPU 71 executes a credit request process (S10). In this process, the player determines how many credits are used from the credits stored in the IC card.

Then, the main CPU 71 determines whether or not credit is bet (S11). In this process, the main CPU 71 determines whether or not a bet amount for one line is already determined by pressing the bet buttons 34, 35, and 37 to 39, and determines whether or not the number of paylines to be activated is determined by pressing the play line buttons 40 to 44. Alternatively, whether or not the repeat bet button 46 is pressed is determined. In cases where the repeat bet button 46 is pressed, the main CPU 71 the bet amount (the bet amount per line and the number of paylines to be activated) is determined as to be the same as that of the previous game is determined. When it is determined that no credit is bet, the process goes back to S10.

In the meanwhile, if it is determined in S11 that credit is bet, the main CPU 71 executes a process of reducing the credit amount stored in the RAM 73 in accordance with the credit amount bet (bet amount) (S12). When the credit amount bet is larger than the credit amount stored in the RAM 73, the step of reducing the credit amount stored in the RAM 73 is not executed and the process goes back to S11. When the amount of credit bet is larger than the maximum value that can be bet on one game, the step of decreasing the credit amount stored in the RAM 73 is not carried out and the process proceeds to S13.

Next, the normal game symbol determination process is executed (S13). The normal game symbol determination process determines symbols 500 to be rearranged in the symbol display area 150 (pseudo reels 151 to 155). It should be noted that, when the special symbols 506 are to be rearranged, which one of the normal symbols 501 each of the special symbols 506 is substituted for is randomly determined, in S13.

Next, in S14, the main CPU 71 executes a scroll display control process. In this process, the display control is conducted so that, after the start of the scroll of the symbols, the symbols are rearranged in accordance with S15.

Thereafter, the main CPU 71 determines whether a prize is established (S15). In S17, the main CPU 71 counts, regarding the symbols rearranged in accordance with S16, the number of symbols of each type rearranged on each payline L. Then the main CPU 71 determines whether the number of the symbols of each type is at least two. Furthermore, there is determined whether a predetermined number or more of scatter symbols (trigger symbols 504) are rearranged irrespective of the paylines L.

When a prize is not established in S15 (S15: NO), the present routine is terminated. When it is determined that a prize is established (S15: YES), the main CPU 71 executes a step concerning the payout of credit (S16). For example, a process of determining the payout amount based on the bet amount for each line, an effect display process of a payout amount, and a process of adding the payout amount to the credit owned by the player are executed.

Subsequently, whether a trigger condition is established as a result of the rearrangement of a predetermined number or more of scatter symbols (trigger symbols 504) is determined (S17). When the trigger condition is not established (S17: NO), the present routine is terminated. In the meantime, when the trigger condition is established (S17: YES), a feature game running process is executed (S18).

(Operations of Slot Machine: Feature Game Running Process)

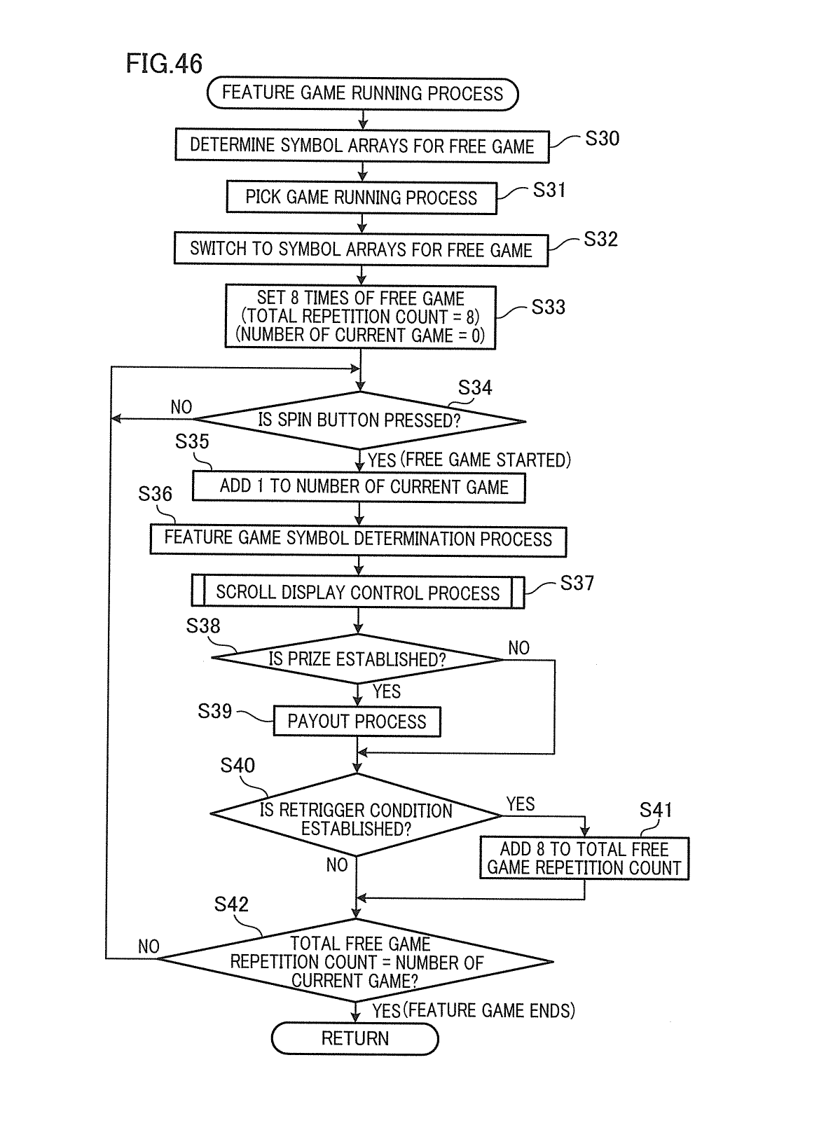

In the feature game running process shown in FIG. 46, the main CPU 71 executes a process of determining symbol arrays for the free game (S30). In this process of determining the symbol arrays for the free game, a type of symbol arrays out of 5 types of symbol arrays for the free game is randomly determined. Then, a pick game running process is executed (S31). In the pick game running process, an effect display of a card game is performed as shown in FIG. 37 and FIG. 38, and a selected target image 1413 corresponding to the symbol arrays for free game randomly determined is displayed in place of the player-selected selectable image 1412. It should be noted that the present embodiment deals with a case where the symbol arrays for the free game is randomly determined; however, the present invention is not limited to this. For example, it is possible to associate 5 types of symbol arrays for free game with 5 selectable images 1412, and use the symbol arrays for free game associated with the player-selected selectable image 1412 in the free game.

Next, the symbol arrays are switched to the symbol arrays for the free game (S32). Specifically, after the crystal symbol addition effect image 1415 as shown in FIG. 39 is displayed, the symbol arrays for the normal game are switched to the symbol arrays for the free game determined in Step S30.

In the free game, the total free game repetition count is set to 8 initially, and the current number of free game is set to 0 (S33).

After that, whether or not the repeat bet button 46 is determined (S34). When the repeat bet button 46 is not pressed (S34: NO), S34 is executed again. In the meantime, when the repeat bet button 46 is pressed (S34: YES), the number of the current game is incremented by 1 (S35), and then the feature game symbol determination process is executed (S36). It should be noted that, when the special symbols 506 are to be rearranged, which one of the normal symbols 501 each of the special symbols 506 is substituted for is randomly determined, in S36. Then, the scroll display control process is executed (S37). After that, whether or not the prize is established is determined (S38). When a prize is established (S38: YES), the payout process is executed (S39), and then S40 is executed. In the meanwhile, when a prize is not established (S38: NO), S40 is executed.

In S40, there is determined whether or not the retrigger condition (free game addition condition) is established (S40). When the retrigger condition is not established (S40: NO), S42 is executed. On the other hand, when the retrigger condition is established (S40: YES), 8 is added to the free game repetition count (S41).

In S42, whether the total free game repetition count equals to the number of the current game is determined (S42). If the total free game repetition count is not the same as the number of the current game (S42: NO), it is determined that there remains unconsumed free game, and the process goes back to S34. On the other hand, if the total free game repetition count is the same as the number of the current game (S42: YES), it is determined that all the repetition of the free game is completed, and the present routine is terminated.

(Process Operations of Slot Machine: Scroll Display Control Process)

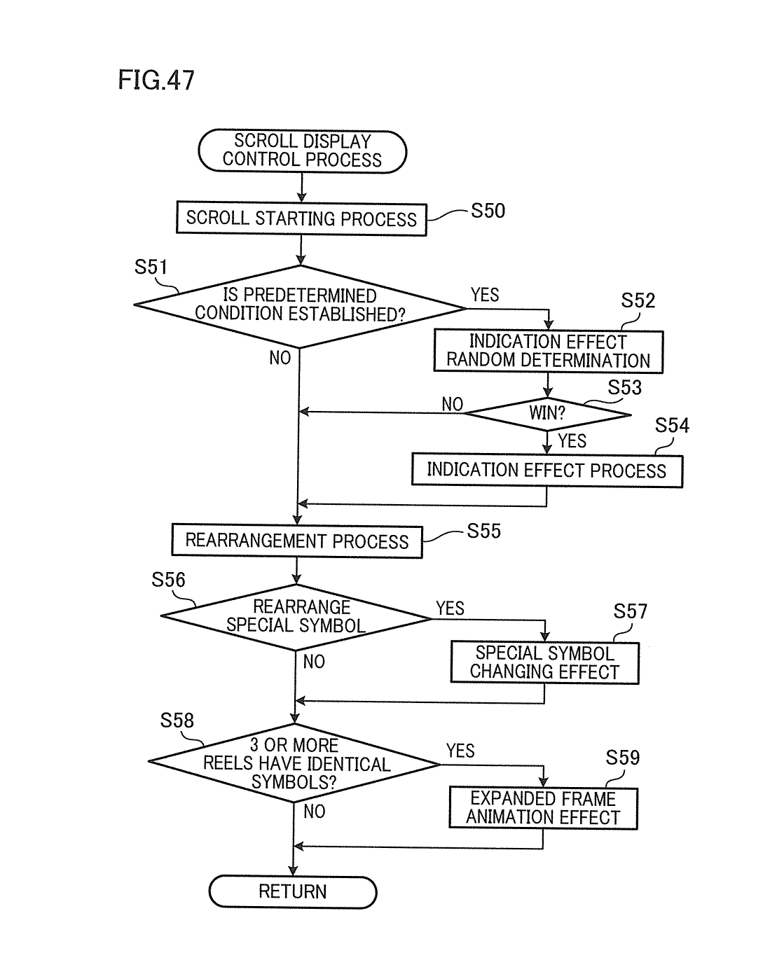

The following describes a scroll display control process of S14 in FIG. 45 and S37 in FIG. 46, with reference to FIG. 47. First, the main CPU 71 executes the scroll starting process (S50). That is, variable displaying of symbol arrays is started in the symbol display area 150 of the lower image display panel 141, as shown in FIG. 17. Next, the main CPU 71 determines whether or not the predetermined condition for the indication effect is established (S51). When there are a plurality of indication effects with different conditions, the main CPU 71 executes the above process of determination for each condition. It should be noted that, if all of the plurality of conditions are satisfied, all of the indication effects may be performed, or one of the indication effects with the highest priority may be performed. In other words, the plurality of indication effects may be given different priorities.

In the present embodiment, the main CPU 71 performs the determination of conditions in S51 for each of the crystal ball appearing indication effect and the feature indication effect. Specifically, the conditions for performing the crystal ball appearing indication effect include 10 or more special symbols 506 included in the symbols 500 to be rearranged, and the payout resulting from a combination with each of the special symbols 506 substituted for any one of the normal symbols 501 being ×20 or more of the bet amount. The condition of performing the feature indication effect is that 3 trigger symbols 504 are included in the symbols 500 to be rearranged.

When the above mentioned conditions are met (S51: YES), there is performed a process of randomly determining whether to perform the indication effect (S52), and the result of the process is determined (S53). When the indication effect is determined as to be performed (S53: YES), the indication effect shown in FIG. 19 and FIG. 23 is performed.

When none of conditions is satisfied in S51 (S51: NO), when the indication effect is determined as not to be performed in S53 (S53: NO), or after S54, the symbols 500 are rearranged (S55).

Then, there is determined whether or not the symbols 500 rearranged includes the special symbol 506 (S56). When the symbols 500 rearranged include the special symbol 506 (S56: YES), the effect of converting the special symbol as shown in FIG. 22 is executed (S57). That is, an effect of converting the special symbol 506 to any one of the normal symbols 501 is executed.

When the special symbol 506 is not rearranged (S56: NO), or after S57, there is determined whether or not identical symbols are rearranged in 3 or more reels (S58). When the identical symbols are not rearranged in 3 or more reels, the present routine is terminated. On the other hand, when the identical symbols are rearranged in 3 or more reels, the expanded frame animation effect is executed according to the number of reels having the identical symbols, as shown in FIG. 29, FIG. 30, and FIG. 31 (S59). The present routine is then terminated.

(Other Structures)

The following describes the other structures of the gaming machine 300 (slot machine 10) described above.

(Spin Table)

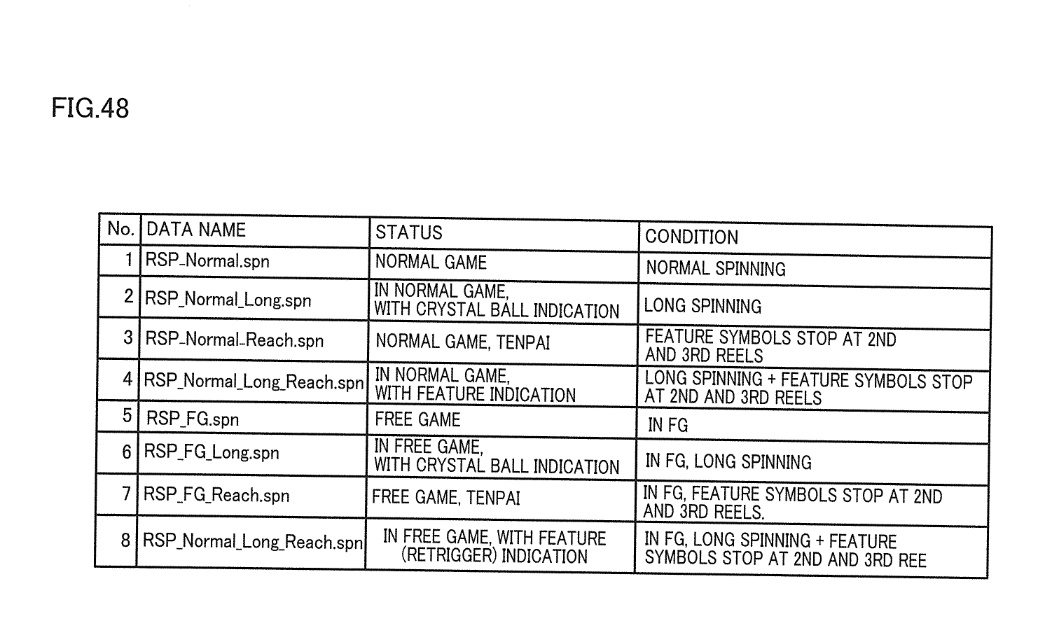

FIG. 48 shows a spin table of sets of spin data used in different gaming states of the slot machine 10. The spin table includes number fields, data name fields, status fields, and condition fields.

For example, in association with “1” of the number field, the data name field stores “RSP_Normal.spn”, the status field stores “Normal Game”, and the condition field stores “Normal Spinning”. In association with “2” of the number field, the data name field stores “RSP_Normal_Long.spn”, the status field stores “In normal game, with crystal ball indication”, and the condition field stores “Long Spinning”. That is, when the crystal ball appearing indication effect is performed, “RSP_Normal_Long.spn” which is data for “Long Spinning”, longer variable displaying than usual, is selected. In association with “3” of the number field, the data name field stores “RSP_Normal_Reach.spn”, the status field stores “Normal game, Tenpai”, and the condition field stores “Feature symbols stop at second and third reels”. That is, when the trigger symbol 504 stops in the pseudo reels 152 and 153 in the normal game, and the trigger symbol 504 further stops in the pseudo reel 154, the trigger condition is established and the feature game will be started. As described, when the trigger symbol 504 stops in the pseudo reels 152 and 153, and the pseudo reel 154 is still variably displayed, the “RSP_Normal_Reach.spn” which is different from the normal is selected. As is clear from the above, the spin table stores data that changes the effect of variable displaying according to the status.

(LED Data Table)

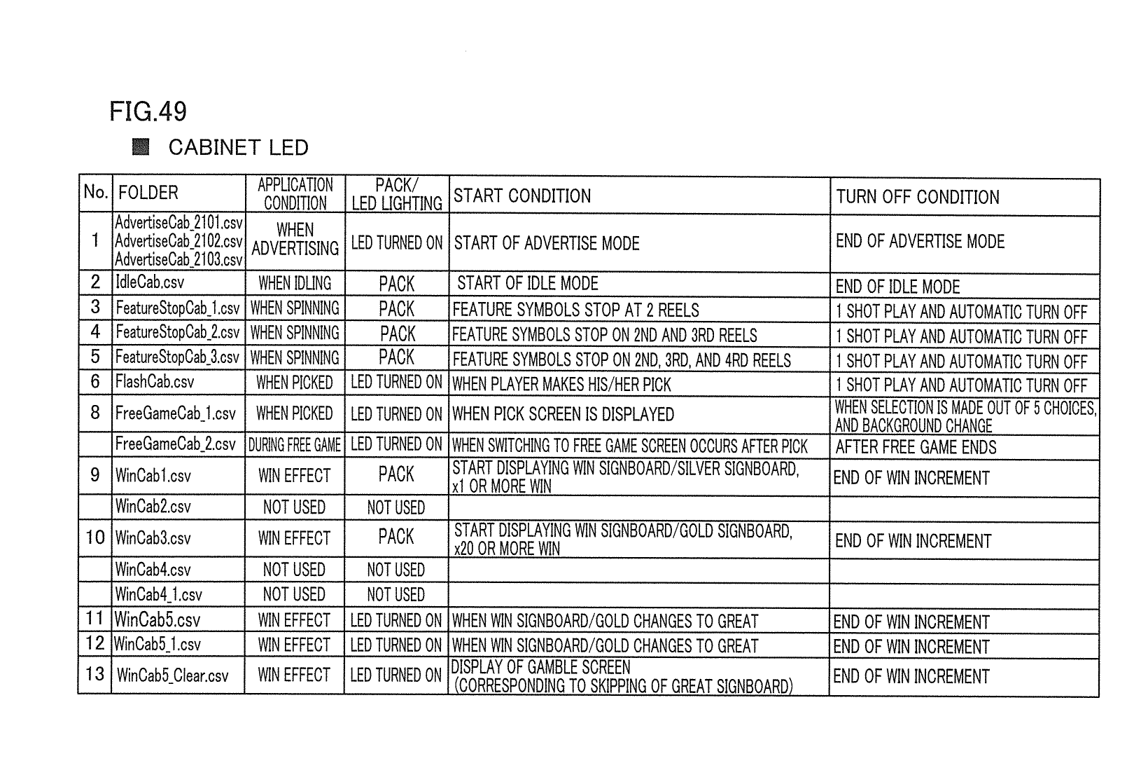

FIG. 49 shows a LED data table by which a condition for controlling the turn-on/off of LED on the slot machine 10. The slot machine 10 reproduces LED data under the control of a program based on the data table.

More specifically, the LED data table includes number fields, folder fields, application part fields, Pack/Led Lighting field, start condition fields, and deletion condition fields. For example, in association with “1” of the number field, the folder field stores “AdvertiseCab_{—}2101.csv, AdvertiseCab_{—}2102.csv, AdvertiseCab_{—}2103.csv”, the application part field stores “WHEN ADVERTISING”, the Pack/LED lighting field stores “LED TURNED ON”, the start condition field stores “START OF ADVERTISE MODE”, and the deletion condition field stores “END OF ADVERTISE MODE”. The advertise (ADVERTISE) is the state to be transited when the slot machine 10 is in the idling state. For example, during the advertise, an effect display by the LED is performed to show that the slot machine 10 is in operation. The fields associated with the “1” of the number field indicate the data used for the LED effect during this advertise mode. As described, the LED data table stores the data for used in LED effect according to different statuses.

(Screen Layout)

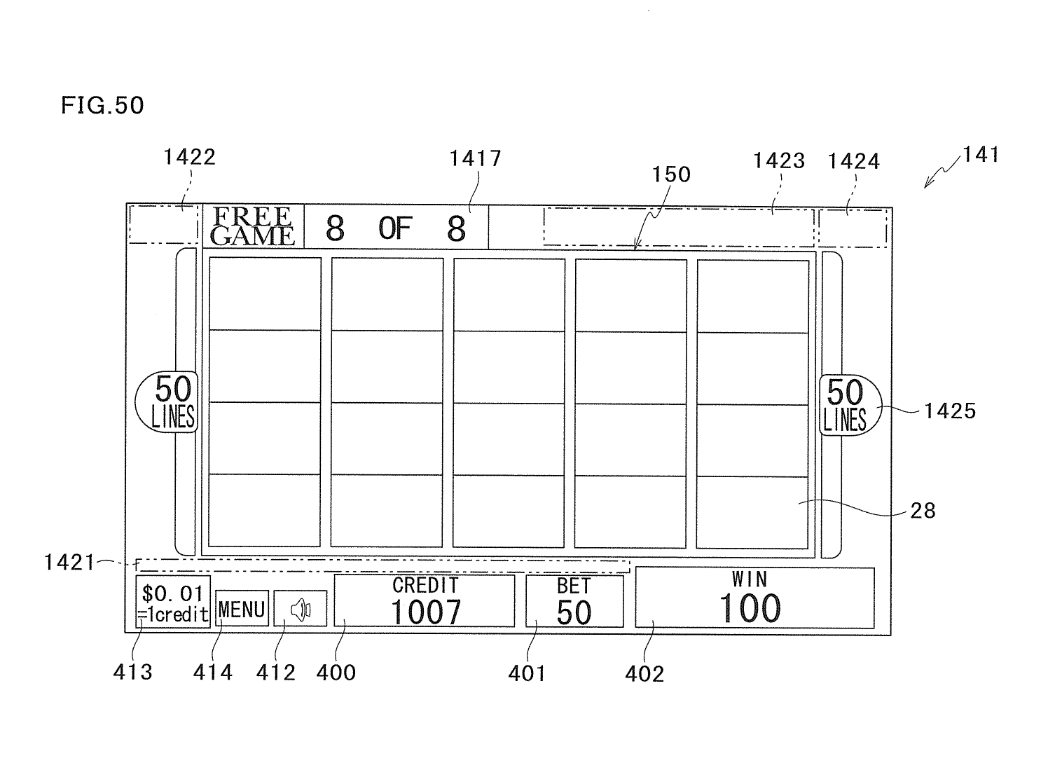

The following describes in details a screen layout on the lower image display panel 141. The lower image display panel 141 employed is one based on the HD standard of 1366×768 in resolution, for example. As shown in FIG. 50, the lower image display panel 141 is provided with an area to serve as the symbol display area 150 which is a reel window provided with the pseudo reels 151 to 155 in which symbol arrays are variably displayed. In the symbol display area 150, the display blocks 28 for rearranging therein symbols are provided in 5 columns and 4 rows; however, the symbol display area 150 is not limited to this, and for example, the display blocks 28 may be provided in 5 columns and 3 rows. Below the symbol display area 150 are provided various display areas for indicating the status of the game. Specifically, below the symbol display area 150, there are provided a denomination indicator 413, a menu touch icon 414, a volume touch icon 412, a credit meter 400, a bet meter 401, and a win meter 402. Between the symbol display area 150 and the various display areas indicating the status of the game is provided a game message display area 1421.

Above the symbol display area 150 are arranged an error log indicator 1422, the above-mentioned free game counter 1417, a system message 1423, and a time indication area 1424. On both sides of the symbol display area 150 is provided a line count indicator 1425.

The denomination indicator 413 indicates the current denomination which is set in advance. Specifically, the indicator has two stages, i.e., upper stage and the lower stage. In the upper stage is shown the currency or the game point, while the lower stage shows the credit amount corresponding to the currency or the game point in the upper stage. It should be noted that the denomination may be switchable by the touching operation by the player. The volume touch icon 412 switches the sound volume of the game in 3 steps. Each time the icon is touched, the game sound volume is switched such that, for example, from low to middle to high to small to middle.

The game message display area 1421 displays a message such as, for example, “BONUS REELS IN PLAY”, when the symbol arrays for free game and the like, different from those in the normal occasions, are used. Further, during the idling and advertising state, text of “GAME OVER” is displayed. While the GAMBLE is waited, text of “PLAY ON, GAMBLE TAKE WIN” is displayed. To add the above, for example, “GAME PAYS 123456789” is displayed as the total credit won, and “LINE 12 WIN×123123456789” is displayed as the details of the payout.

The error log indicator 1422 indicates the log of errors occurred in the slot machine 10, in the left justified manner. When there are a plurality of error records, the indication of the log is switched. The system message 1423 shows the payout, the ticket log, communication information, and the like in the right justified manner, with the time indication area 1424 on the right side. Examples of payout information displayed in the system message 1423 include: “AMOUNT PAID $$12,345,678.90(TOTAL $$12,345,678.90).”, “AMOUNT PAID OUT $$12,345,678.90 (TOTAL $$12,345,678.90).”, and “NOTE REJECTED IF CREDITS EXCEED $10,000.” Further, when auto-play is possible, “AUTO PLAY” is displayed. Time indication area 1424 indicates the current time. However, the time indication area 1424 may be one that does not indicate the time.

The line count indicator 1425 indicates the number of active paylines selected by the play line buttons 40 to 44. That is, the number of paylines in the previous game is indicated. When the number of paylines is fixed (e.g., 50), that number of paylines is displayed in a fixed manner.

(Meters)

The following describes the credit meter 400, the bet meter 401, and the win meter 402. The credit meter 400 is an area for indicating the total credit amount. The bet meter 401 is an area for indicating the total bet amount (=bet amount per line×the number of active paylines). The win meter 402 is an area for indicating the total credit amount of the prizes won.

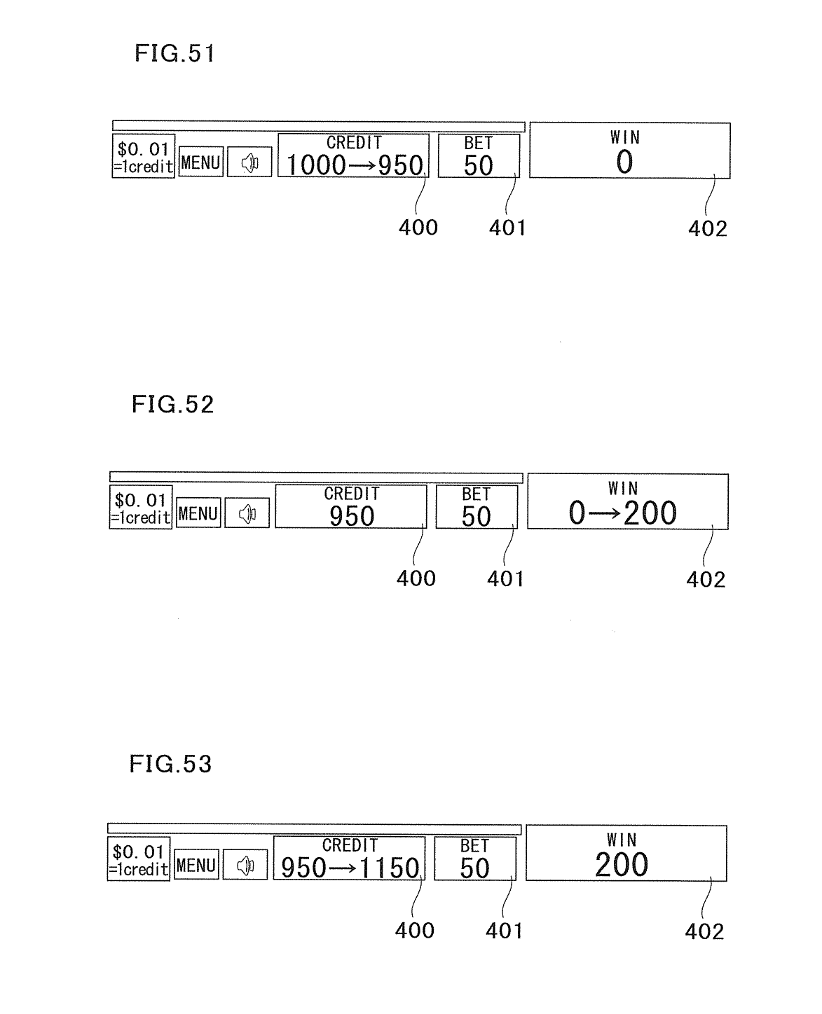

First, the following description deals with a case where there is a payout in the normal game. When the game starts with a bet amount of 50, the bet meter 401 indicates 50, and credit meter 400 indicates that 50 will be subtracted, as shown in FIG. 51. That is, while the player-owned credit amount is 1000, the amount of 50 is subtracted from the player-owned credit, and 950 will be indicated in the credit meter 400. When there is a payout of 200 after all the pseudo reels stop, the win meter 402 indicates an increment of an amount 200, as shown in FIG. 52. Then, the payout won is added to the value of the credit meter 400, as shown in FIG. 53. That is, the credit meter 400 indicates 1150 which is the sum of 950 and 200.

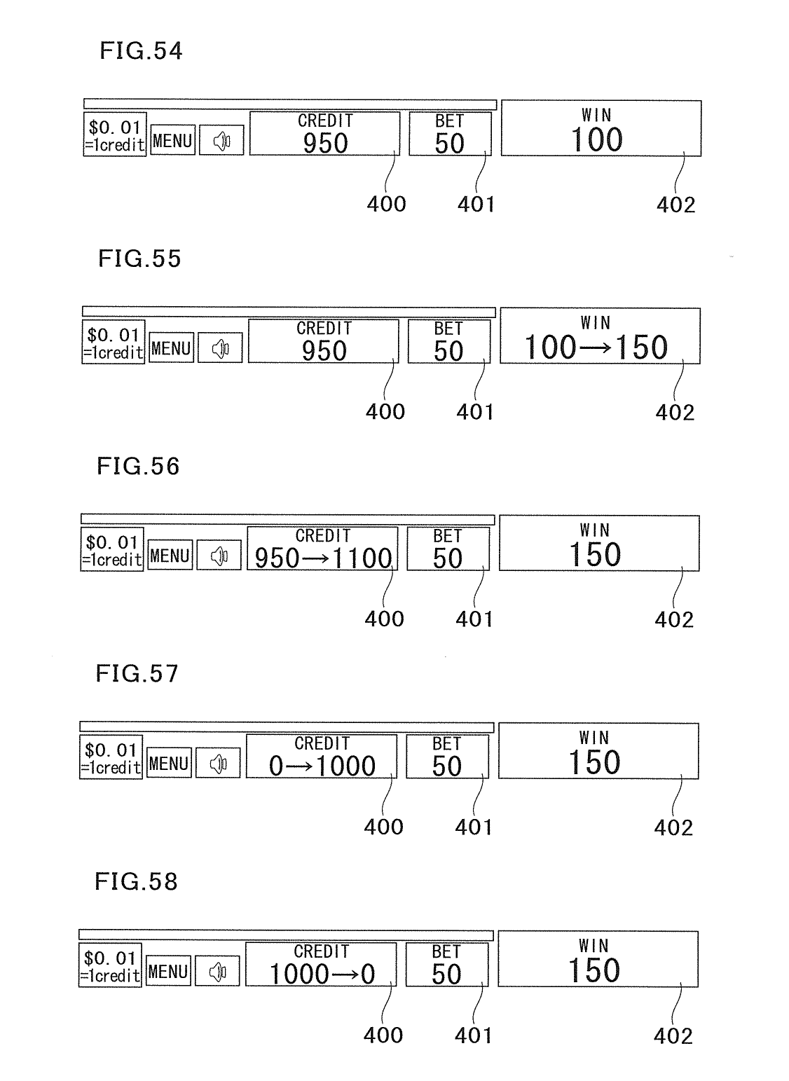

Next, the following description deals with a case where there is a payout in the free game. As shown in FIG. 54, the bet meter 401 during the free game indicates the amount of bet in the normal game having triggered that free game. Further, the win meter 402 indicates the payout won at the time of triggering the free game. When there is a payout of 50 after all the pseudo reels of the free game stop, the win meter 402 indicates an increment of an amount 50, as shown in FIG. 55. Then, when the free game ends, the payouts added to the win meter 402 are added at once to the value of the credit meter 400, as shown in FIG. 56.

When the player adds an amount of credit to the slot machine 10, the added amount of credit is added at once to the value of the credit meter 400, as shown in FIG. 57. It should be noted that the indication of the win meter 402 is not updated. Further, when the player cashes out the credit from the slot machine 10, the credit amount indicated in the credit meter 400 is updated to 0. It should be noted that the indication of the win meter 402 is not updated.

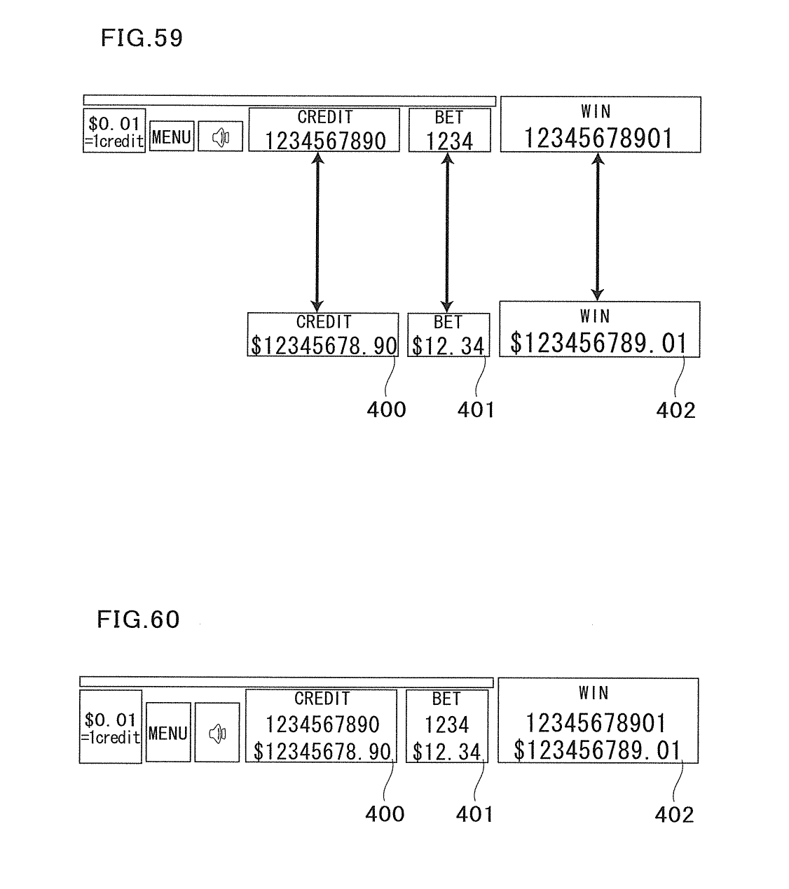

The credit meter 400, the bet meter 401, and the win meter 402 may be configured so that touching of the indication part of any of these meters 400 to 402 will switch the unit of indication between the credit and the amount of money, as shown in FIG. 59. When the slot machine 10 stores an amount less than a credit amount of 1, the indication may be automatically switched to indication in the amount of money. Further, the credit meter 400, the bet meter 401, and the win meter 402 may each have two stages, i.e., the upper stage and the lower stage, as shown in FIG. 60, and the credit amount and the amount of money may be indicated in the upper stage and the lower stage, respectively.

(Touch Icon)

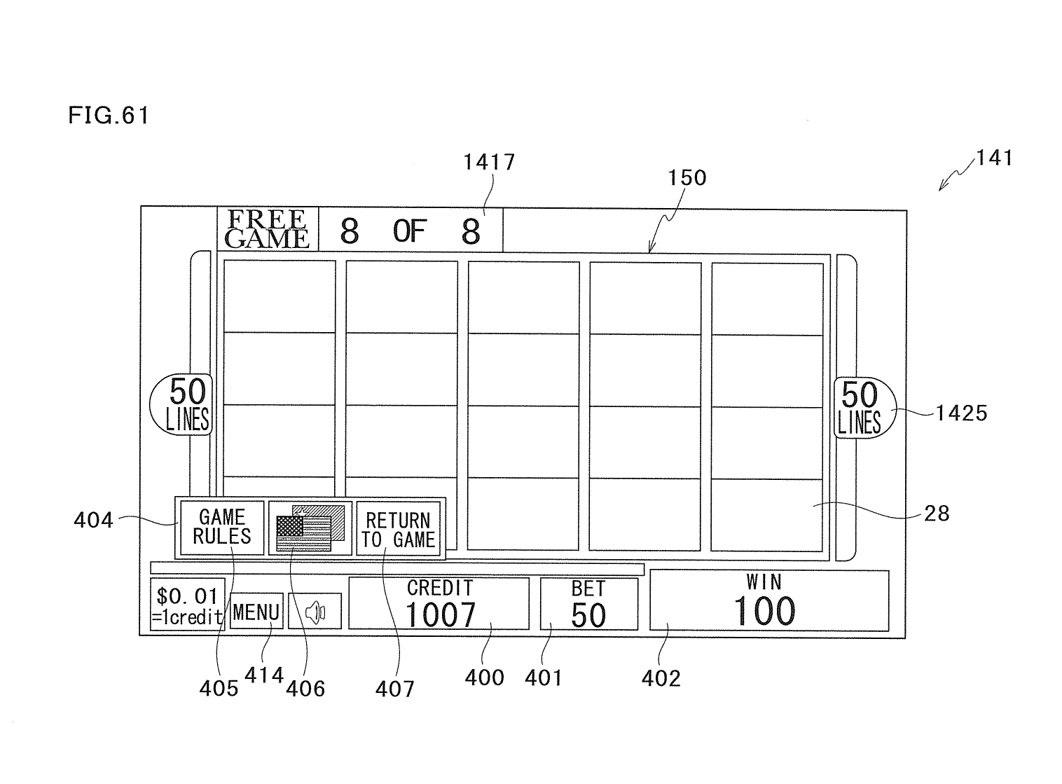

The menu touch icon 414, when touched, opens a menu window 404 as shown in shown in FIG. 61. In the area of the menu window 404, there are provided a game rule icon 405, a language selection icon 406, and a return-to-the-game icon 407. Touching the game rule icon 405 displays the help screen. Touching the language selection icon 406 switches the language used between English and Chinese, while the menu window 404 is displayed. Touching the return-to-the-game icon 407 hides the menu window 404. The menu window 404 is hidden also when the control panel 30 is operated, when no operation was entered for 30 seconds, an area other than the menu window 404 is touched, and at the time of cash in. The game rule icon 405 may be provided in place of the menu touch icon 414.

(Help Screen)

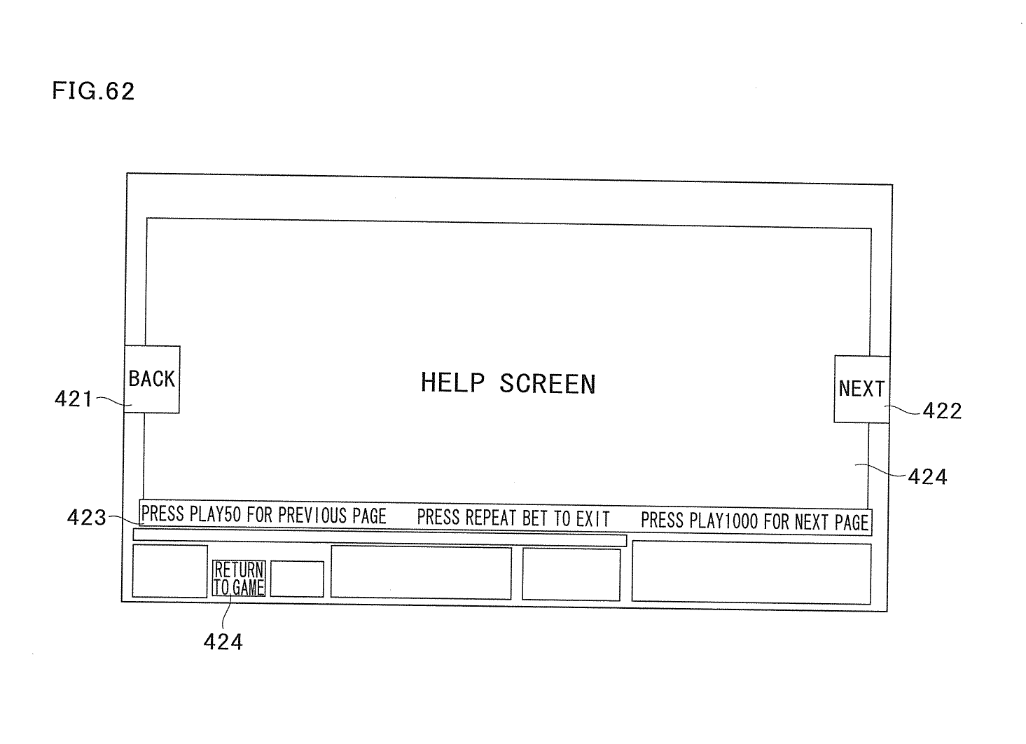

The following describes the help screen which is displayed on the lower image display panel 141 when the game rule icon 405 is touched. A help screen 420 is displayed at the central portion of the lower image display panel 141, as shown in FIG. 62. On the left side of the help screen 420 is a back touch icon 421. On the right side of the help screen 420 is a next touch icon 422. Below the help screen 420 is displayed an operation manual indication 423. Further, the return-to-the-game icon 424 is displayed in the area where the menu touch icon 414 was displayed.

The help screen 420 is configured to switch and display a plurality of pages. Specifically, the help screen 420 displays the guide to the game over all, the line configuration as shown in FIG. 3, the guide to the feature game, the payout table as shown in FIG. 2, the descriptions of icons, and the like. Further, the screen displays the range of credit playable (“PLAY XXX TO YYY CREDITS”), and indicate that all the payouts are paid out by the slot machine 10 or the staff people. Further, the screen indicates that the credit meter 400, the bet meter 401, and the win meter 402 is configured so that touching of the indication part of any of these meters 400 to 402 will switch the unit of indication between the credit and the amount of money.

Touching the back touch icon 421 displays the immediately previous page. Touching the next touch icon 422 displays the next page. Touching the return-to-the-game icon 424 ends the help screen. The help screen may be ended also when the no-operation status continues for 3 minutes, when an amount of credit is entered, when an error occurs, when the repeat bet button 46 of the control panel is operated, and the like. Further, for example, when there is a game rule button on the control panel, the help screen may be ended when that button is operated.

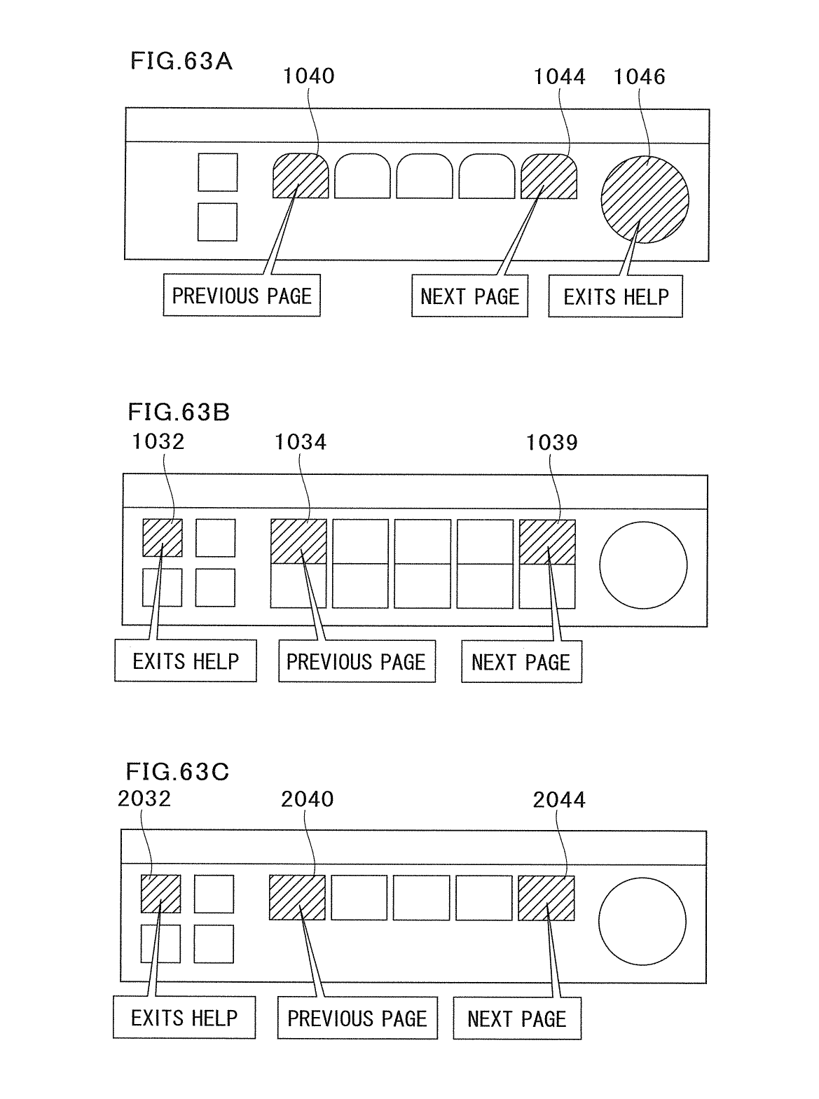

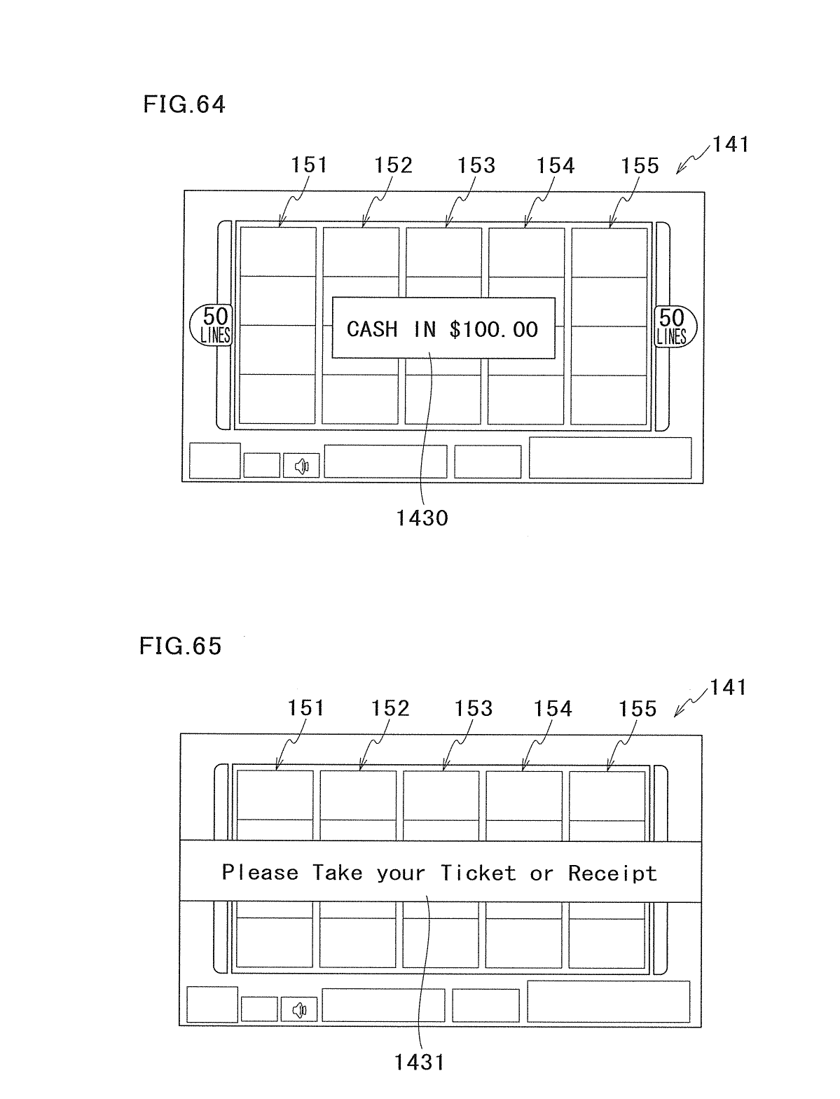

The operation manual indication 423 provides descriptions for operations of the help screen by the control panel 30. For example, when the number of active paylines is fixed and there is only a button for designating the bet amount, the operation manual indication 423 indicates that the previous page is displayed by the play 50 button 1040 for designating a bet of 50, the help screen is ended by the repeat bet button 1046, and the next page is displayed by the play 1000 button 1044 for designating a bet of 1000, as shown in FIG. 63. Further, for example, when the number of active paylines is selectable, the operation manual indication 423 indicates that the previous page is displayed by the 1 bet button 1034 for placing a bet of 1 on one line, the help screen is ended by the game rule button 1032, and the next page is displayed by the 20 bet button 1039 for placing a bet of 20 on one line, as shown in FIG. 64. Further, for example, when the number of active paylines is fixed and there is only a button for designating the bet amount, the operation manual indication 423 indicates that the previous page is displayed by the play 50 button 2040 for designating a bet of 50, the help screen is ended by the game rule button 2032, and the next page is displayed by the play 1000 button 2044 for designating a bet of 1000, as shown in FIG. 65.

(The Other Status of the Slot Machine 10)

The progressive money amount is brought to the initial value in the slot machine 10, after clearing the RAM. Further, immediately after the RAM clearance, the reels are stopped at the reel stop position exclusively for immediately after the RAM clearance. The symbols 500 are stopped in such a manner as to form no winning combination. Further, the log of SYSTEM TILT is displayed and the touch buttons are lighted and activated. The minimum values are selected for the number of active paylines and the bet amount per payline, and the line count indicator 1425 indicates the minimum number of paylines. Note however that, when the number of paylines is fixed, the fixed value is indicated. The meters 400 to 402 indicates “0”, and the game message display area 1421 displays the text of “GAME OVER”. This changes as “XX BET PER LINE”, according to the amount of bet placed for each payline selected. It should be noted that the TOTAL BET does not make such a change, until the game is started.

In the idling state, the game message display area 1421 displays the text of “GAME OVER”. When the credit is entered cash-in is carried out, the cash-in indicator 1430 is displayed as shown in FIG. 64. For example, the cash-in indicator 1430 indicates that “CASH IN $100.00”, and this will disappear after 3 seconds. After such a cash-in and the credit reaches the amount such that the game is playable, the control panel 30 lights up and is activated.

When the game starts and variable display of the pseudo reels 151 to 155 starts, the SYSTEM TILT log disappears. Further, the menu touch icon 414 is disabled, while the volume touch icon 412 is activated. Further, the game message display area 1421 hides the text of “GAME OVER”, The bet meter 401 indicates the consumed credit amount, and the amount of credit consumed is subtracted from the value of the credit meter 400. The values selected for the lines and bet is maintained.

When one game ends and there is no payout, the game message display area 1421 displays the text of “GAME OVER”. Further, the values of the meters 400 to 402 are maintained until the start of the next game. As to the effect of the cases where there is a payout, description is provided later. When there is a cash-out, a ticket issuance signboard 1431 is displayed as shown in FIG. 65. The value of the credit meter 400 is changed to “0”. The indications on the bet meter 401 and the win meter 402 are maintained. The system message 1423 shows a payout log.

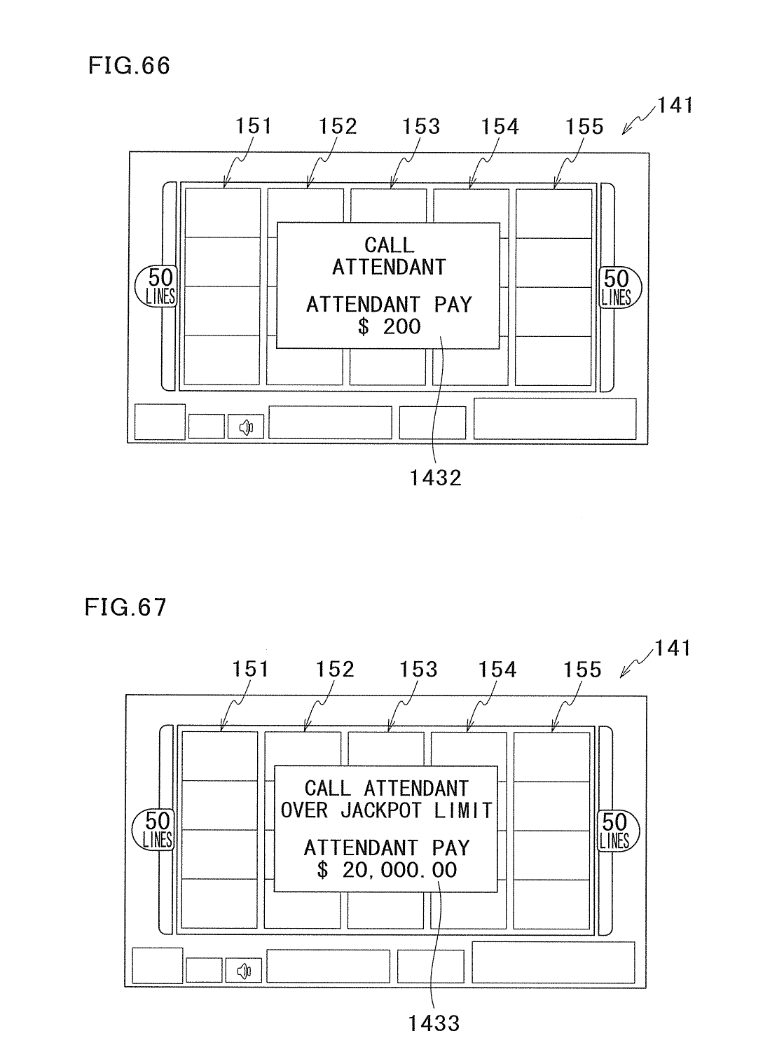

When cashing out manually, CALL ATTENNDANT is executed. As shown in FIG. 66, a call-attendant image 1432 is displayed, and the slot machine 10 is locked. Then, a special sound is output, and the value of the credit meter 400 is maintained until the machine is reset by a key. After the reset by the key, the call-attendant image 1432 is hidden, and the indication of payout is also hidden. Then, the value of the credit meter 400 is changed to “0”. The indications on the bet meter 401 and the win meter 402 are maintained. The system message 1423 indicates that the CALL ATTENNDANT has been executed.

In cases of ATTENNDANT PAY for the WIN, the call-attendant image 1433 is displayed as shown in FIG. 67, and the slot machine 10 is locked. Then, only the WIN amount is paid manually. The special sound is output and the effect is paused. The values of meters 400 to 402 are maintained. After the reset by the key, the call-attendant image 1433 is hidden. The values of meters 400 to 402 are maintained. The system message 1423 indicates that the CALL ATTENNDANT has been executed.

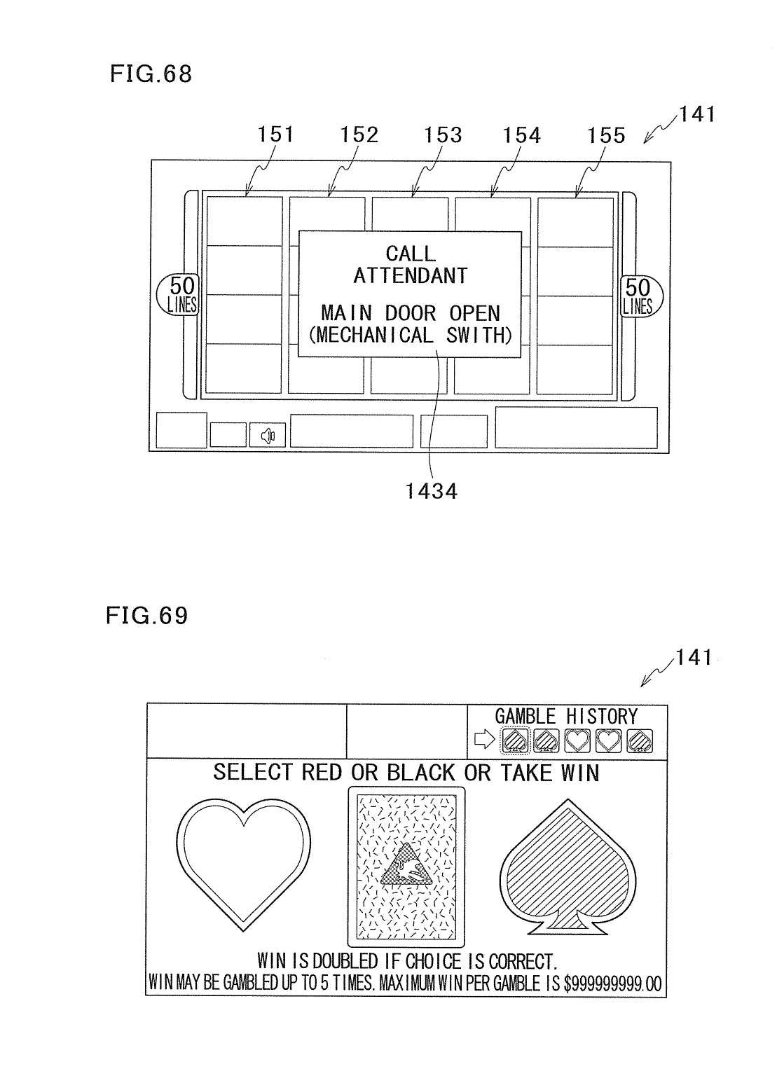

When an error occurs, the game is stopped upon occurrence of the error. Then, the call-attendant image 1433 is displayed as shown in FIG. 68. If the error is one that can be automatically recovered, the call-attendant image 1433 is hidden upon cancellation of the error. If the error requires resetting, the call-attendant image 1433 is hidden after the resetting by a key is carried out. When the error takes place during the game, the game is resumed after the error is cancelled.

In cases of the gamble waiting state, the system message 1423 shows text “PLAY ON, GAMBLE or TAKE WIN”. As to the other areas, the state after the WIN is continued. When the gamble button 45 of the control panel 30 is pressed, there will be a transition to the gamble screen shown in FIG. 69. The WIN in the gamble game is added to the value of the win meter 402. If the last gamble game is won, and the cash-out button 32 is pressed, the win meter 402 indicates the WIN value of the gamble game, and the credit meter 400 indicates the value after the WIN value is added. It should be noted that when the gamble game results in LOSE, the win meter 402 indicates “0”. The gamble game is detailed later. The idling state starts after the gamble game ends. The values of meters 400 to 402 are maintained to the state of the previous game. The win meter 402 indicates the WIN value at the time the gamble game is ended, or “0”.

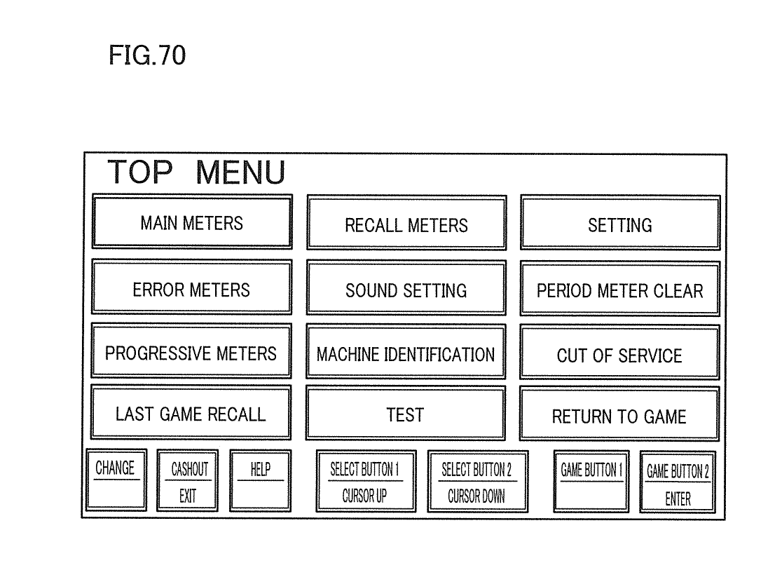

In an audit screen (setting screen), screens as shown in FIG. 70 are displayed. At this time, the upper image display panel 131 is blacked out. When the audit screen is set, entry of credit and playing of game are disabled.

(Button Prereading Process)

A button prereading process is provided to smoothly start the next game by receiving an input to the repeat bet button 46 for the next game immediately before the end of the rotation of the reels, in the normal game.

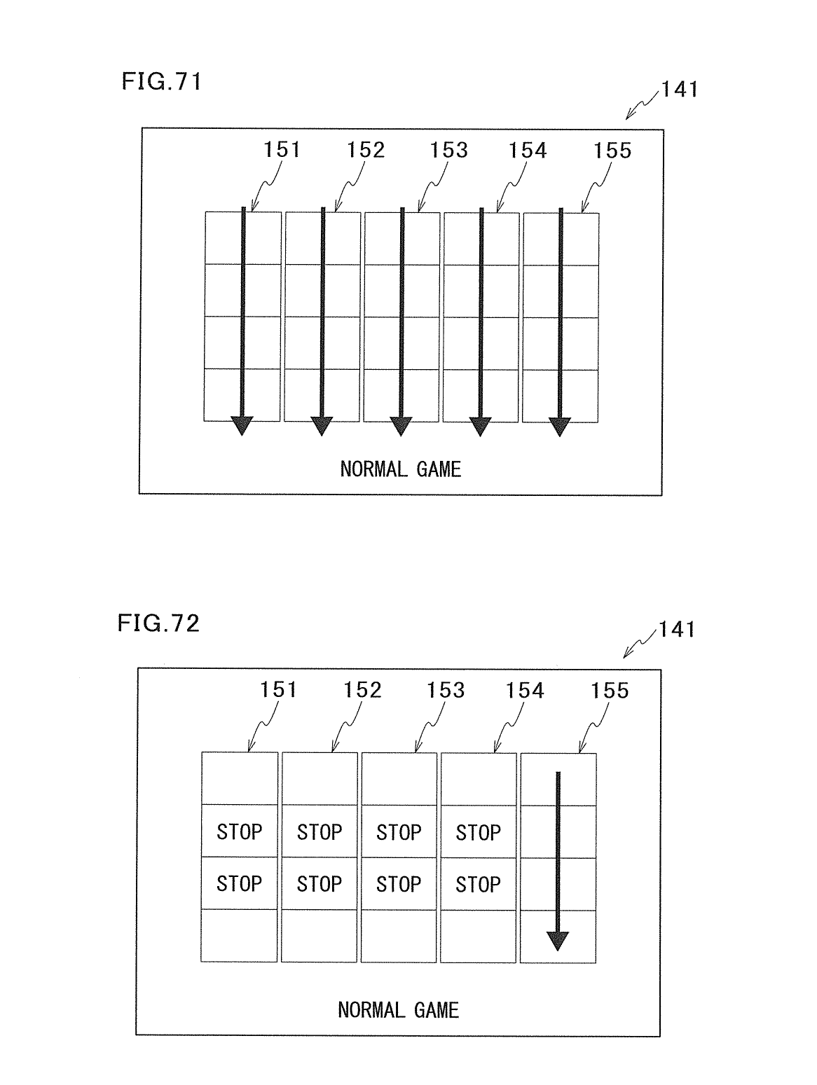

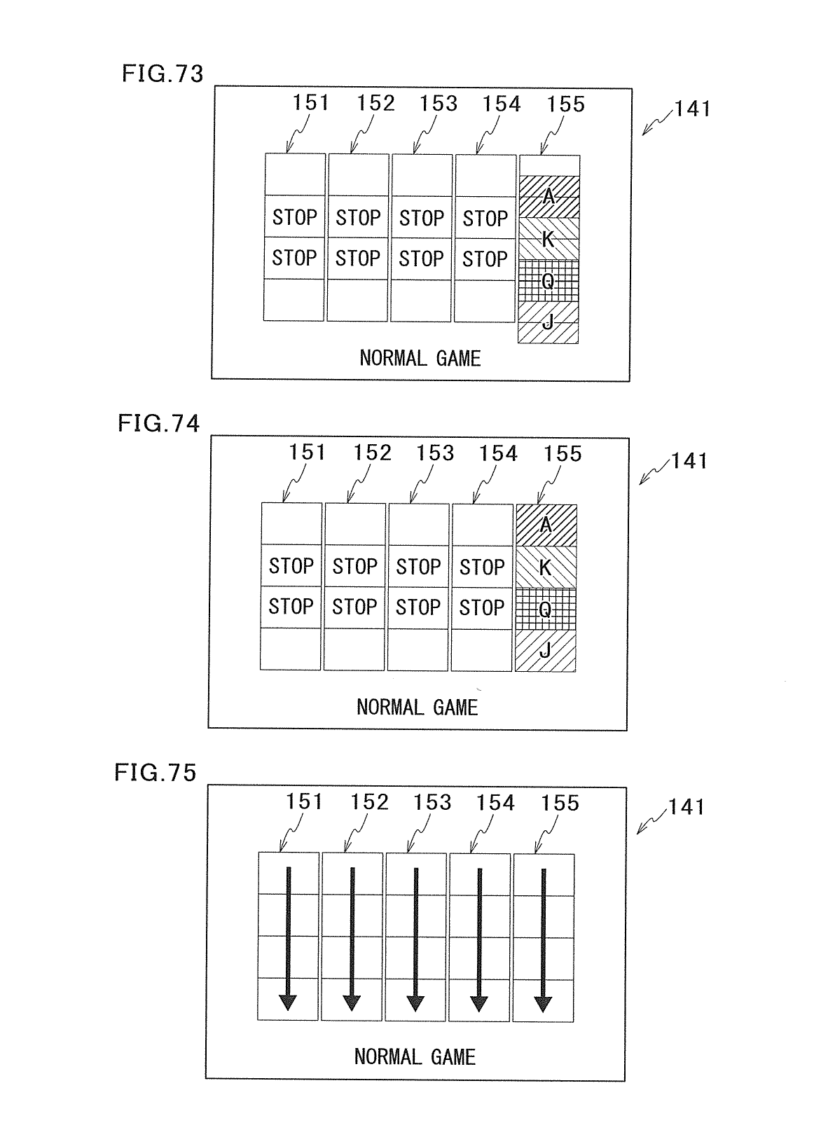

To be more specific, as shown in FIG. 71 and FIG. 72, the rotation of the fourth reel stops. Thereafter, as shown in FIG. 73, when the repeat bet button 46 is continuously pressed while the fifth reel sinks at the maximum and rises to the surface, as shown in FIG. 74 and FIG. 75, the spinning in the next game starts immediately after the stop of the fifth reel. It is noted that, while the spinning in the next game immediately starts, other effects and processes are not skipped.

The prereading function of prereading the pressing of the button is active only in a normal game in which no WIN occurs. The prereading function is inactive in a game in which WIN occurs. By setting the AUDIT, the prereading function is activated or disabled. In other words, the priority is arranged as Setting>Hardware setting>Control panel. The prereading function is usually activated. The function is disabled in USA.

The button prereading function is active only when the remaining credit amount is sufficient to start the next game. For example, when a currently-selected bet is 50 whereas the remaining credit amount is 25, the spin prereading function is disabled. In the meanwhile, when a currently-selected bet is 50 whereas the remaining credit amount is 100, the spin prereading function is activated.

When the prereading is active, a corresponding button LED is turned on. When the prereading of the spinning is active, the spin button is illuminated.

(Button Prereading Process: Coexistence with Reel Skip Function)

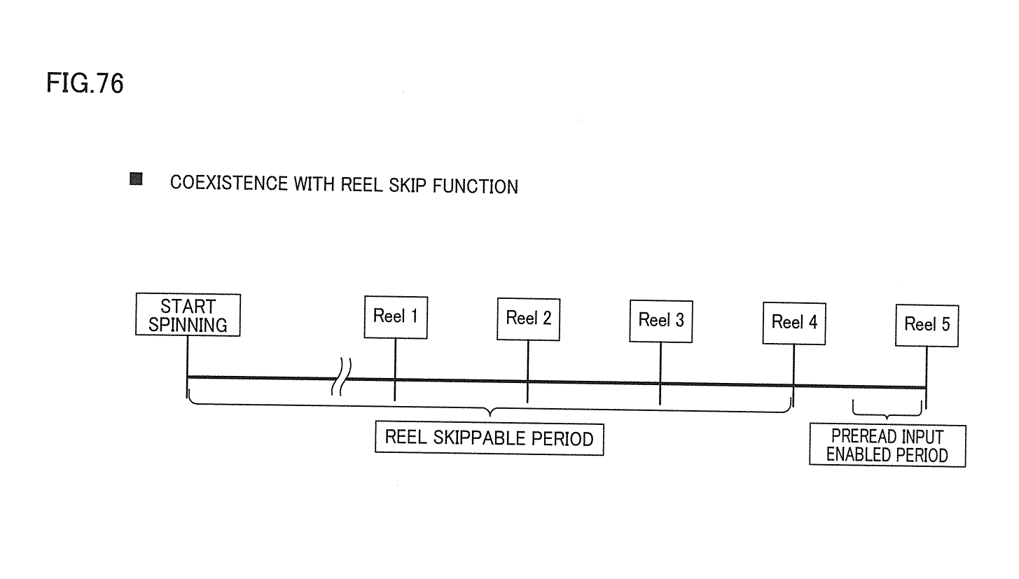

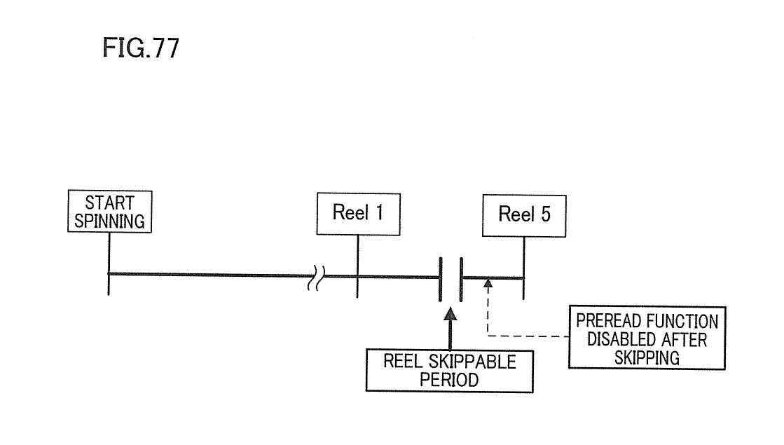

As shown in FIG. 76, the button for the prereading function is used also for the reel skip. For this reason, a reel skippable time and a prereading input available time are independently provided. In the reel skippable time, the reel skip function is active. In the input available time, the prereading of the next game is active. As shown in FIG. 77, when the reel skip is executed in a game, the prereading function is disabled in that game. With this arrangement, even if the button mistakenly pressed twice to execute the skip function, the next game does not unexpectedly starts due to the execution of the spin button prereading function.

(Win Effect)

Now, an WIN effect executed during the game as above will be described. The WIN effect is an effect executed when WIN (payout) is achieved in the normal game or the free game. When the win occurs, the amount of win (payout amount) is added in the win signboard 134 (Win effect image 1314, see FIG. 36) displayed in the win meter 402 and the upper image display panel 131. Further, when the free game ends, the win effect 1419 is displayed according to the total credit amount won (total payout amount) (see FIG. 42).

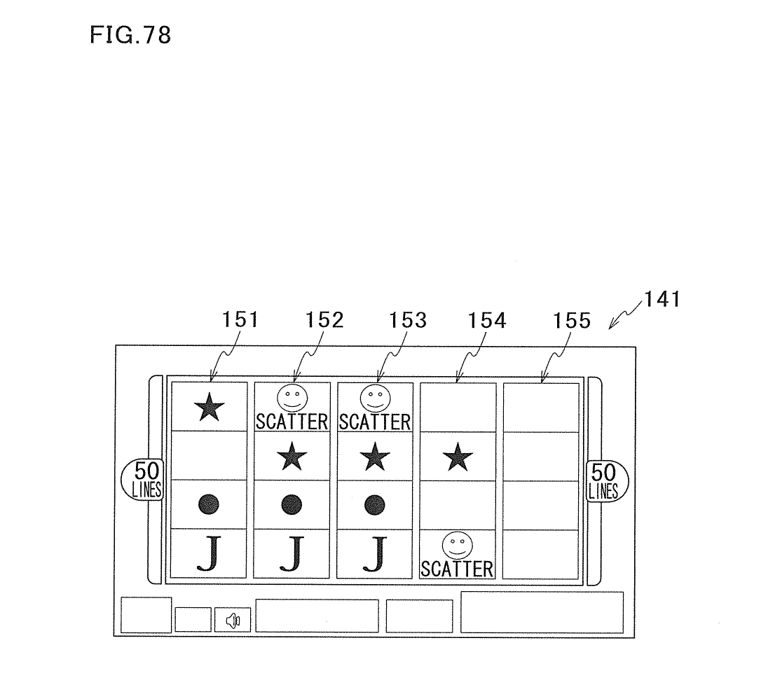

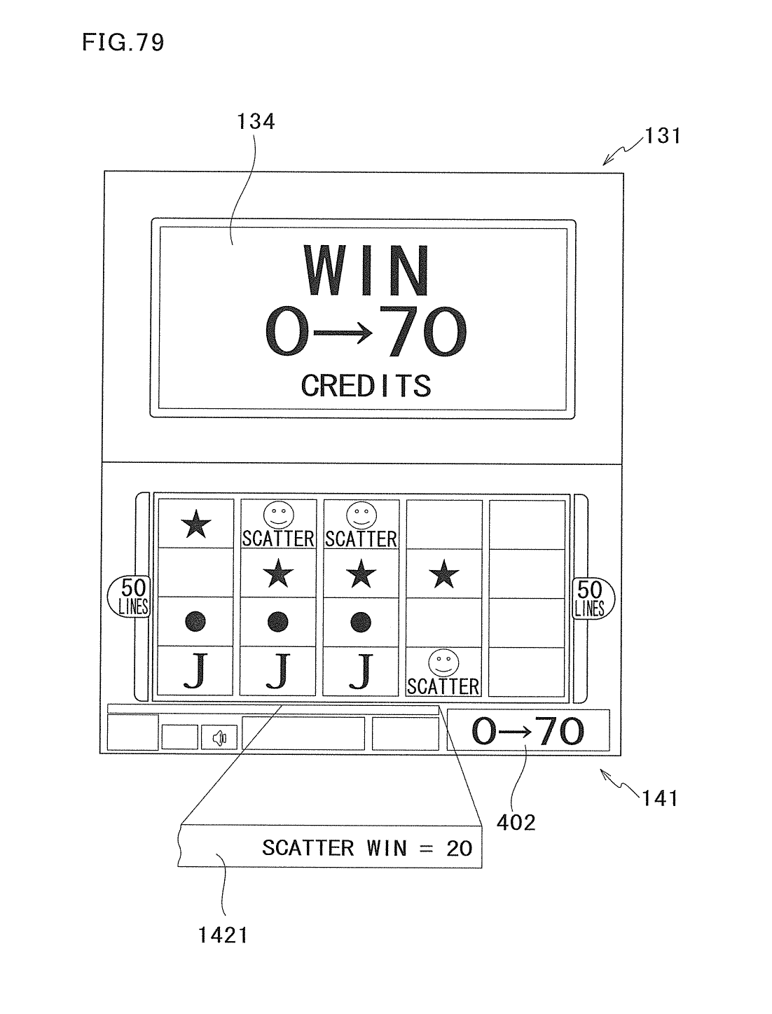

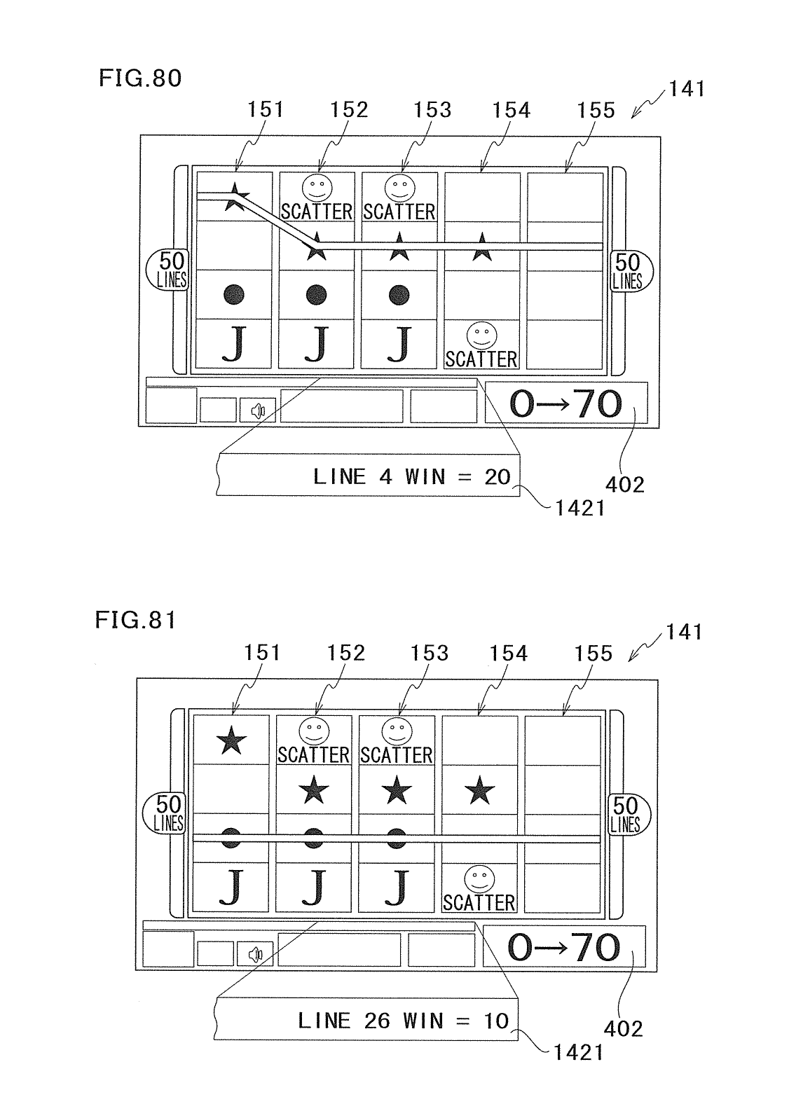

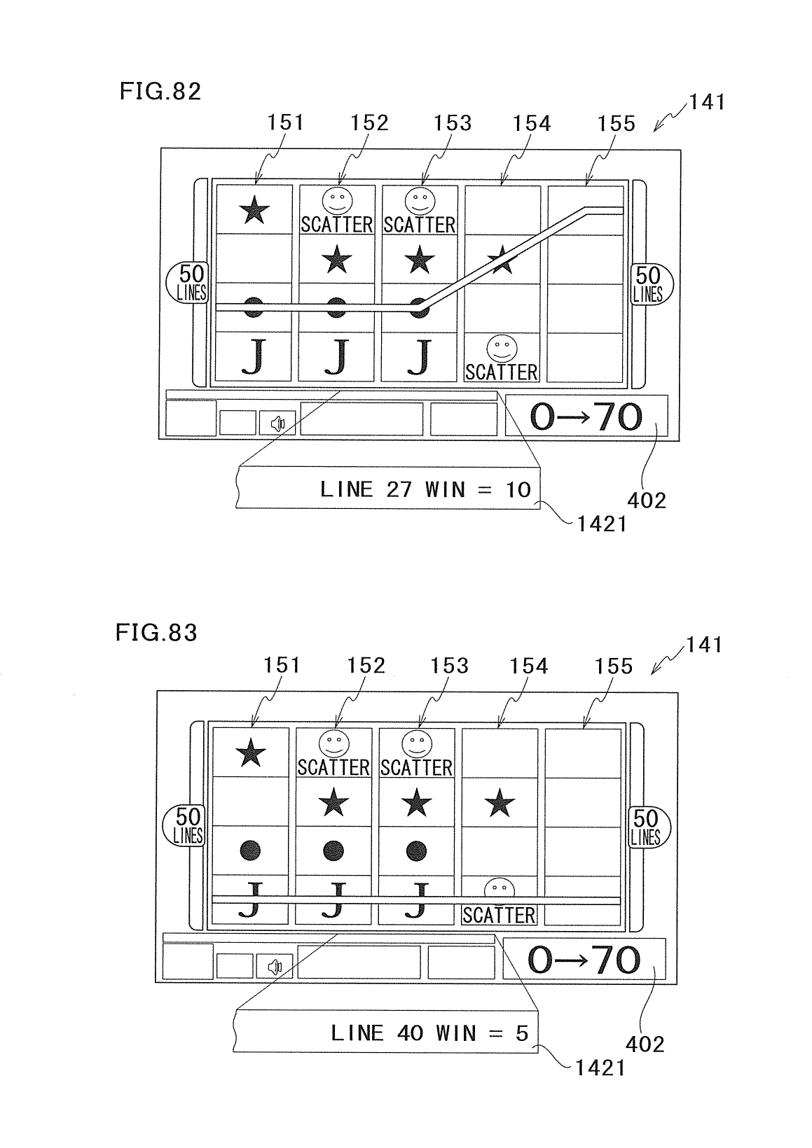

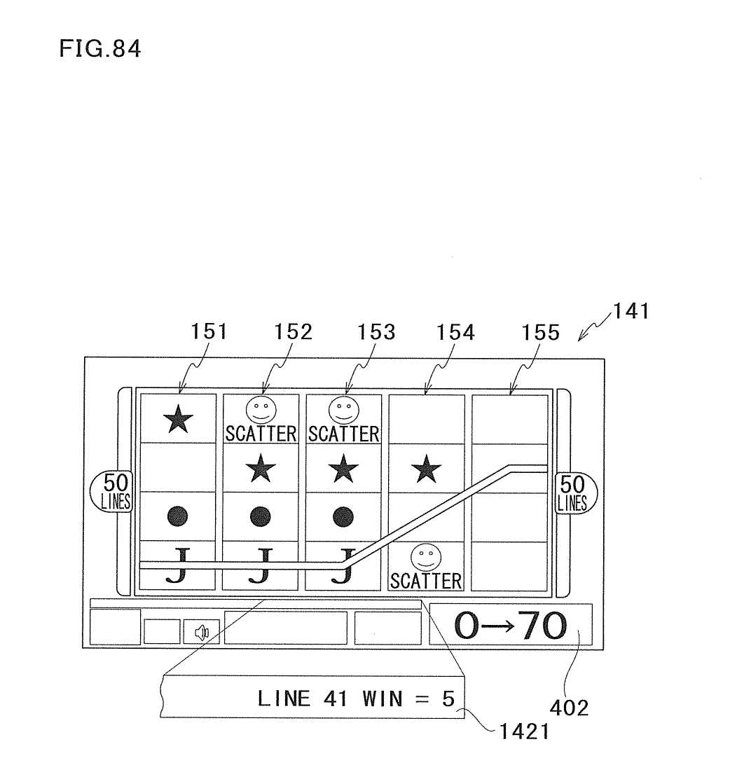

As shown in FIG. 78, when all the reels stop in the lower image display panel 141, the win signboard 134 displayed on the upper image display panel 131 indicates a value incremented by the credit won, as shown in FIG. 79. The win signboard 134 is linked to the win meter 402 on the lower image display panel 141. On the lower image display panel 141, the achieved win is emphasized first at the scatter symbol (see FIG. 79) and then on the symbols serially from a symbol having the smallest line number to a symbol having the largest line number. Specifically, the details of the win by the scatter symbol is indicated in the game message display area 1421 such as “SCATTER WIN=20”, as shown in FIG. 79. Then, the win effect of displaying the paylines in the ascending order of the line numbers is executed as shown in FIG. 80 to FIG. 84. In the effect of line win, the detail of the win is indicated in the game message display area 1421, in the form of text reading, for example, “LINE 4 WIN=20”.

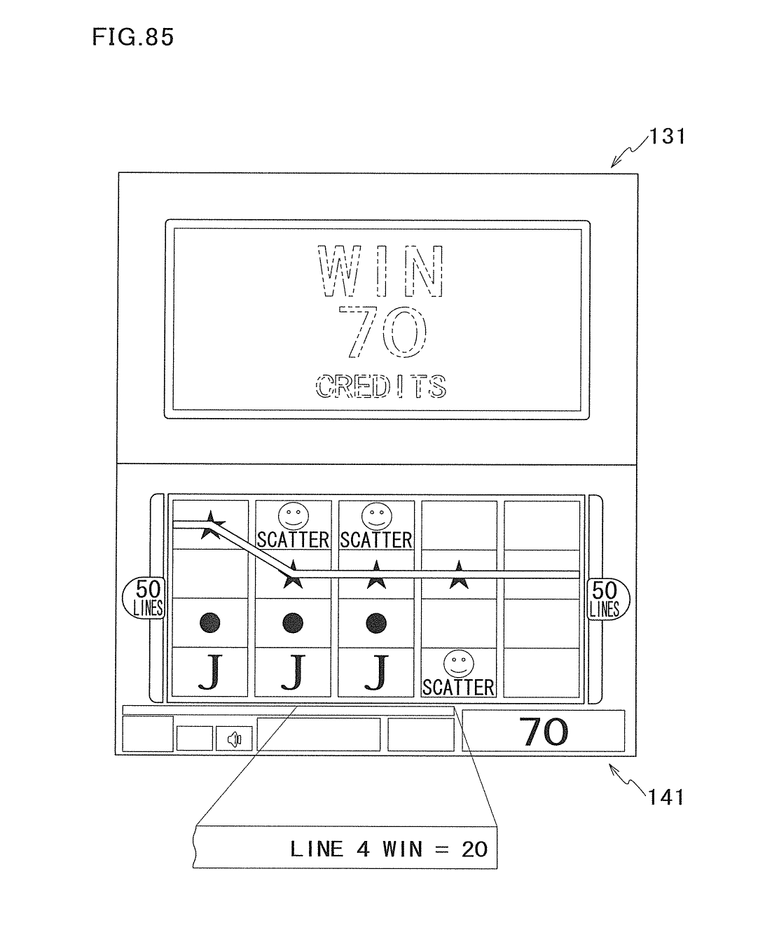

Then, as shown in FIG. 85, the win signboard 134 on the upper image display panel 131 is hidden. The lower image display panel 141 continues the effect in which the achieved win is emphasized first at the scatter symbol (see FIG. 79) and then on the symbols serially from a symbol having the smallest line number to a symbol having the largest line number, and the increment in the win meter 402 is stopped.

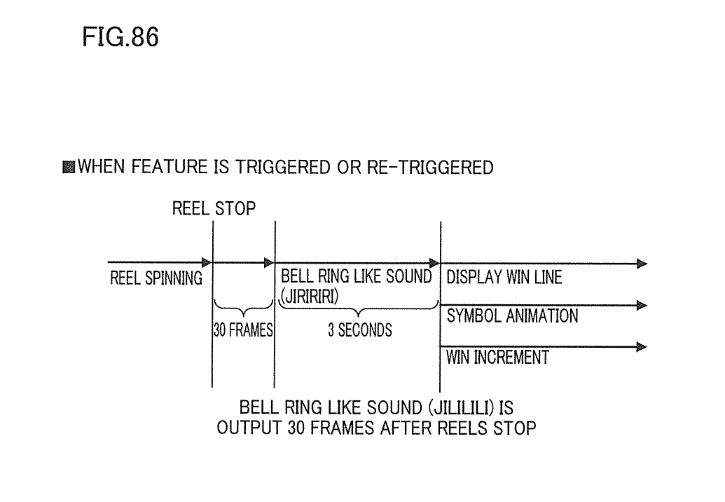

When three feature symbols appear, “Jilililili” sound (bell-ring like sound) is reproduced as a sound effect. As shown in FIG. 86, the reproduction of the sound is continued for three seconds after the stop of all reels and until the increment starts after the time for 30 frames elapses. While the “Jilililili” sound (bell-ring like sound) is reproduced, the symbol animation and the line win are displayed. The increment is stopped. In the free game, dedicated “Jilililili” sound (bell-ring like sound) is reproduced when two feature symbols successively appear from the first reel. Each time the retrigger is carried out, the process is on hold for 30 frames and “Jilililili” sound (bell-ring like sound) is reproduced.

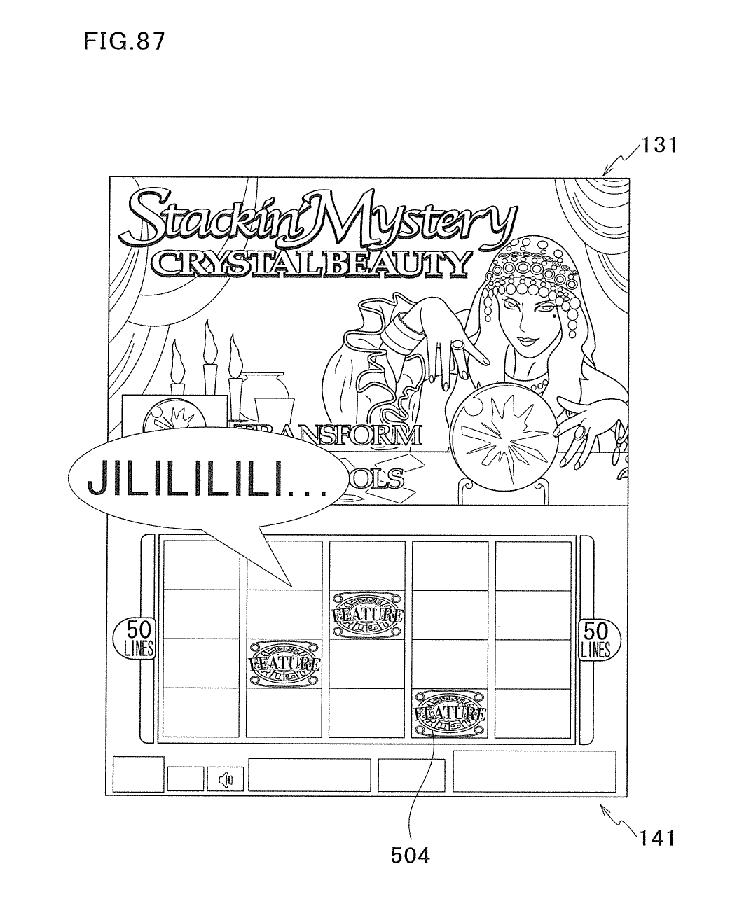

More specifically, as shown in FIG. 35, when all the reels stop and the trigger symbol 504 is rearranged, the waiting time for 30 frames occurs as shown in FIG. 35. Thereafter, the “bleep sound” is reproduced as shown in FIG. 87. The process proceeds to the next step after 3 seconds elapse. Then, the effect is performed as in the win effect described above.

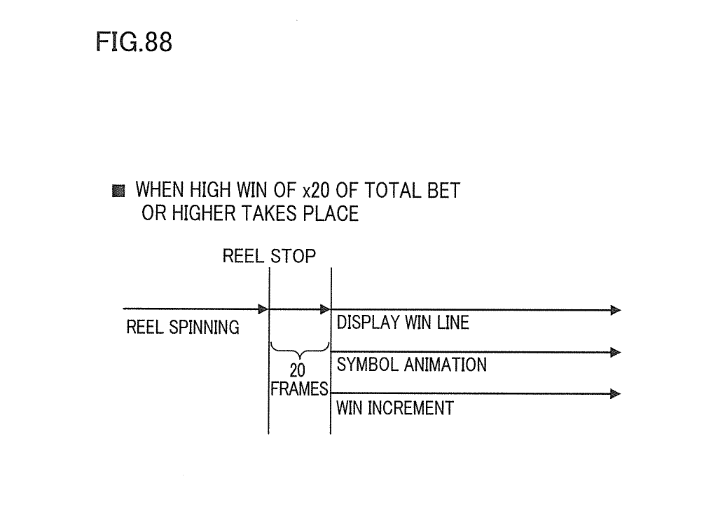

As shown in FIG. 88, when expensive WIN which is more than 20 times as large as the total bet occurs, the data between the reel stop and the start of the increment is arranged to be blank for 20 frames. Then there is a transition to the win effect. However, when the feature-in occurs at the same time, the effect by the feature-in is preferentially performed as shown in FIG. 86.

(Win Signboard)

After the end of the normal game or the free game, a total obtained credit is displayed on the upper image display panel 131. In accordance with the obtained credit (i.e., how many times as large as the total bet), one of three types of effects is used.

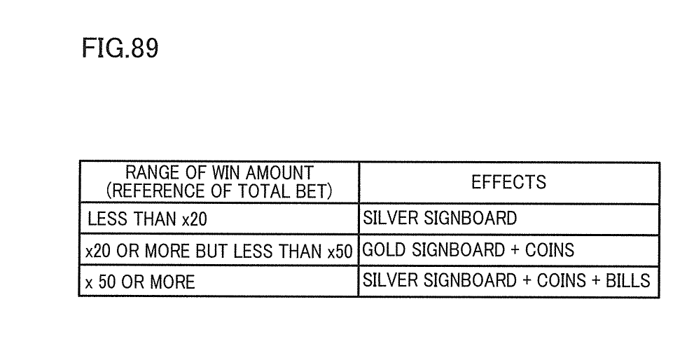

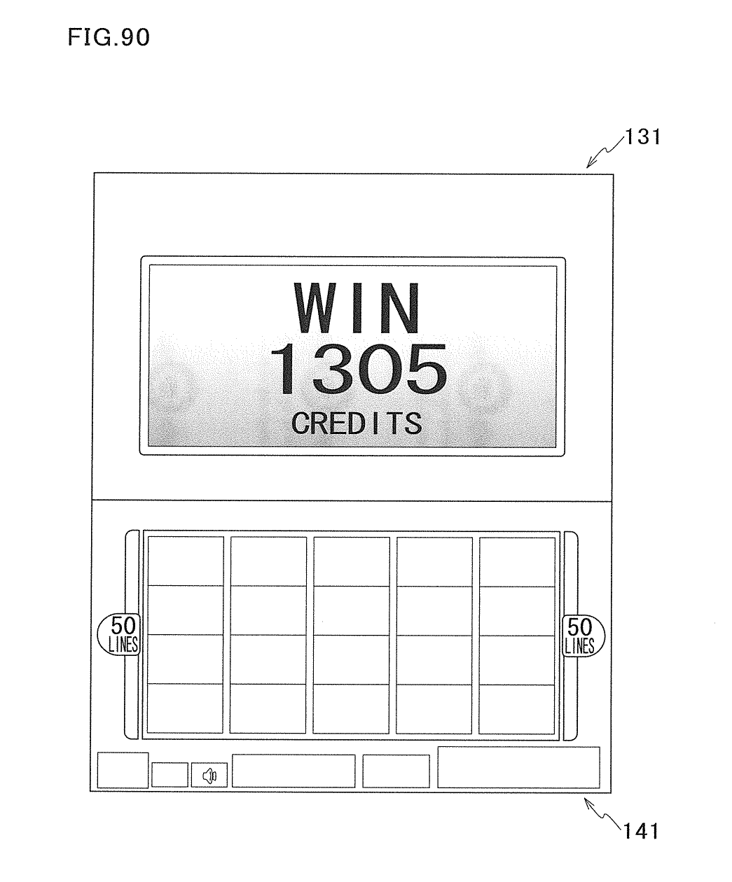

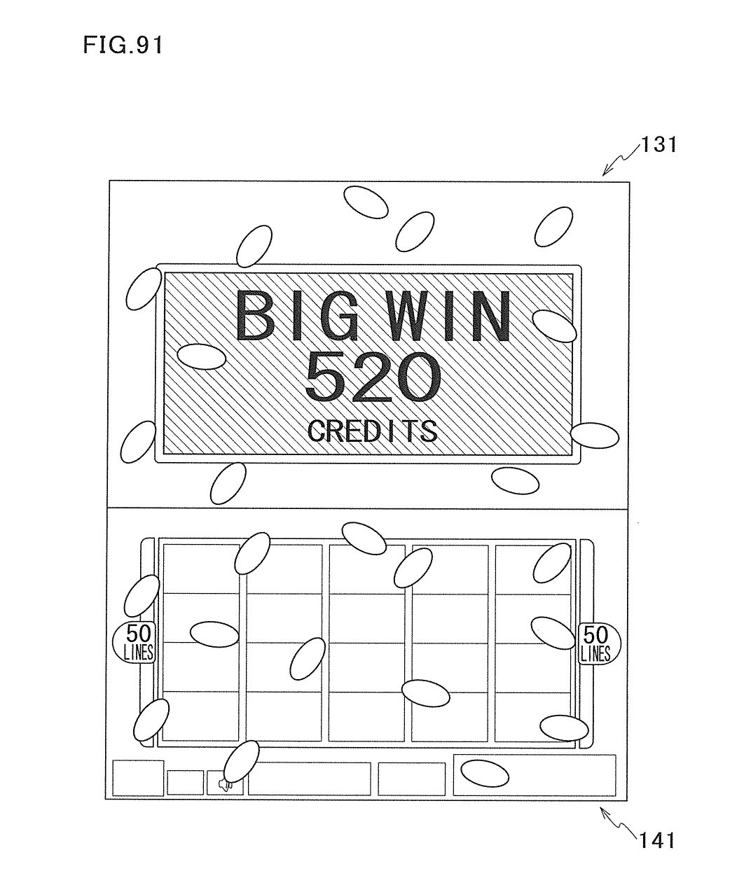

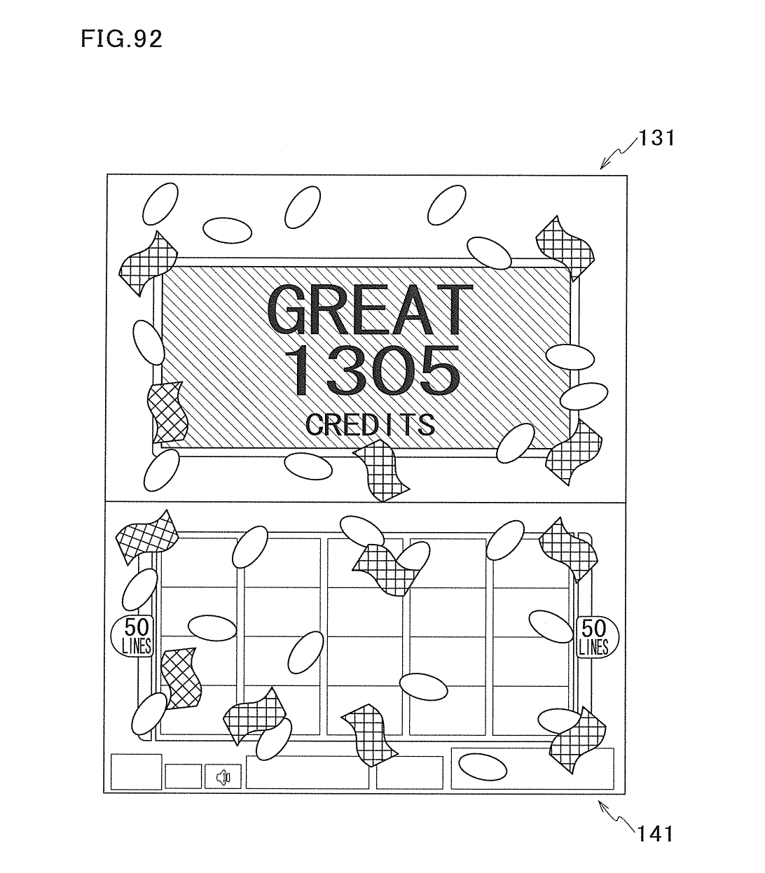

To be more specific, as shown in FIG. 89, the relationship between the obtained credit and the effect is as below. When the total obtained credit is less than ×20 of the total bet, the Silver Signboard is displayed on the upper image display panel 131 and the lower image display panel 141 as shown in FIG. 90. When the total obtained credit is ×20 or more but less than ×50 of the total bet, the Gold Signboard+Coins are displayed on the upper image display panel 131 and the lower image display panel 141 as shown in FIG. 91. When the total obtained credit is ×50 or more of the total bet, the Gold Signboard+Coins are displayed on the upper image display panel 131 and the lower image display panel 141 as shown in FIG. 91, followed by displaying of the Gold Signboard+Coins+Bills, as shown in FIG. 92.

(Total Win Effect of Free Game)

After the end of all the free games, the total credit amount won in the free game is indicated on the lower image display panel 141, and an effect is performed on the upper image display panel 131 and the lower image display panel 141. In accordance with the obtained credit (i.e., how many times as large as the total bet), one of three types of effects is used.

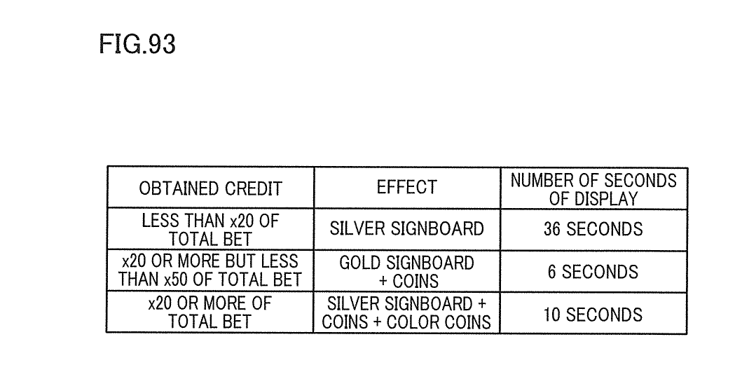

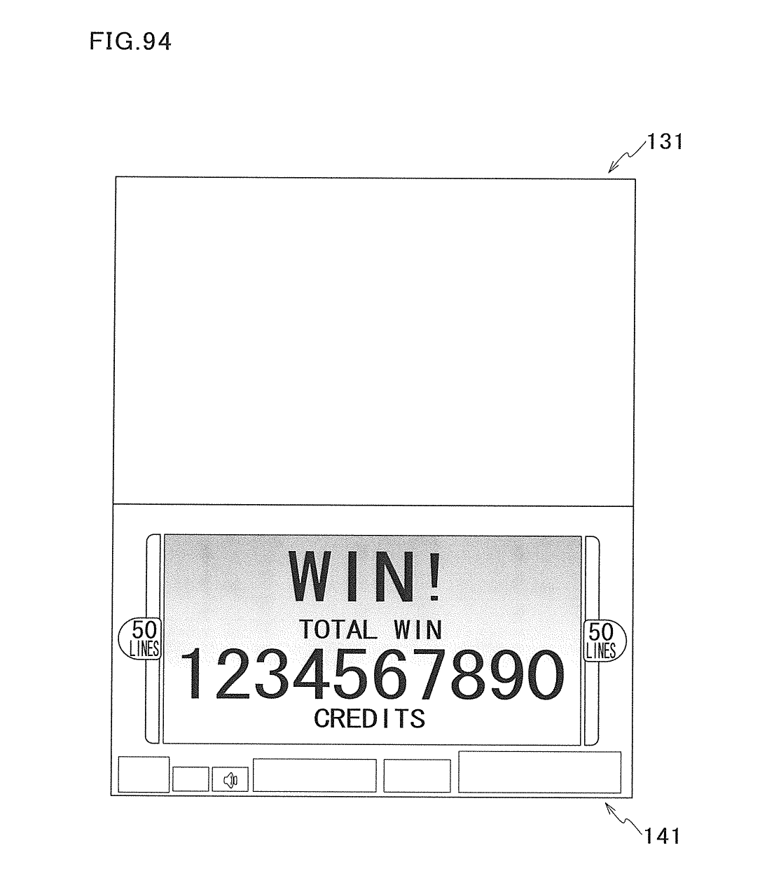

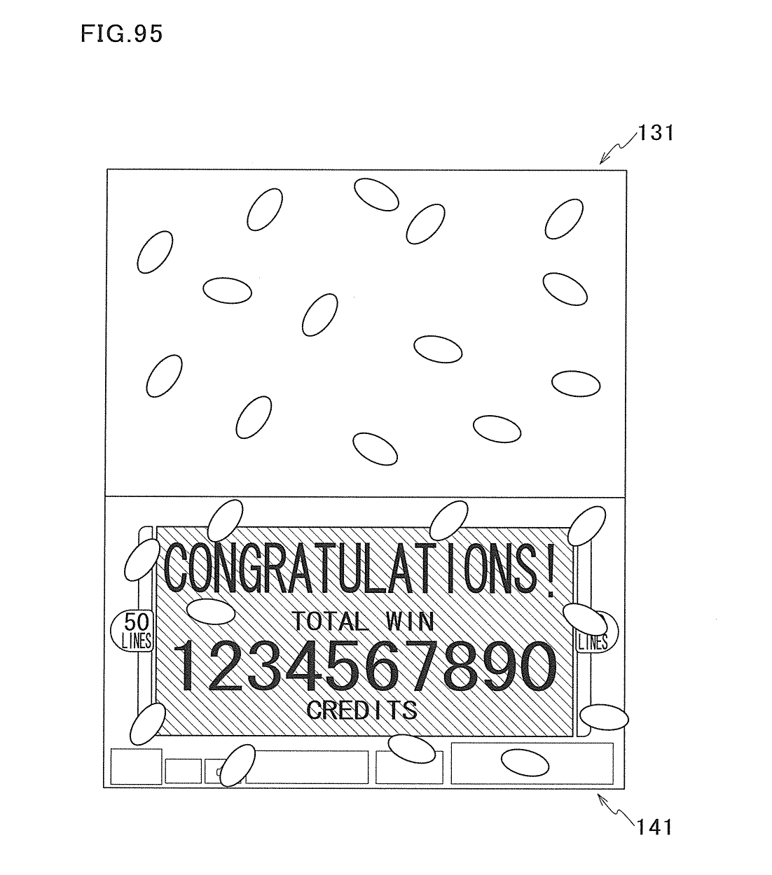

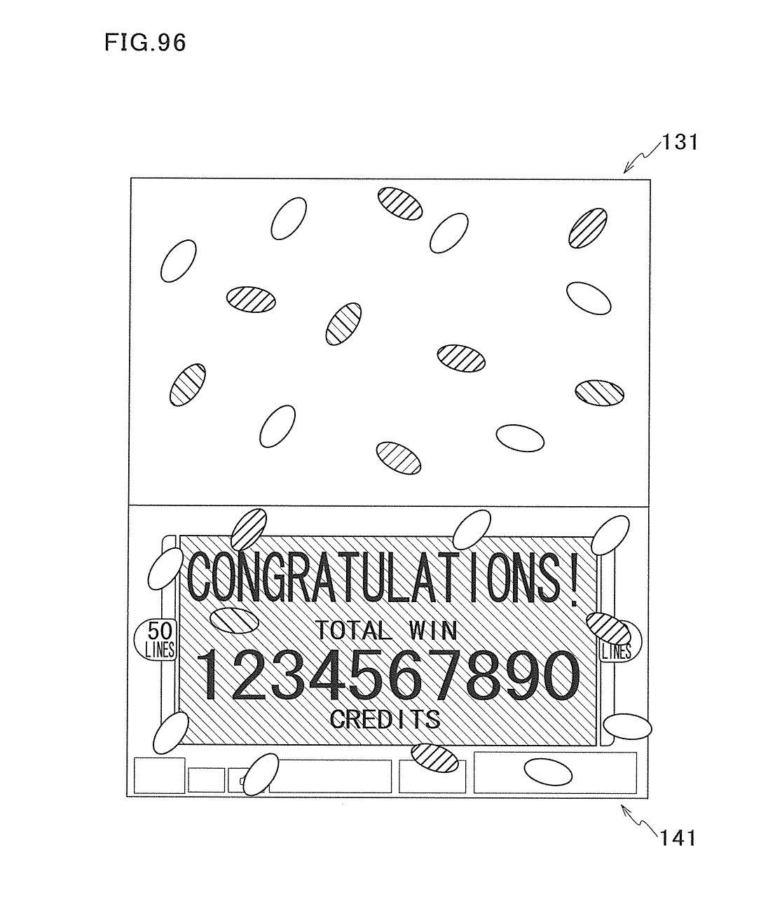

Specifically, as shown in FIG. 93, the relationship between the obtained credit, the effect, and display seconds is as below. When the total obtained credit is less than ×20 of the total bet, the Silver Signboard is displayed on the upper image display panel 131 and the lower image display panel 141 for 3.6 seconds as shown in FIG. 94. When the total obtained credit is ×20 or more but less than ×50 of the total bet, the Gold Signboard+Coins are displayed on the upper image display panel 131 and the lower image display panel 141 for 6 seconds, as shown in FIG. 95. When the total obtained credit is ×50 or more of the total bet, the Gold Signboard+Coins+Color Coins are displayed on the upper image display panel 131 and the lower image display panel 141 for 10 seconds, as shown in FIG. 96.

(Win Effect: Increment Speed and Win Sound)

The increment speed and win sound are arranged such that, 24 ranks of win are identified, and the increment speed and the win sound are set for each rank.

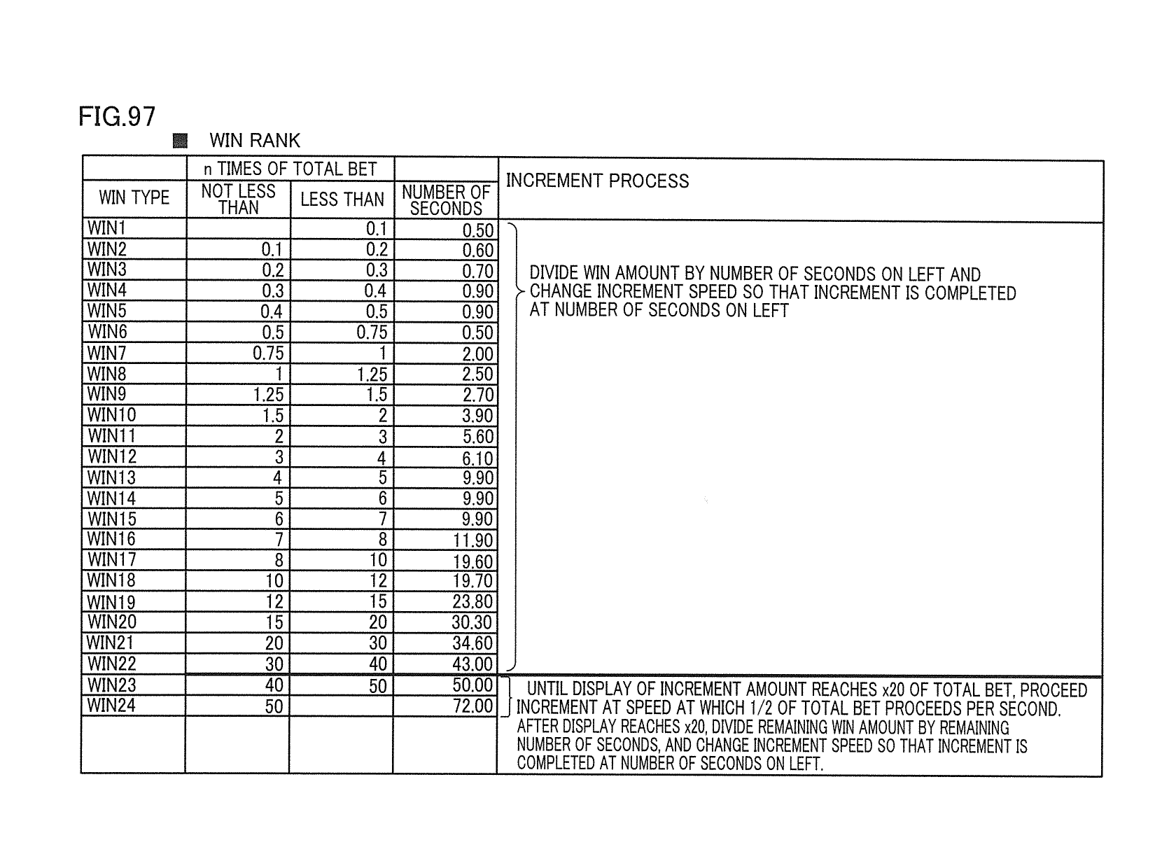

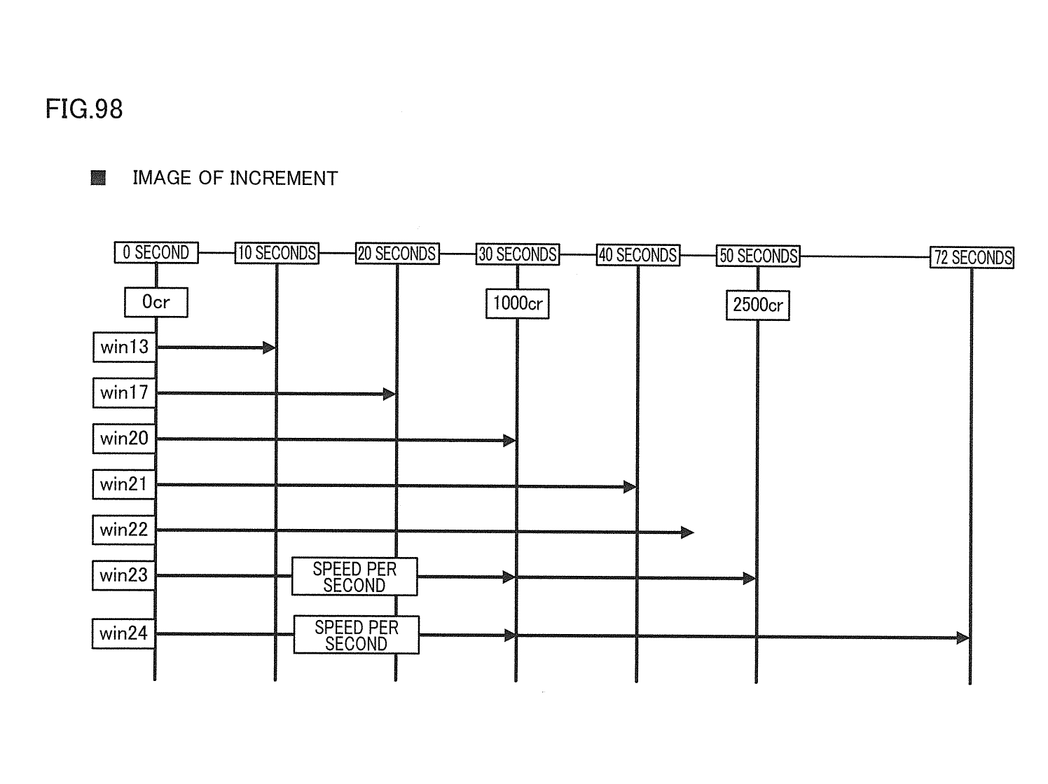

More specifically, as shown in FIG. 97, a win rank is a relationship between a win type and an increment process. In “WIN 1” to “WIN 22”, a win amount is divided by the number of seconds, and the increment speed is adjusted so that the increment is completed at that number of seconds. In “WIN 23” to “WIN 24”, the increment proceeds at a speed at which ½ of the total bet proceeds per second, until the display of the increment amount reaches 20 times as large as the total bet. After 20 times the total bet, the remaining WIN amount is divided by the remaining number of seconds, and the increment speed is adjusted so that the increment is completed at that number of seconds. Therefore, the increment is executed as shown in FIG. 98, for example.

(Control Panel)

As shown in FIG. 63A to FIG. 63C, a plurality of patterns are adoptable for the control panel 30. In the following, each pattern and an example operation are specifically described. Note that the hatched buttons may be omitted or be constantly inactive. Note further that the expression “turned off” in the following description means that the button is not lighted or switched from the on state to the off state. Further that the expression “turned on” in the following description means that the button is lighted or switched from the off state to the on state. The “active” means that the button functions, when pressed. The “inactive” means that the button does not function, even when it is pressed. “Increment Skip” means to skip the process of incrementing the value of the win meter 402. “Take Win” means to add the value of the win meter 402 to that of the credit meter 400, without the increment in the win effect.

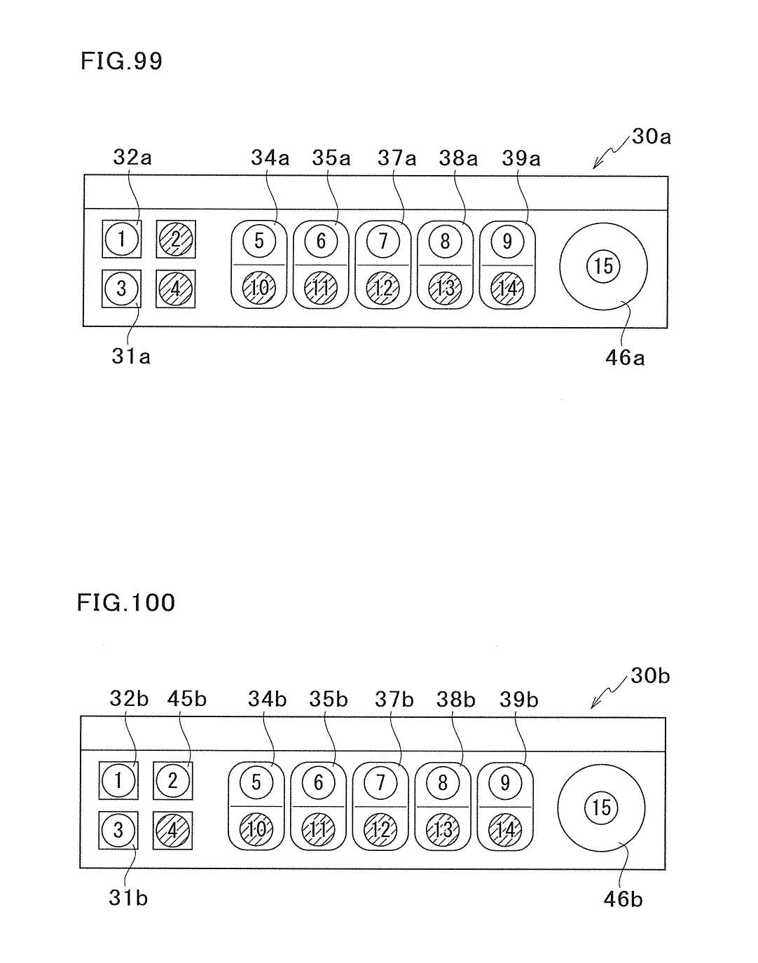

FIG. 99 shows a control panel 30a used in a game with fixed paylines, in which gamble is in the off state. The control panel 30a includes: a take-win/cash-out button 32a, a service button 31a, bet buttons 34a, 35a, 37a, 38a, and 39a, and a repeat bet button 46a. The actions of the buttons in different states.

The take-win/cash-out button 32a is a button for carrying out the take-win and paying out the credit. The service button 31a is a button for calling an attendant. The bet buttons 34a, 35a, 37a, 38a, and 39a are buttons for selecting the bet and starting the game. The repeat bet button 46a is a button for starting the game, with the current setting of the bet selection and the line selection.

At the time of booting and clearing the RAM, the service button 31a is turned off and is active. Operating this button turns on itself, and further turns on the lamp 111 of the slot machine 10. The other buttons are turned off and inactive.

During advertisement (demonstration), the take-win/cash-out button 32a, the bet buttons 34a, 35a, 37a, 38a, and 39a, and a repeat bet button 46a are turned off and inactive. The service button 31a is turned off and active. The service button 31a turns on when operated, and further turns on the lamp 111 of the slot machine 10, and ends the advertisement.

During the idling state after the RAM clearance and an initial amount of money is entered, the take-win/cash-out button 32a is turned on and active, and performs cash-out upon being operated. The service button 31a is turned off and is active. Operating this button turns on itself, and further turns on the lamp 111 of the slot machine 10. The bet buttons 34a, 35a, 37a, 38a, and 39a are turned on and active, if the game can be started with the current credit. The buttons start spinning upon operation. The repeat bet button 46a is turned off and inactive.

During the idling state with the game already started and no credit, the take-win/cash-out button 32a, the bet buttons 34a, 35a, 37a, 38a, and 39a, and a repeat bet button 46a are turned off and inactive. The service button 31a is turned off and is active. Operating this button turns on itself, and further turns on the lamp 111 of the slot machine 10.

During the idling state with the game already started and there is credit, the take-win/cash-out button 32a is turned on and active, and performs cash-out when operated. The service button 31a is turned off and is active. Operating this button turns on itself, and further turns on the lamp 111 of the slot machine 10. The bet buttons 34a, 35a, 37a, 38a, and 39a and the repeat bet button 46a are turned on and active, if the game can be started with the current credit. The buttons start spinning upon operation.

While the game rule screen (help screen) is displayed, the take-win/cash-out button 32a, and the bet buttons 35a, 37a, and 38a are turned off and inactive. The service button 31a is turned off and is active. Operating this button turns on itself, and further turns on the lamp 111 of the slot machine 10. The bet button 34a is turned on and active, and switches the page to the previous page when operated. The bet button 39a is turned on and active, and switches the page to the next page when operated. The repeat bet button 46a is turned off and inactive, and exits from the game rule screen when pressed.

When an error takes place, all the buttons are turned off and inactive. After recovery from the error, the service button 31a returns to the state before the error after 120 seconds. The other buttons return to the states before the error. After power interruption, all the buttons return to the state before the power interruption.

While the reels are spinning in the normal game or the free game, the take-win/cash-out button 32a and the bet buttons 34a, 35a, 37a, 38a, and 39a are turned off and inactive. The service button 31a is turned off and is active. Operating this button turns on itself, and further turns on the lamp 111 of the slot machine 10. Only if the slot machine 10 supports a quick stopping function, the repeat bet button 46a is turned on and active, and quick-stops the reels when operated.

During the win increment in the normal game, the take-win/cash-out button 32a and the bet buttons 34a, 35a, 37a, 38a, and 39a are turned off and active, and operating any of these buttons leads to the take-win and game over. The service button 31a is turned off and is active. Operating this button turns on itself, and further turns on the lamp 111 of the slot machine 10. The repeat bet button 46a is turned off and active. If the next game is possible with the current setting of bet, pressing this button will lead to take-win and starts the spinning.

During the increment of a big win, great win, an exclusive win in the normal game, the take-win/cash-out button 32a and the bet buttons 34a, 35a, 37a, 38a, and 39a, and the repeat bet button 46a are turned off and active, and operating any of these buttons leads to the take-win and game over. The service button 31a is turned off and is active. Operating this button turns on itself, and further turns on the lamp 111 of the slot machine 10.

During the win increment in the free game, the take-win/cash-out button 32a and the bet buttons 34a, 35a, 37a, 38a, and 39a, and the repeat bet button 46a are turned on and active, and operating any of these buttons proceeds to next, skipping the increment. The service button 31a is turned off and is active. Operating this button turns on itself, and further turns on the lamp 111 of the slot machine 10.

During the increment in relation to the payout by the trigger symbols 504, the service button 31a is turned off and is active. Operating this button turns on itself, and further turns on the lamp 111 of the slot machine 10. The other buttons are turned on and active, and pressing any of them will proceed to the next, skipping the increment.

While a video effect that can be skipped is performed, the take-win/cash-out button 32a and the bet buttons 34a, 35a, 37a, 38a, and 39a are turned off and inactive. The service button 31a is turned off and is active. Operating this button turns on itself, and further turns on the lamp 111 of the slot machine 10. The repeat bet button 46a is turned on and active, and skips the video effect when operated.

While the total win screen is displayed in the feature game, the take-win/cash-out button 32a and the bet buttons 34a, 35a, 37a, 38a, and 39a are turned off and inactive. The service button 31a is turned off and is active. Operating this button turns on itself, and further turns on the lamp 111 of the slot machine 10. The repeat bet button 46a turns on and active 4 seconds after the displaying of the screen is started, and skips the screen (skips the increment if increment is taking place) when operated.

During a big type feature game, the take-win/cash-out button 32a is turned off and is inactive. The service button 31a is turned off and is active. Operating this button turns on itself, and further turns on the lamp 111 of the slot machine 10. The bet buttons 34a, 35a, 37a, 38a, and 39a are turned on and active, if they are buttons to be subjected, and direct selection and cursor movement are enabled. The repeat bet button 46a is turned on and active if it is a cursor move type, and determines the selection.

When a “XXXX” button is pressed, the take-win/cash-out button 32a is turned off and inactive. The service button 31a is turned off and is active. Operating this button turns on itself, and further turns on the lamp 111 of the slot machine 10. The bet buttons 34a, 35a, 37a, 38a, and 39a and the repeat bet button 46a are turned on and active, if they are buttons displayed. Operating these buttons will proceed to the next.

FIG. 100 shows a control panel 30b used in a game with fixed paylines, in which gamble is in the on state. The control panel 30b includes: a take-win/cash-out button 32b, a gamble button 45b, a service button 31b, bet buttons 34b, 35b, 37b, 38b, and 39b, and a repeat bet button 46b.

The take-win/cash-out button 32b is a button for carrying out the take-win and paying out the credit. The gamble button 45b is a button for transition to the gamble screen. The service button 31b is a button for calling an attendant. The bet buttons 34b, 35b, 37b, 38b, and 39b are buttons for selecting the bet and starting the game. The repeat bet button 46b is a button for starting the game, with the current setting of the bet selection and the line selection. The actions of the buttons in different states. It should be noted that the actions of various buttons described in relation to the control panel 30a are the same as those in the control panel 30b, and therefore descriptions of these buttons are omitted.

The gamble button 45b is turned off and inactive, except for the following states. Specifically, after recovery from an error, the gamble button 45b returns to the state before the error. After recovery from a power interruption, the gamble button 45b returns to the state before the power interruption. During the win increment in the normal game, the gamble button 45b is turned on and active. Operating this button leads to transition to gamble. During “PLAY ON, GAMBLE or TAKE WIN” state after win increment, the gamble button 45b is turned on and active. Operating this button leads to transition to gamble.

While the gamble screen is displayed, the take-win/cash-out button 32a and the repeat bet button 46d are turned on and active, and operating any of these buttons leads to the take-win and game over. The gamble button 45b is turned off and inactive. The service button 31b is turned off and is active. Operating this button turns on itself, and further turns on the lamp 111 of the slot machine 10. The bet buttons 34b, 35b, 37b, 38b, and 39b are turned off and inactive.

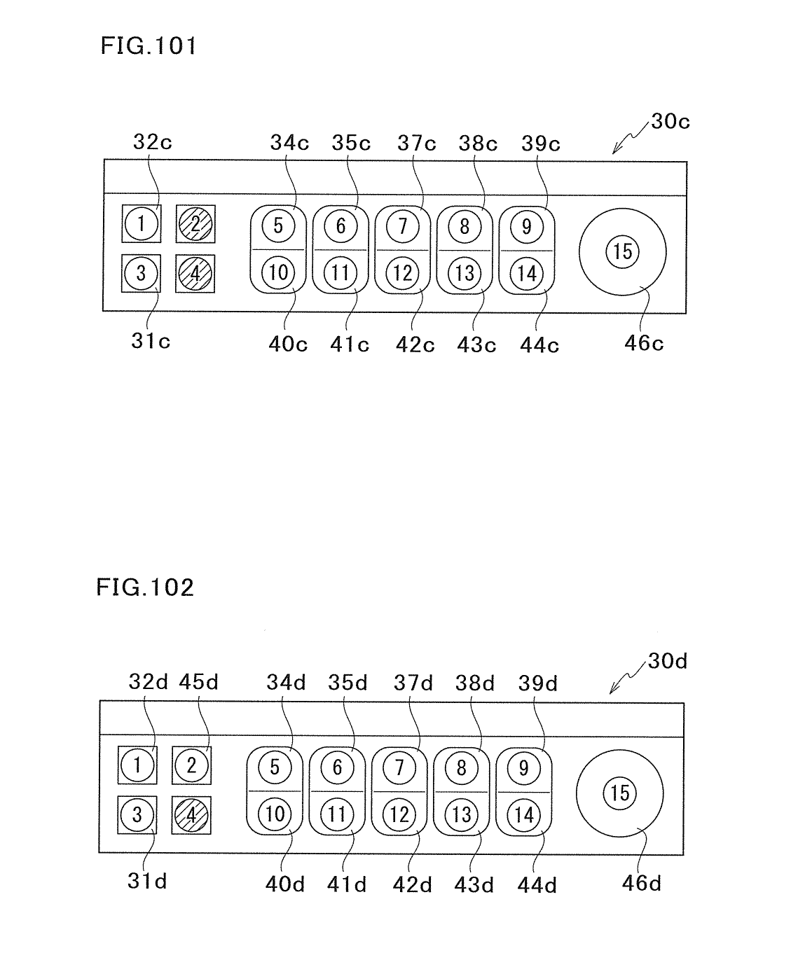

FIG. 101 shows a control panel 30c used in a game with selectable paylines, in which gamble is in the off state. The control panel 30b includes: a take-win/cash-out button 32c, a service button 31c, bet buttons 34c, 35c, 37c, 38c, and 39c, play line buttons 40c, 41c, 42c, 43c, and 44c, and a repeat bet button 46b. The actions of the buttons in different states.

The take-win/cash-out button 32c is a button for carrying out the take-win and paying out the credit. The service button 31c is a button for calling an attendant. The bet buttons 34b, 35b, 37b, 38b, and 39b are buttons for selecting the amount of bet per line and starting the game. The play line buttons 40c, 41c, 42c, 43c, and 44c are buttons for selecting the number of lines and starting the game. The repeat bet button 46c is used for starting the game with the setting of the current bet amount and the number of lines.

At the time of booting and clearing the RAM, the service button 31c is turned off and is active. Operating this button turns on itself, and further turns on the lamp 111 of the slot machine 10. The other buttons are turned off and inactive.

During advertisement (demonstration), the service button 31c is turned off and is active. Operating this button turns on itself, and further turns on the lamp 111 of the slot machine 10. The other buttons are turned off and inactive.

During the idling state after the RAM clearance and an initial amount of money is entered, the take-win/cash-out button 32c is turned on and active, and performs cash-out upon being operated. The service button 31c is turned off and is active. Operating this button turns on itself, and further turns on the lamp 111 of the slot machine 10. The bet buttons 34c, 35c, 37c, 38c, and 39c are turned on and active, if the game can be started with the current credit. Operating any of these buttons will turn off the rest of the other bet buttons. The play line buttons 40c, 41c, 42c, 43c, and 44c are turned on and active, if the game can be started with the current credit. Any of these buttons starts spinning upon operation. The repeat bet button 46c is turned off and inactive.

During the idling state with the game already started and no credit, the service button 31c is turned off and is active. Operating this button turns on itself, and further turns on the lamp 111 of the slot machine 10. The other buttons are turned off and inactive.

During the idling state with the game already started and there is credit, the take-win/cash-out button 32c is turned on and active, and performs cash-out when operated. The service button 31c is turned off and is active. Operating this button turns on itself, and further turns on the lamp 111 of the slot machine 10. The bet buttons 34c, 35c, 37c, 38c, and 39c are turned on and active, if the game can be started with the current credit. Operating any of these buttons will turn off the rest of the other bet buttons. The play line buttons 40c, 41c, 42c, 43c, and 44c and the repeat bet button 46c are turned on and active, if the game can be started with the current credit. Any of these buttons starts spinning upon operation.

While the game rule screen (help screen) is displayed, the take-win/cash-out button 32c, the bet buttons 35c, 37c, and 38c, and the play line button 40c, 41, 42c, 43c, and 44c are turned off and inactive. The service button 31c is turned off and is active. Operating this button turns on itself, and further turns on the lamp 111 of the slot machine 10. The bet button 34c is turned on and active, and switches the page to the previous page when operated. The bet button 39c is turned on and active, and switches the page to the next page when operated. The repeat bet button 46c is turned on and active, and exits from the game rule screen when pressed.

When an error takes place, all the buttons are turned off and inactive. After recovery from the error, the service button 31c returns to the state before the error after 120 seconds. The other buttons return to the states before the error. After power interruption, all the buttons return to the state before the power interruption.

While the reels are spinning in the normal game or the free game, the take-win/cash-out button 32c, the bet buttons 34c, 35c, 37c, 38c, and 39c, and the play line buttons 40c, 41c, 42c, 43c, and 44c are turned off and inactive. The service button 31c is turned off and is active. Operating this button turns on itself, and further turns on the lamp 111 of the slot machine 10. Only if the slot machine 10 supports a quick stopping function, the repeat bet button 46c is turned on and active, and quick-stops the reels when operated.

During the win increment in the normal game, the take-win/cash-out button 32c, the bet buttons 34a, 35a, 37a, 38a, and 39a, and the play line buttons 40c, 41c, 42c, 43c, and 44c are turned off and active, and operating any of these buttons leads to the take-win and game over. The service button 31c is turned off and is active. Operating this button turns on itself, and further turns on the lamp 111 of the slot machine 10. The repeat bet button 46c is turned off and active. If the next game is possible with the current setting of bet, pressing this button will lead to take-win and starts the spinning.

During the increment of a big win, great win, an exclusive win in the normal game, the take-win/cash-out button 32c, the bet buttons 34c, 35c, 37c, 38c, and 39c, and the play line buttons 40c, 41c, 42c, 43c, and 44c are turned off and active, and operating any of these buttons leads to the take-win and game over. The service button 31c is turned off and is active. Operating this button turns on itself, and further turns on the lamp 111 of the slot machine 10. The repeat bet button 46c is turned off and active. If the next game is possible with the current setting of bet, operating this button will lead to take-win and starts the spinning.

During the win increment in the free game, the take-win/cash-out button 32c, the bet buttons 34c, 35c, 37c, 38c, and 39c, the play line buttons 40c, 41c, 42c, 43c, and 44c, and the repeat bet button 46a are turned on and active, and operating any of these buttons proceeds to next, skipping the increment. The service button 31c is turned off and is active. Operating this button turns on itself, and further turns on the lamp 111 of the slot machine 10.

During the increment in relation to the payout by the trigger symbols 504, the service button 31c is turned off and is active. Operating this button turns on itself, and further turns on the lamp 111 of the slot machine 10. The other buttons are turned on and active, and pressing any of them will proceed to the next, skipping the increment.

While a video effect that can be skipped is performed, the take-win/cash-out button 32c, the bet buttons 34c, 35c, 37c, 38c, and 39c, and the play line buttons 40c, 41c, 42c, 43c, and 44c are turned off and inactive. The service button 31c is turned off and is active. Operating this button turns on itself, and further turns on the lamp 111 of the slot machine 10. The repeat bet button 46c is turned on and active, and skips the video effect when operated.

While the total win screen is displayed in the feature game, the take-win/cash-out button 32, the bet buttons 34c, 35c, 37c, 38c, and 39c, and the play line buttons 40c, 41c, 42c, 43c, and 44c are turned off and inactive. The service button 31c is turned off and is active. Operating this button turns on itself, and further turns on the lamp 111 of the slot machine 10. The repeat bet button 46c turns on and active 4 seconds after the displaying of the screen is started, and skips the screen (skips the increment if increment is taking place) when operated.

During a big type feature game, the take-win/cash-out button 32c is turned off and is inactive. The service button 31c is turned off and is active. Operating this button turns on itself, and further turns on the lamp 111 of the slot machine 10. The bet buttons 34c, 35c, 37c, 38c, and 39c and the play line buttons 40c, 41c, 42c, 43c, and 44c are turned on and active, if they are buttons to be subjected, and direct selection and cursor movement are enabled. The repeat bet button 46c is turned on and active if it is a cursor move type, and determines the selection.

When a “XXXX” button is pressed, the take-win/cash-out button 32c is turned off and inactive. The service button 31c is turned off and is active. Operating this button turns on itself, and further turns on the lamp 111 of the slot machine 10. The bet buttons 34c, 35c, 37c, 38c, and 39c, the play line buttons 40c, 41c, 42c, 43c, and 44c, and the repeat bet button 46a are turned on and active, if they are buttons displayed. Operating these buttons will proceed to the next.

FIG. 102 shows a control panel 30d used in a game with selectable paylines, in which gamble is in the on state. The control panel 30d includes: a take-win/cash-out button 32d, a gamble button 45d, a service button 31d, bet buttons 34d, 35d, 37d, 38d, and 39d, play line buttons 40d, 41d, 42d, 43d, and 44d, and a repeat bet button 46d.

The take-win/cash-out button 32d is a button for carrying out the take-win and paying out the credit. The gamble button 45d is a button for transition to the gamble screen. The service button 31d is a button for calling an attendant. The bet buttons 34d, 35d, 37d, 38d, and 39d are buttons for selecting the amount of bet per line and starting the game. The play line buttons 40d, 41d, 42d, 43d, and 44d are buttons for selecting the number of lines and starting the game. The repeat bet button 46d is used for starting the game with the setting of the current bet amount and the number of lines. The actions of the buttons in different states. It should be noted that the actions of various buttons described in relation to the control panel 30d are the same as those in the control panel 30d, and therefore descriptions of these buttons are omitted.

The gamble button 45d is turned off and inactive, except for the following states. Specifically, after recovery from an error, the gamble button 45d returns to the state before the error. After recovery from a power interruption, the gamble button 45d returns to the state before the power interruption. During the win increment in the normal game, the gamble button 45d is turned on and active. Operating this button leads to transition to gamble. During “PLAY ON, GAMBLE or TAKE WIN” state after win increment, the gamble button 45d is turned on and active. Operating this button leads to transition to gamble.

While the gamble screen is displayed, the take-win/cash-out button 32d and the repeat bet button 46d are turned on and active, and operating any of these buttons leads to the take-win and game over. The gamble button 45d is turned off and inactive. The service button 31d is turned off and is active. Operating this button turns on itself, and further turns on the lamp 111 of the slot machine 10. The bet buttons 34d, 35d, 37d, 38d, and 39d and the play line buttons 40d, 41d, 42d, 43d, and 44d are turned off and inactive.

(Example Structure of Control Panel)

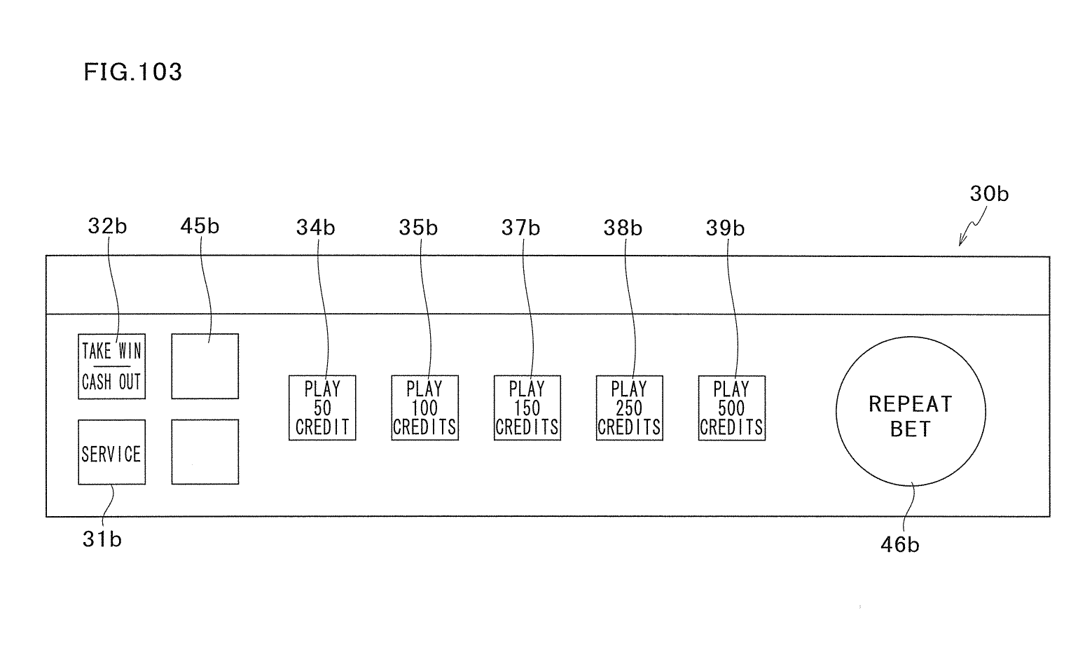

The following describes specifically an example structure of the control panel as described above. For example, when the number of lines is fixed, the control panel shown in FIG. 103 is adopted. FIG. 103 shows the control panel 30b which operates as described with reference to FIG. 100. As shown in FIG. 103, the control panel 30b includes: a take-win/cash-out button 32b, a gamble button 45b, a service button 31b, bet buttons 34b, 35b, 37b, 38b, and 39b, and a repeat bet button 46b. The bet buttons 34b starts a game with a bet of 50 credit. The bet buttons 35b starts a game with a bet of 100 credit. The bet buttons 37b starts a game with a bet of 150 credit. The bet buttons 38b starts a game with a bet of 250 credit. The bet buttons 39b starts a game with a bet of 500 credit. Note that, if the gamble is off, the gamble button 45b is inactive or not provided. Therefore, the control panel 30a has the structure described with reference to FIG. 99.

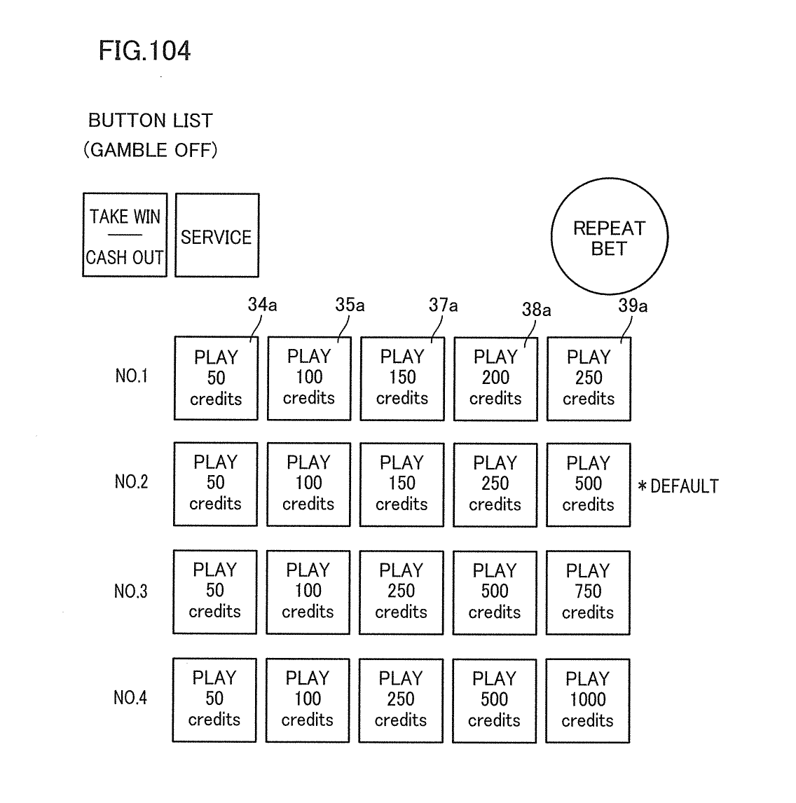

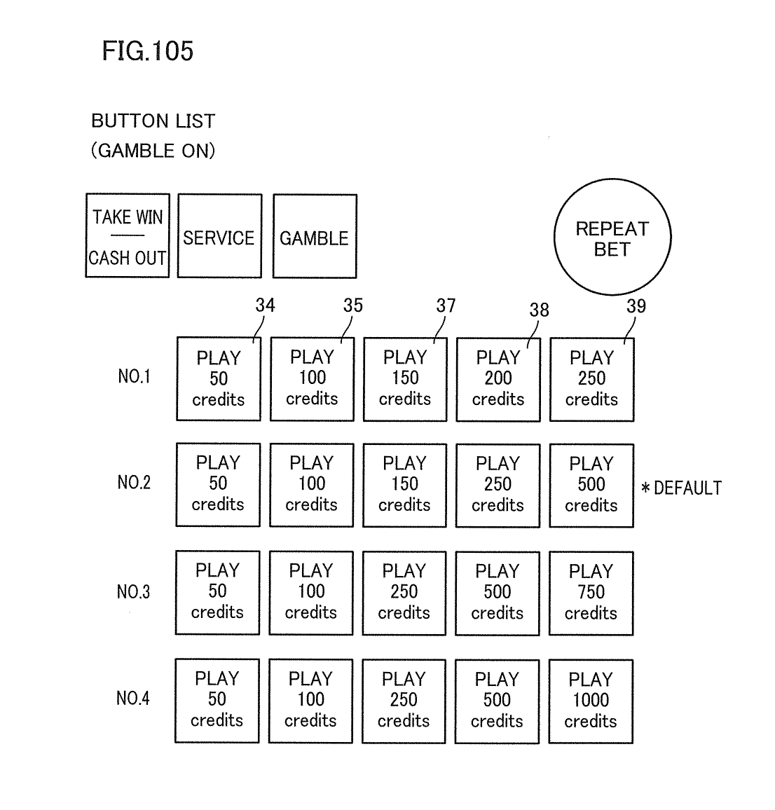

FIG. 104 shows a button list of the above described control panel, with the gamble being off. As shown in FIG. 104, the bet buttons 34a, 35a, 37a, 38a, and 39a are configured so that sets of buttons with different settings of bet amounts are selectively adopted according to the setting of the game. Specifically, it is possible to switch over among: a set of bet buttons whose associated bet amounts are “50”, “100”, “150”, “200”, and “250”; a set of bet buttons whose associated bet amounts are “50”, “100”, “150”, “250”, and “500”; a set of bet buttons whose associated bet amounts are “50”, “100”, “250”, “500”, and “750”; and a set of bet buttons whose associated bet amounts are “50”, “100”, “250”, “500”, and “1000”. FIG. 105 shows a button list of the above described control panel, with the gamble being on. As in the above case, the bet buttons 34b, 35b, 37b, 38b, and 39b are configured so that sets of buttons with different settings of bet amounts are selectively adopted according to the setting of the game.

Further, for example, when the number of lines is selectable, the control panel shown in FIG. 8 is adopted. FIG. 8 shows the control panel 30 which operates as described with reference to FIG. 102. Note that, if the gamble is off, the gamble button 45 is inactive or not provided. Therefore, the control panel 30c has the structure described with reference to FIG. 101.

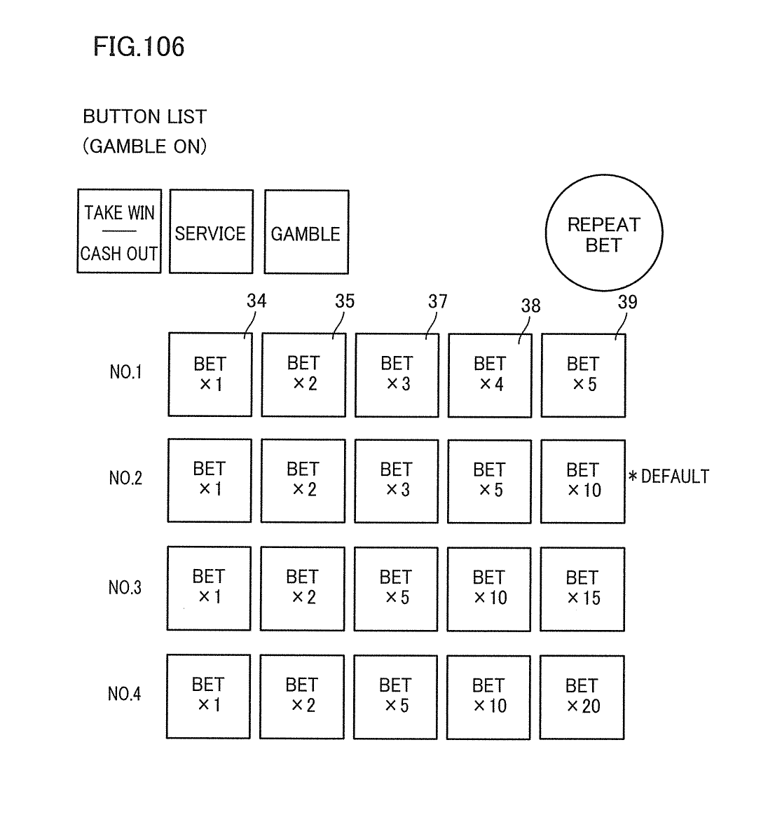

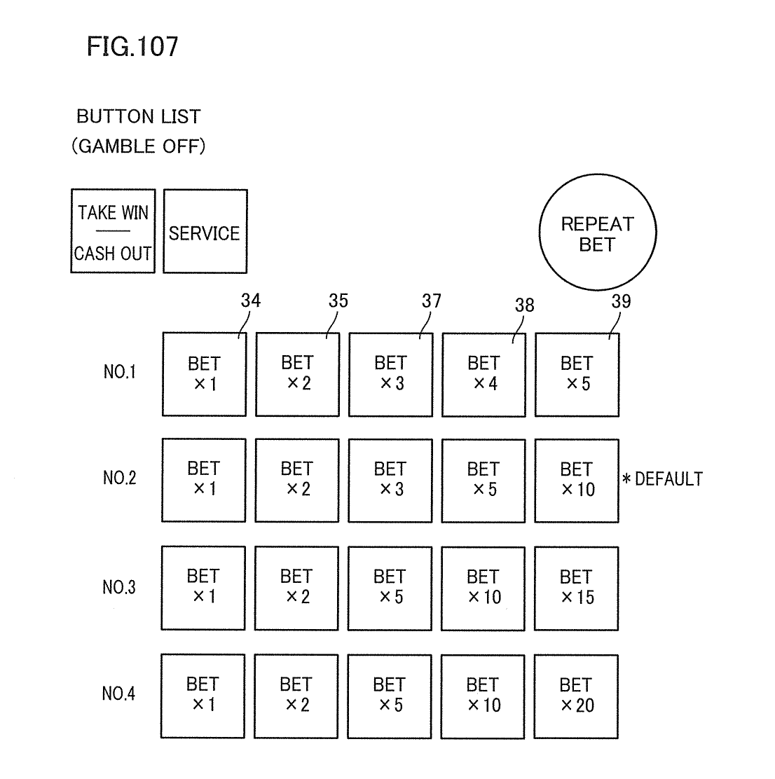

FIG. 106 shows a button list of the above described control panel, with the gamble being off. As shown in FIG. 106, the bet buttons 34, 35, 37, 38, and 39 are configured so that sets of buttons with different settings of bet amounts (per line) are selectively adopted according to the setting of the game. Specifically, it is possible to switch over among: a set of bet buttons whose associated bet amounts per line are “50”, “100”, “150”, “200”, and “250”; a set of bet buttons whose associated bet amounts per line are “50”, “100”, “150”, “250”, and “500”; a set of bet buttons whose associated bet amounts per line are “50”, “100”, “250”, “500”, and “750”; and a set of bet buttons whose associated bet amounts per line are “50”, “100”, “250”, “500”, and “1000”. FIG. 107 shows a button list of the above described control panel, with the gamble being on. As in the above case, the bet buttons 34, 35, 37, 38, and 39 are configured so that sets of buttons with different settings of bet amounts are selectively adopted according to the setting of the game.

(Gamble Game)

The following describes the operation steps of the gamble game. The limit of the value winnable in Gamble is set in the AUDIT. The maximum number of times of Gamble is also set in the AUDIT. For example, the maximum number of times is set at five and the number of times of Gamble is set so as to be five or lower. Whether the touch panel can be used is switchable in some countries.

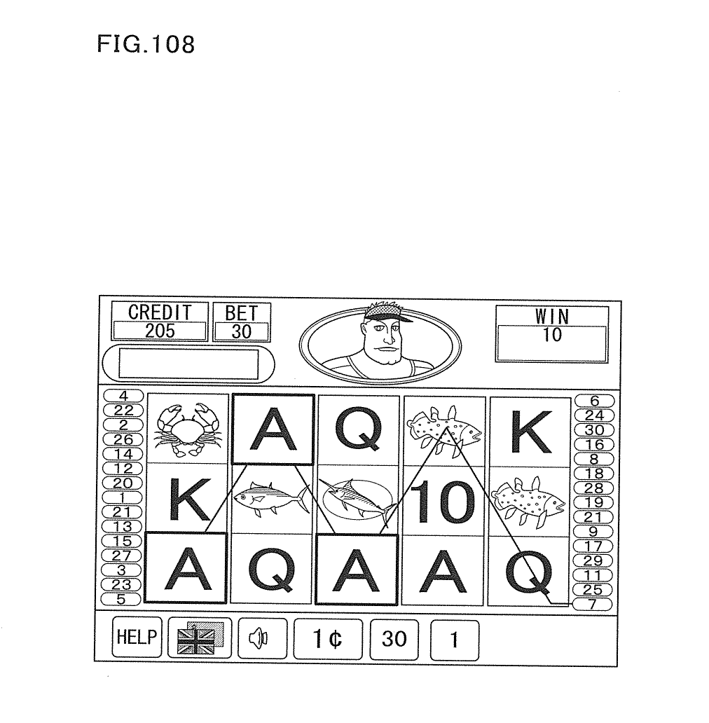

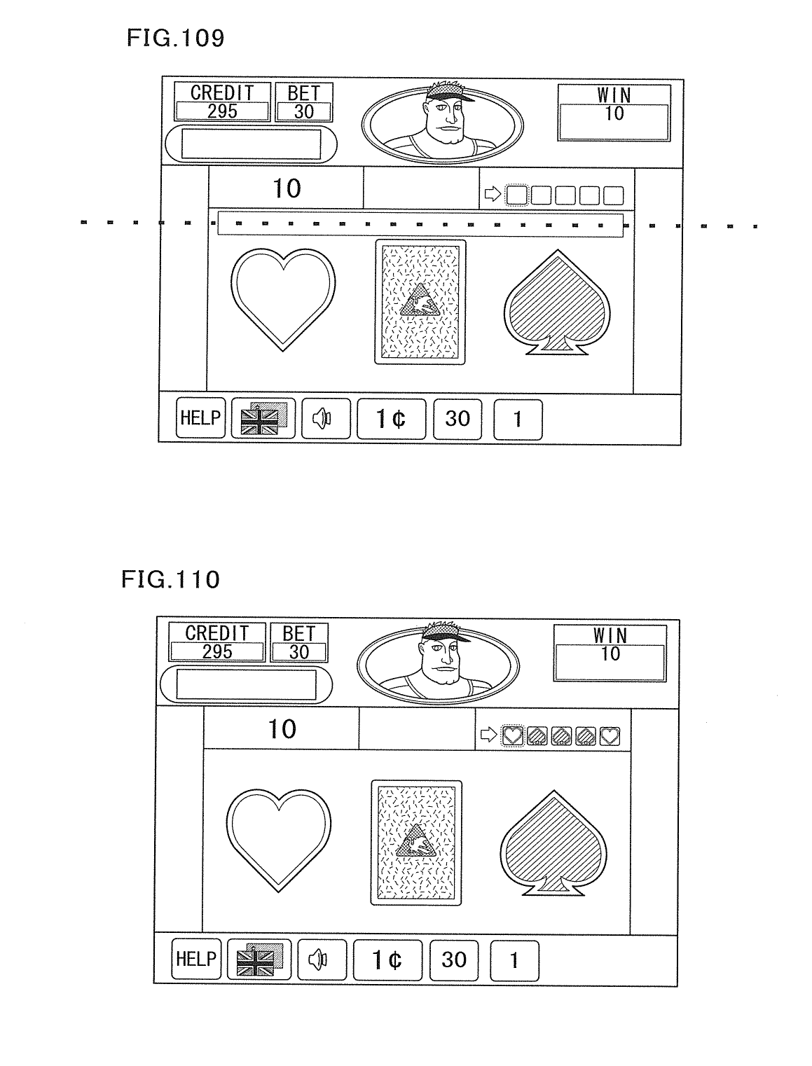

More specifically, WIN occurs as shown in FIG. 108. As shown in FIG. 109, when the shifting to the gamble screen occurs, the message “PLAY ON, GAMBLE or TAKE WIN” disappears. Immediately after the clearance of the RAM, the card history is empty until the gamble game is played. At this stage, the red button is turned on, the black button is turned on, and TAKE WIN button is turned on. The other buttons are turned off except the change button.

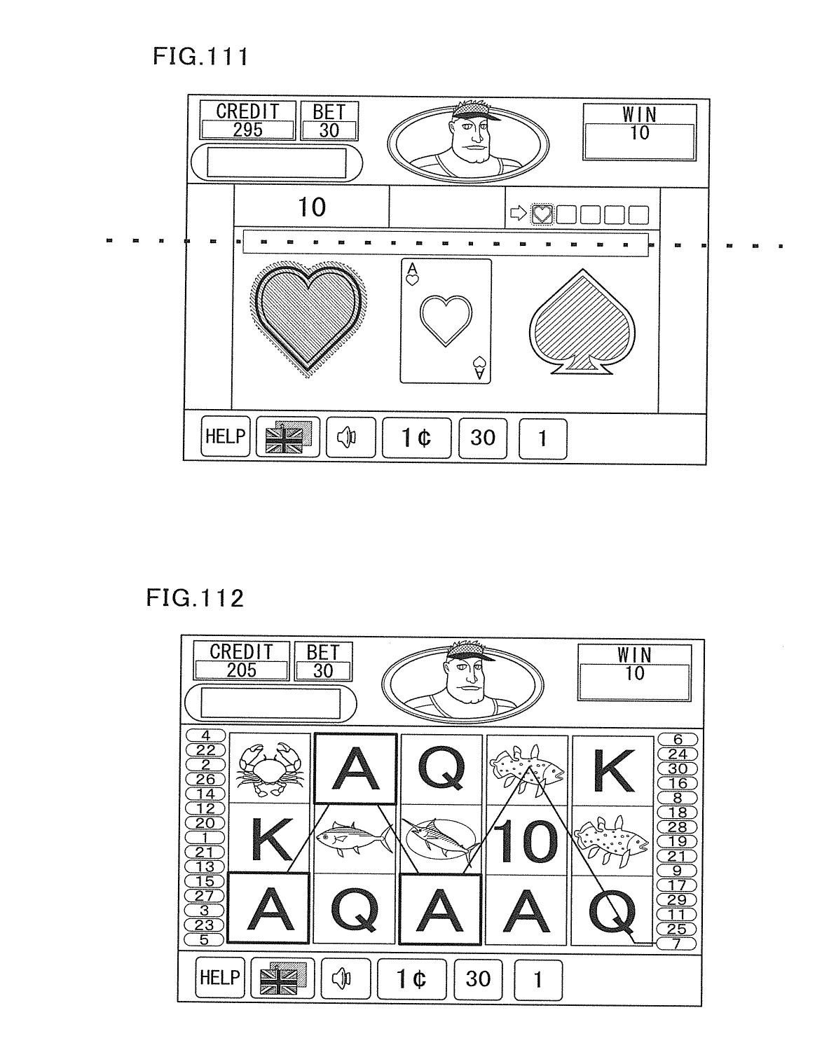

As shown in FIG. 110, the amount bet on “GAMBLE AMOUNT” is displayed. For the selection of “Red” or “Black”, the operation proceeds to the process shown in FIG. 111 in case of failure, or proceeds to the process shown in FIG. 112 in case of success. When TAKE WIN is selected, the amount of WIN is added to the credit at once and the idle state returns. In this regard, when “Red” or “Black” is selected, the red button, the black button, and the TAKE WIN button are turned off. If TAKE WIN is selected, the button LED returns to the idle state.

In case of failure in Gamble, as shown in FIG. 111, non-selected options are darkened. At the left edge of the gamble history field, the card history is displayed at once. The preceding card history moves right. The trace of the movement is not presented in animation, and hence the history is rewritten at once. The central card result is displayed at once. At this stage, there are no changes in the win meter and the gamble amount meter. Failure sound is reproduced and the shifting to the main game screen is performed after 1.2 second elapses. At the same time, the red button, the black button, and the TAKE WIN button are turned off.

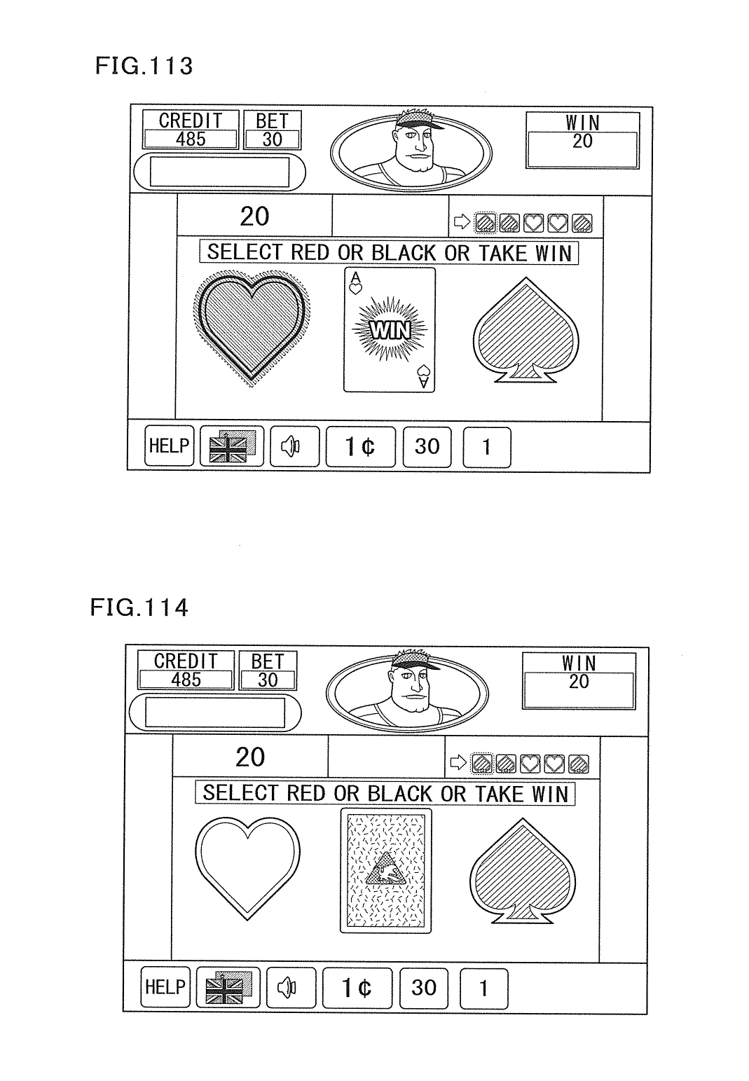

As shown in FIG. 112, at the same time as the switching to the main game screen, the WIN meter becomes 0. The button LED also returns to the idle state. In case of Success in Gamble, as shown in FIG. 113, non-selected options are darkened. At the left edge of the gamble history field, the card history is displayed at once. The preceding card history moves right. The trace of the movement is not presented in animation, and hence the history is rewritten at once. Thereafter, the normal card and the card with the WIN text are alternated on the central card in each frame, and success sound is reproduced (for 1.2 second). Then the amount increased as a result of the Gamble is added to the WIN meter at once. The gamble amount is unchanged at this stage.

When Gamble is played until reaching the upper limit number of times, the amount of WIN is added to the credit at once and the idle state returns. When Gamble has not played until reaching the upper limit number of times, the operation shifts to the process shown in FIG. 114. At the same time, the red button, the black button, and the TAKE WIN button are turned off.

As shown in FIG. 113, the card is overturned. Then the operation goes back to the process shown in FIG. 111. In this regard, when “Red” or “Black” is selected, the red button, the black button, and the TAKE WIN button are turned off. If TAKE WIN is selected, the button LED returns to the idle state.

(Gamble Game: Gamble Limit)

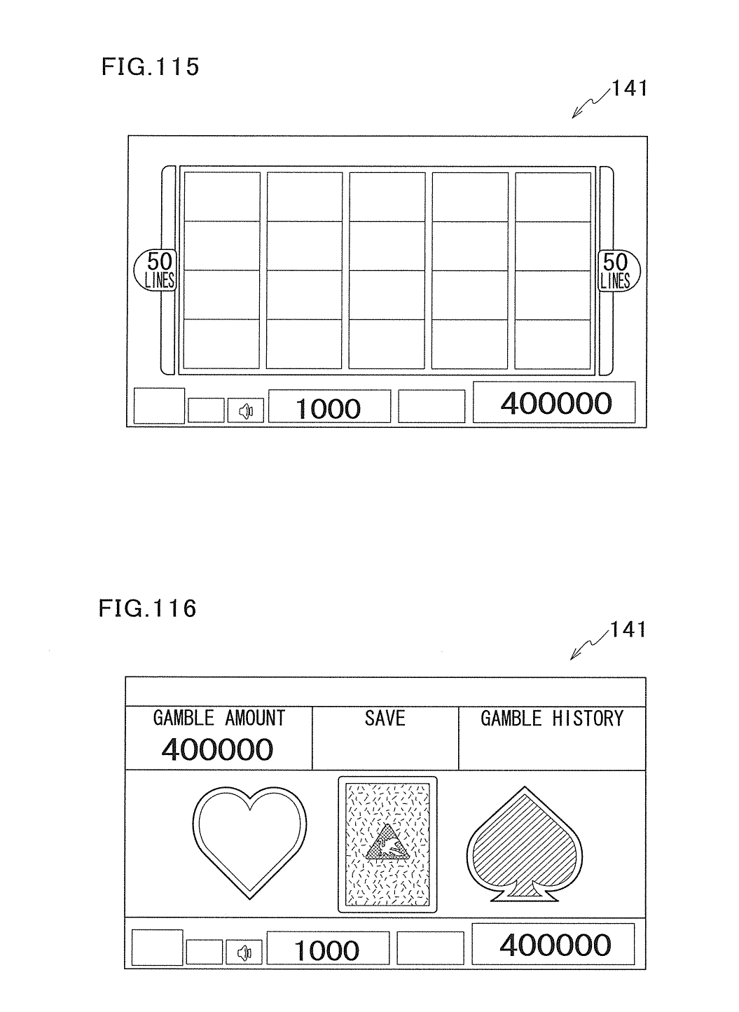

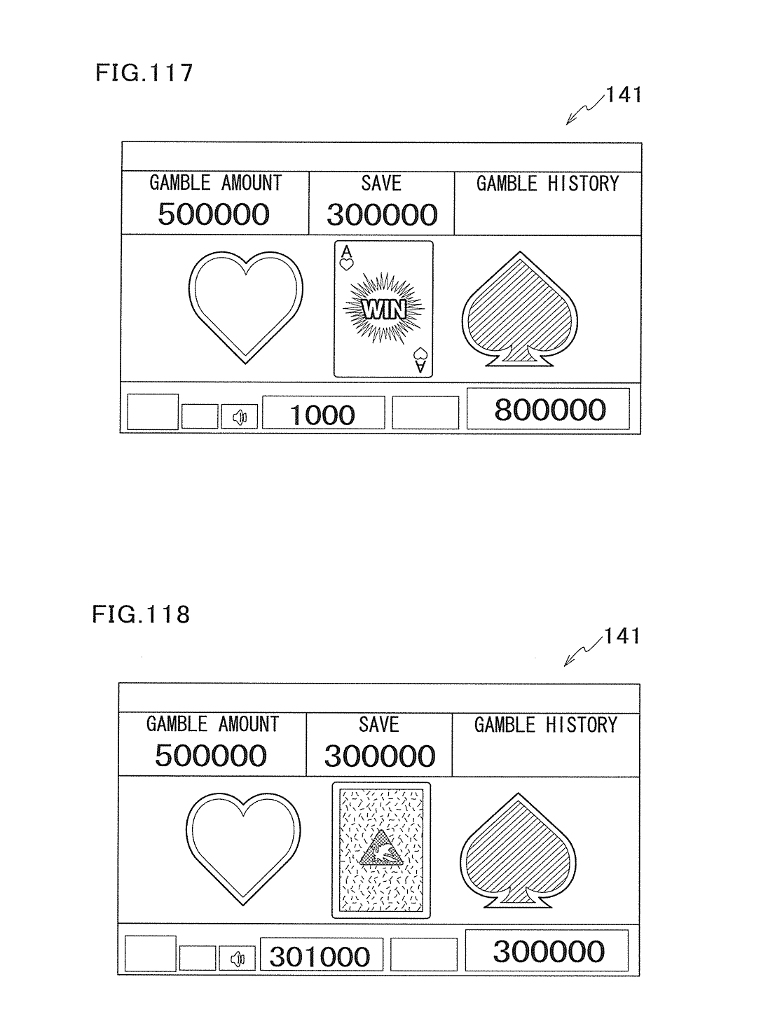

The following describes a gamble game in which a win exceeding a gamble limit has occurred. Suppose the upper limit of the bet amount in the gamble game is set to $5000.00, and a win of $4000.00 occurred as shown in FIG. 115. In this case, if the gamble is selected, the value of “400000” equivalent to $4000.00 is indicated as the gamble amount, as shown in FIG. 116. If the player wins in this gamble as shown in FIG. 117, the amount (“300000”) exceeding the maximum bet amount of the gamble is indicated in a save meter, and the maximum bet amount (“500000”) is indicated in the gamble amount. That is, the bet amount in the next gamble is $5000.00. The win meter indicates an amount that can be obtained if the collect is executed at this time. Then, as shown in FIG. 117, if the player loses in the subsequent gamble, the credit amount in the win meter is overwritten to the saved amount, and the saved amount is added to the credit meter. Then, a transition to the normal game screen occurs and the game is over.

(AUDIT Screen)

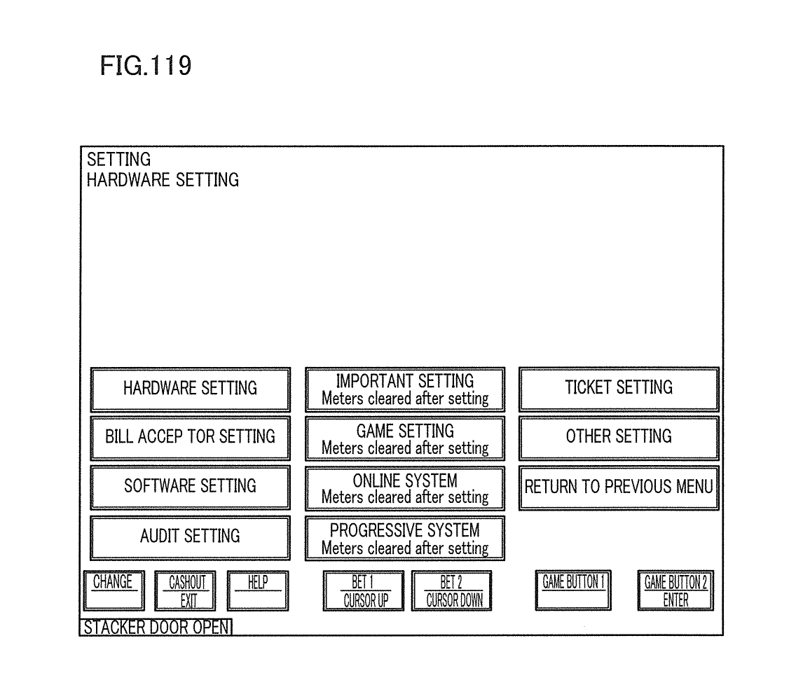

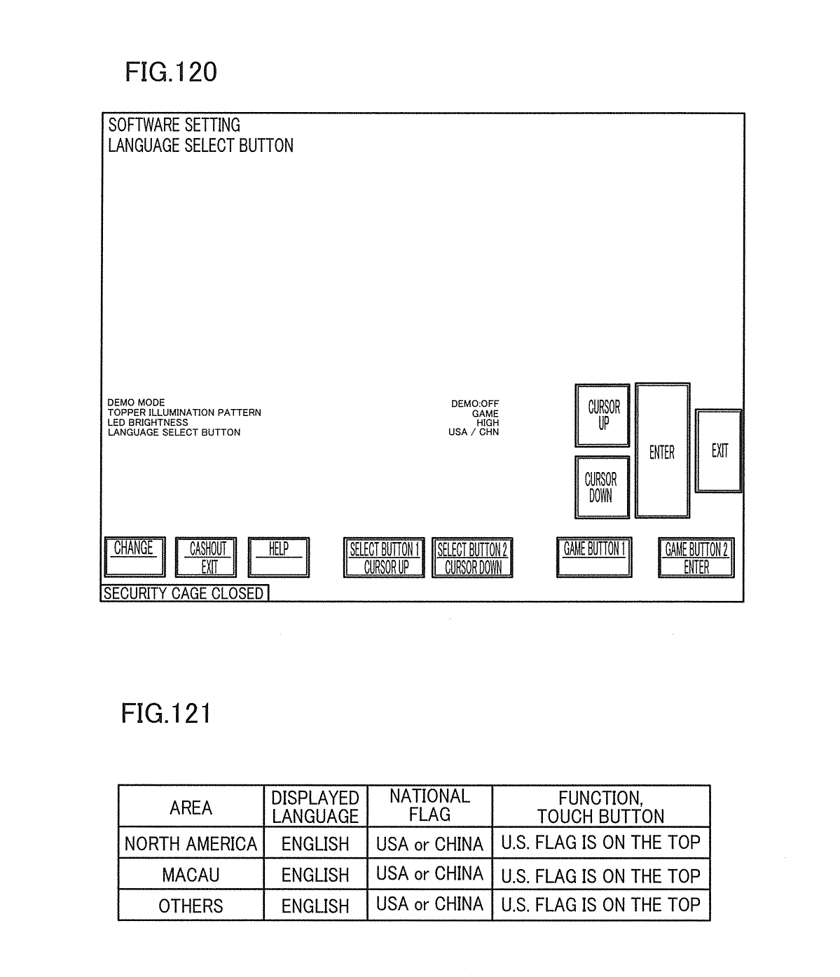

The AUDIT screen allows the switching of the national flag on an AUDIT menu. In the switching of the national flag on the AUDIT menu, “national flag” displayed on the touch button at the switching of the language can be set on the AUDIT menu. For example, the operator enters the “AUDIT menu”. Then “SETTING” is pressed, and “SOFTWARE SETTING” is pressed as shown in FIG. 119, a screen shown in FIG. 120 appears. It is noted that the operations by the control panel 30 or the like are not changed from the current settings.

In the screen shown in FIG. 120, the item “LANGUAGE SELECT BUTTON DISPLAY” is added. In regard to the language switching button, the display content in this layer is one of the followings. That is, “LANGUAGE SELECT BUTTON DISPLAY” is one of “DISABLED”, “UK/CHN”, and “US/CHN”.

In addition to the above, the initial display at the clearance of the RAM is shown in FIG. 121. That is to say, in North America, the display language is English, the national flags are U.S./China, and the U.S. flag is on the front on the function/touch button. In the Macau area, the display language is English, the national flags are U.K./China, and the U.K. flag is on the front on the function/touch button. In the other areas, the display language is English, the national flags are U.K./China, and the U.K. flag is on the front on the function/touch button.

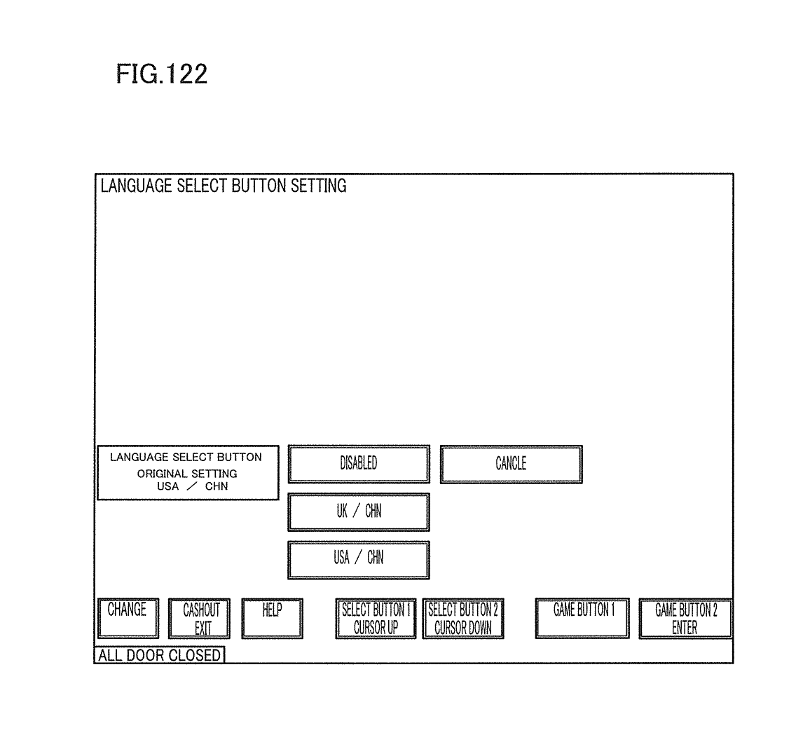

When the item “LANGUAGE SELECT BUTTON DISPLAY” is selected, a screen shown in FIG. 122 is displayed. It is noted that the selected item is enclosed by a red frame. It is noted that the operations through the control panel 30 or the like are not changed from the current settings. “DISABLED” is setting with which the switching function is disabled (only English). The language switching touch button is switched to “PAYTABLE touch button”. After the touch (i.e., the determination by the button), the screen of the immediately above layer is displayed and the determination is confirmed. UK/CHN indicates that the U.K. flag is set. USA/CHN indicates that the U.S. flag is set. The button also functions as the activation of the switching function (i.e., the switching touch button is displayed). After the touch (i.e., the determination by the button), the screen of the immediately above layer is displayed and the determination is confirmed. The selected national flag is on the front on the touch button (Chinese flag is positioned behind). By “CANCEL”, the screen is canceled and the screen of the immediately above layer comes back. The contents that were previously set remain the same.

(Checkout Screen)

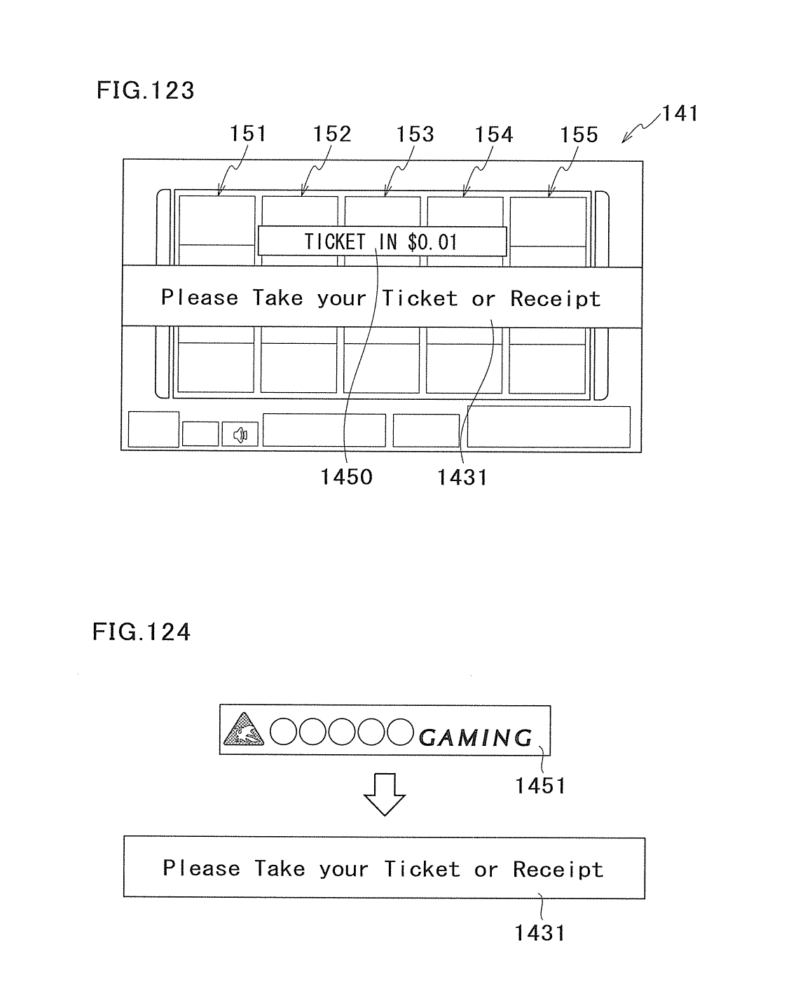

When the cash-out button 32 (see FIG. 8) of the control panel 30 is operated, a ticket is issued, and a ticket issuing message (ticket issuance signboard 1431, see FIG. 65) is displayed. The message of, for example, “CASH IN/CASH OUT” is displayed in a position relative to the vertical direction so as to avoid hiding the pop-up system message. Specifically, as shown in FIG. 123, the ticket issuing message (ticket issuance signboard 1431) is displayed below the system font 1450 displayed on the lower image display panel 141.

Regarding how it is displayed, a logo animation 1451 is displayed for approximately 2 seconds after the cash-out button 32 is pressed, and then the dedicated text of the ticket issuing message (ticket issuance signboard 1431) is displayed, as shown in FIG. 124.

It should be noted that, if the amount to be paid out exceeds the upper limit set in the slot machine 10, when the cash-out button 32 is pressed, the call attendant screen will show and a staff member is called. After resetting by the staff member called, the machine displays the screen shown in FIG. 123, and the ticket issuance is performed. An example of the ticket issuing message displayed is “Please take your Handpay Receipt” and the like.

It should be noted that, if the amount to be paid out exceeds the upper limit of the regulation, when the cash-out button 32 is pressed, the call attendant screen will show and a staff member is called. After resetting by the staff member called, the machine displays the screen shown in FIG. 123, and the ticket issuance is performed. An example of the ticket issuing message displayed is “Please take your Jackpot Receipt” and the like.

Further, in occasions of registering the membership, if a gaming facility (casino and the like) having the slot machine 10 issues a “PLAYABLE ONLY TICKET” for a service, the screen shown in FIG. 123 is displayed and the ticket will be issued. This ticket is only for playing the game, and is not exchangeable with money. An example of the ticket issuing message displayed is “Please take your Playable Only Ticket” and the like.

Further, the screen as shown in FIG. 123 is displayed, when the player attempts to insert the ticket to the printer. An example of the ticket issuing message displayed is “Please take your Ticket or Receipt” and the like.

The above embodiment thus described solely serves as a specific example of the present invention, and the present invention is not limited to such an example. Specific structures and various means may be suitably designed or modified. Further, the effects of the present invention described in the above embodiment are not more than examples of most preferable effects achievable by the present invention. The effects of the present invention are not limited to those described in the embodiments described above.

Further, the detailed description above is mainly focused on characteristics of the present invention to fore the sake of easier understanding. The present invention is not limited to the above embodiments, and is applicable to diversity of other embodiments. Further, the terms and phraseology used in the present specification are adopted solely to provide specific illustration of the present invention, and in no case should the scope of the present invention be limited by such terms and phraseology. Further, it will be obvious for those skilled in the art that the other structures, systems, methods or the like are possible, within the spirit of the present invention described in this specification. The description of claims therefore shall encompass structures equivalent to the present invention, unless otherwise such structures are regarded as to depart from the spirit and scope of the present invention. Further, the abstract is provided to allow, through a simple investigation, quick analysis of the technical features and essences of the present invention by an intellectual property office, a general public institution, or one skilled in the art who is not fully familiarized with patent and legal or professional terminology. It is therefore not an intention of the abstract to limit the scope of the present invention which shall be construed on the basis of the description of the claims. To fully understand the object and effects of the present invention, it is strongly encouraged to sufficiently refer to disclosures of documents already made available.

The detailed description of the present invention provided hereinabove includes a process executed on a computer. The above descriptions and expressions are provided to allow the one skilled in the art to most efficiently understand the present invention. A process performed in or by respective steps yielding one result or blocks with a predetermined processing function described in the present specification shall be understood as a process with no self-contradiction. Further, the electrical or magnetic signal is transmitted/received and written in the respective steps or blocks. It should be noted that such a signal is expressed in the form of bit, value, symbol, text, terms, number, or the like solely for the sake of convenience. Although the present specification occasionally personifies the processes carried out in the steps or blocks, these processes are essentially executed by various devices. Further, the other structures necessary for the steps or blocks are obvious from the above descriptions.

What is claimed is:

1. A gaming machine, comprising: a symbol display device configured to display a result of a game by rearranging symbols in a symbol display area including a matrix of cells, after variably displaying a plurality of symbol arrays each of which is an array of symbols including normal symbols and one or more special symbols each of which is capable of replacing any one of the normal symbols,
a controller configured to run the game, and award, to a player, a payout according to the game result,
wherein the controller
determines symbols to be rearranged on the symbol display device before the variable displaying of symbols starts, and
executes a process of determining whether to perform a predetermined effect during the variable display, when the one or more special symbols included in the symbols determined satisfied a predetermined condition.

2. The gaming machine according to claim 1, further comprising a bet input device capable of receiving a bet whose amount is designated by a player,
wherein the game includes a normal game configured to run on condition that a bet is placed and award a payout to the player according to the game result, and
wherein the controller
executes a process of determining whether to perform the predetermined effect during the variable display in the normal game, when a predetermined number or more of special symbols are to be rearranged in the symbol display device, and when the payout equals to or surpasses the product of bet amount multiplied by a predetermined number.

3. The gaming machine according to claim 2, wherein the game includes a free game which could be triggered in the normal game, and configured to award a payout to the player according to the game result; and
wherein the controller
executes a process of determining whether to perform the predetermined effect during the variable display in the free game, when a predetermined number or more of special symbols are to be rearranged in the symbol display device, and when the payout equals to or surpasses the product of bet amount in the normal game having triggered the free game multiplied by a predetermined number.
